(19) United States
(12) Patent Application Publication
(10) Pub. No.: US 2024/0111608 A1
(43) Pub. Date: Apr. 4, 2024

(54) EVENT-MESSAGE COLLECTION, PROCESSING, AND STORAGE SYSTEMS THAT ARE CONFIGURABLE TO FACILITATE SCALING, LOAD-BALANCING, AND SELECTION OF A CENTRALIZATION/DECENTRALIZATION LEVEL

(71) Applicant: VMware, Inc., Palo Alto, CA (US)

(72) Inventors: Darren Brown, Seattle, WA (US); Anil Sharma, Palo Alto, CA (US); Ashok Kumar, Palo Alto, CA (US)

(73) Assignee: VMware, Inc., Palo Alto, CA (US)

(21) Appl. No.: 17/955,367

(22) Filed: Sep. 28, 2022

(51) Int. Cl. G06F 9/50; G06F 9/54

(52) U.S. Cl. CPC G06F 9/5088; G06F 9/5077; G06F 9/546

(57) ABSTRACT

The current document is directed to event-message collection, processing, and storage systems and, in particular, to event-message collection, processing, and storage computing systems that are configurable to facilitate scaling, load balancing, and selection of a centralizing/decentralizing level which, in turn, provide a variety of operational efficiencies and advantages. Decentralization combined with event-record filtering, in a described implementation, provides for a significant reduction in data-transmission, processing, and data-storage overheads. Dynamic reconfiguration of the components of the event-message collection, processing, and storage systems allows for increased precision in scaling and load balancing to adapt the event-message collection, processing, and storage systems to dynamically reconfigured distributed computer systems in which the event-message collection, processing, and storage systems run.

### TECHNICAL FIELD

The current document is directed to event-message collection, processing, and storage systems and, in particular, to event-message collection, processing, and storage computing systems that are configurable to facilitate scaling, load balancing, and selection of a centralizing/decentralizing level which, in turn, provide a variety of operational efficiencies and advantages.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. Despite all of these advances, however, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed and as general hardware and software technologies continue to advance, the current trend towards ever-larger and more complex distributed computing systems appears likely to continue well into the future.

In modern computing systems, individual computers, subsystems, and components generally output large volumes of status, informational, and error messages that are collectively referred to, in the current document, as “event messages.” In large, distributed computing systems, terabytes of event messages may be generated each day. The event messages are often collected into event logs stored as files in data-storage appliances and are often analyzed both in real time, as they are generated and received, as well as retrospectively, after the event messages have been initially processed and stored in event logs. Event messages may contain information that can be used to detect serious failures and operational deficiencies prior to the accumulation of a sufficient number of failures and system-degrading events that lead to data loss and significant down time. The information contained in event messages may also be used to detect and ameliorate various types of security breaches and issues, to intelligently manage and maintain distributed computing systems, and to diagnose many different classes of operational problems, hardware-design deficiencies, and software-design deficiencies. However, the advantages and capabilities provided by collecting and storing large volumes of event messages within distributed computer systems are obtained at the expense of significant computational-resource costs and overheads, including processing overheads, data-storage overheads, and data-transmission overheads. Developers, managers, and owners of distributed computer systems that employ event-message collection, storage, and analysis therefore continue to seek ways to achieve the advantages and capabilities provided by event-message collection and storage with increased efficiencies.

### SUMMARY

The current document is directed to event-message collection, processing, and storage systems and, in particular, to event-message collection, processing, and storage computing systems that are configurable to facilitate scaling, load balancing, and selection of a centralizing/decentralizing level which, in turn, provide a variety of operational efficiencies and advantages. Decentralization combined with event-record filtering, in a described implementation, provides for a significant reduction in data-transmission, processing, and data-storage overheads. Dynamic reconfiguration of the components of the event-message collection, processing, and storage systems allows for increased precision in scaling and load balancing to adapt the event-message collection, processing, and storage systems to dynamically reconfigured distributed computer systems in which the event-message collection, processing, and storage systems run.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates a simple example of event-message logging and analysis.

FIG. 12 shows a small, 11-entry portion of a log file from a distributed computer system.

FIG. 13 illustrates one aspect of the event-message-processing approach represented by the currently disclosed methods and systems.

FIG. 14A illustrates one implementation of clustering methods and systems.

FIG. 14B illustrates processing of a first event message.

FIG. 14C illustrates processing of a second message.

FIGS. 15-20 illustrate one implementation of the logic used by an event-message-clustering system to compute a metric for a received event message that allows the event message to be assigned to a particular existing cluster.

FIG. 21 illustrates an implementation of the event-message-clustering system to which the current document is directed at a greater level of detail than, but using the same illustration conventions as used in, FIG. 14A.

FIG. 22 illustrates a cluster-merge operation.

FIG. 23 illustrates a cluster-split operation.

FIG. 24 provides a final illustration of one implementation of the event-message-clustering system to which the current document is directed.

FIG. 25 illustrates a process that extracts parameter values from an event message.

FIGS. 26A-C illustrate examples of editing of the redirection-rule table.

FIG. 27A illustrates regular expressions corresponding to various types of formats in which dates may be encoded in event messages.

FIG. 27B illustrates construction of generalized regular expressions that identify two or more types of date formats.

FIG. 27C illustrates an example of the use of regular expressions in text processing.

FIG. 27D shows a representation of the deterministic finite automata 2860 corresponding to the regular expression 2850 in the example shown in FIG. 28C.

FIGS. 28A-B illustrate implementation of a regular-expression-based variable-finding subsystem.

FIGS. 29A-B illustrate a general approach to generating a parsing function for an event-message cluster.

FIG. 30 illustrates a computational method for identifying the static or conserved substrings within a cluster of event messages.

FIGS. 31A-B illustrate generation of event distributions from log-file entries.

FIGS. 32A-B show event-type histograms collected from different time intervals using queries, such as query 3120 in FIG. 31B, executed against one or more log files or virtual files.

FIGS. 33A-B illustrate conversion of the histograms shown in FIG. 32A-B into numeric probability distributions.

FIG. 34 illustrates the components of one implementation of an event-message collection, processing, and storage system (“EM system”) within a distributed computer system.

FIG. 35 illustrates distribution of components of an EM system within a distributed computer system.

FIG. 36 illustrates the decentralization/centralization level of an EM system within a distributed computer system.

FIGS. 37A-G illustrate configurations of a hypothetical EM system representing different levels of centralization/decentralization.

FIGS. 38A-B illustrate evolution, over time, of an EM system that provides for dynamic adjustment of the centralization/decentralization level.

FIG. 39 illustrates one EM-system implementation that features a relatively high level of decentralization and that also includes centralized components.

FIGS. 40A-E provide control-flow diagrams that illustrate one implementation of the EM system discussed with reference to FIG. 39.

FIGS. 41A-D provide control-flow diagrams that illustrate the process_input functions for the collector and normalization components of one implementation of an EM system.

FIGS. 42A-D provide control-flow diagrams that illustrate the feature-vector-generation, event-type-assignment, and filter process_input routines.

### DETAILED DESCRIPTION

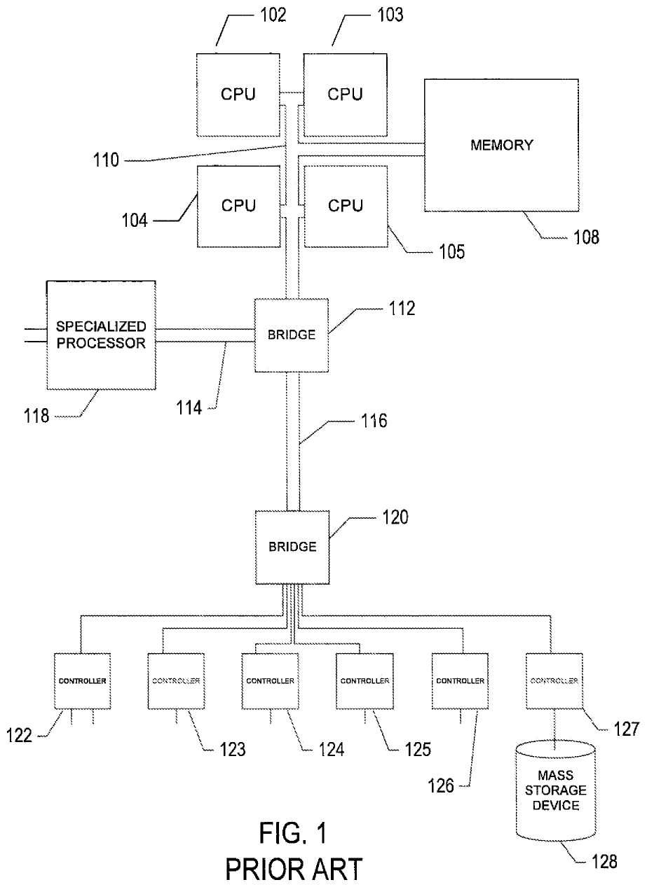

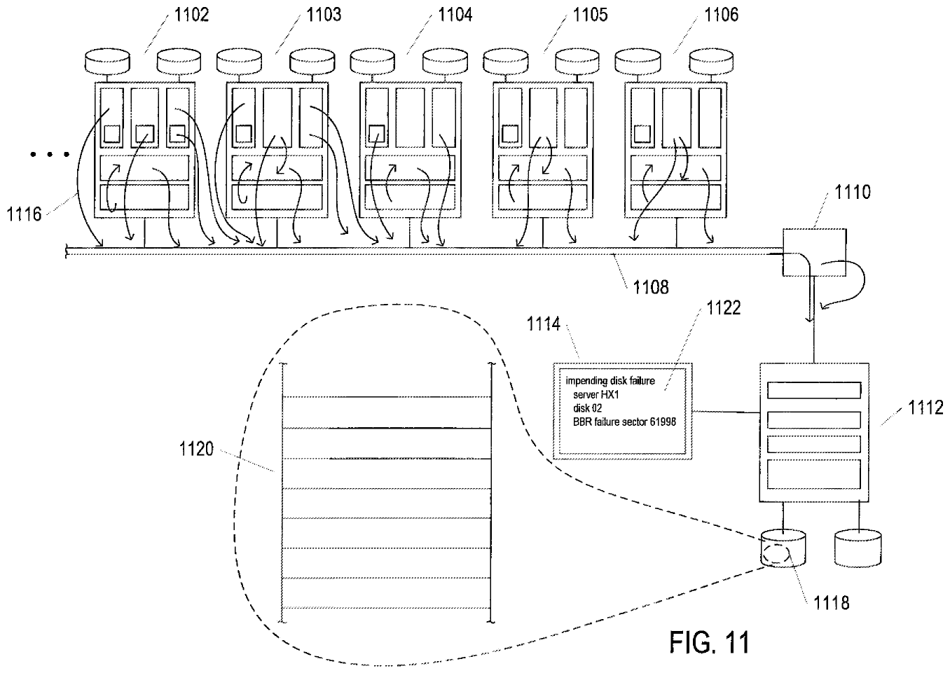

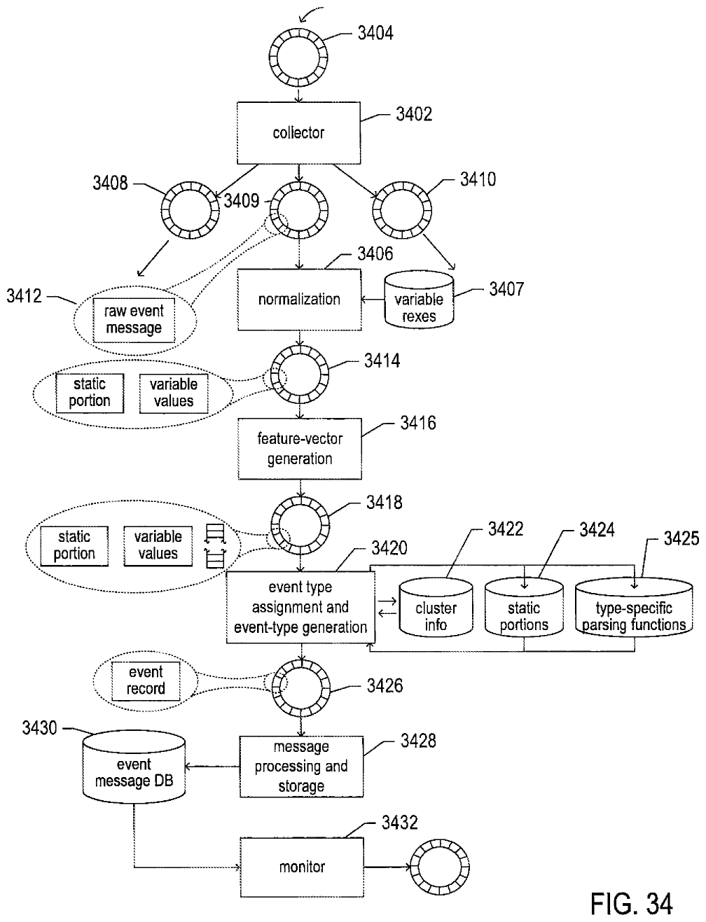

The current document is directed to methods and systems for collecting, processing, and storing large volumes of event messages generated in modern computing systems. In a first subsection, below, a detailed description of computer hardware, complex computational systems, and virtualization is provided with reference to FIGS. 1-10. In a second subsection, collection, processing, and storage of event messages are discussed with reference to FIGS. 11-33B. In a third subsection, decentralization and centralization of an event-message collection, processing, storage, and filtering system is discussed with reference to FIGS. 34-42D.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

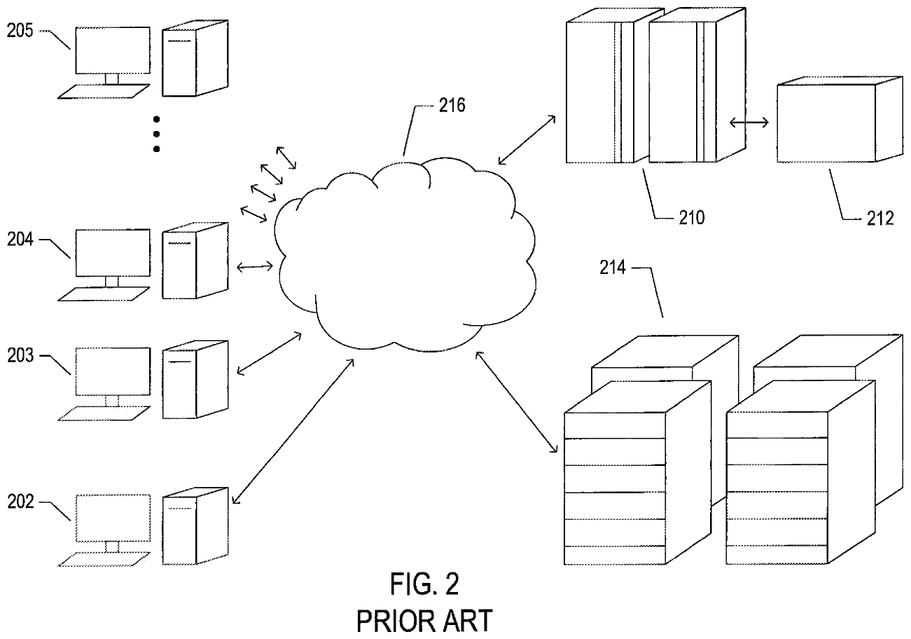

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

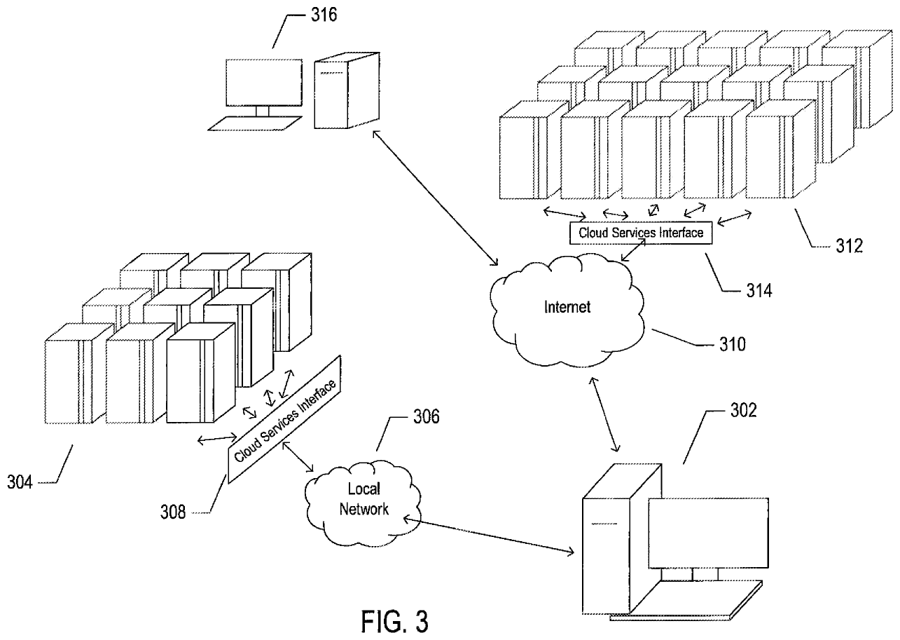

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

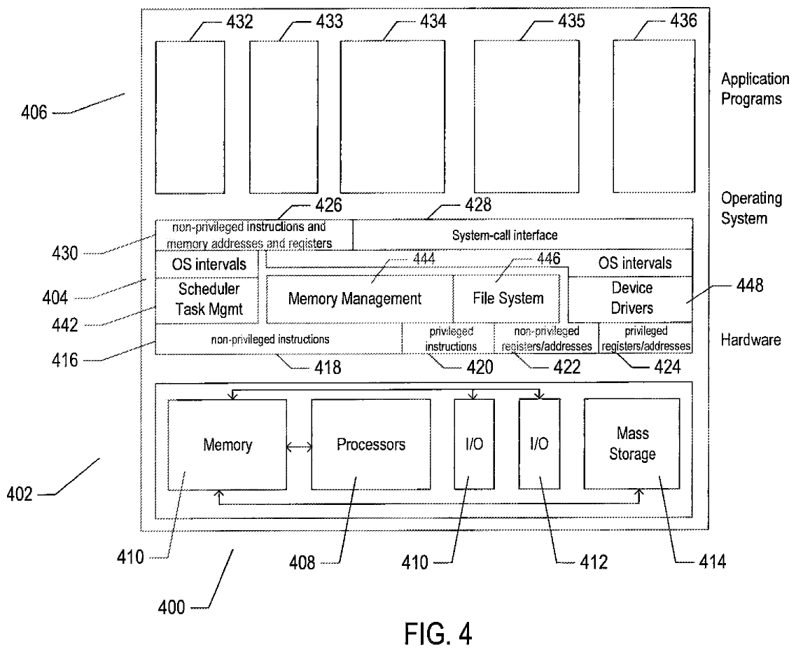

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

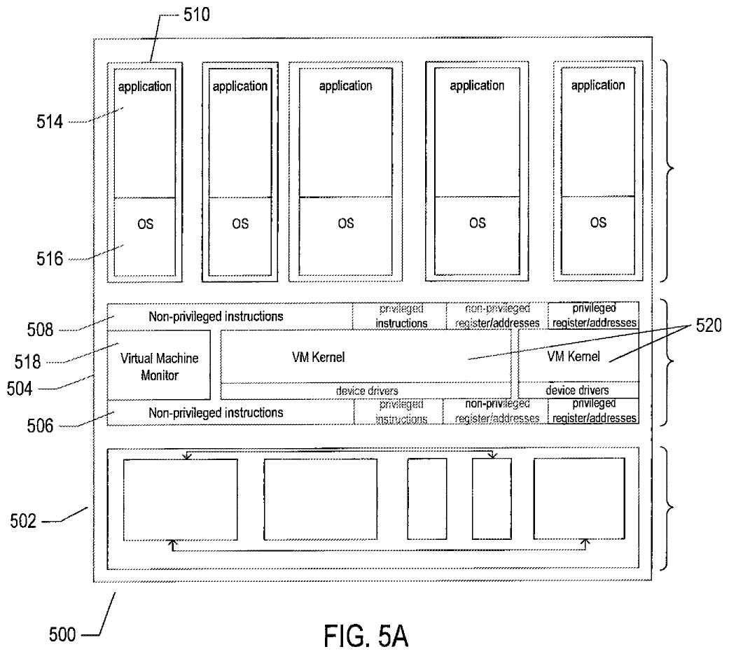

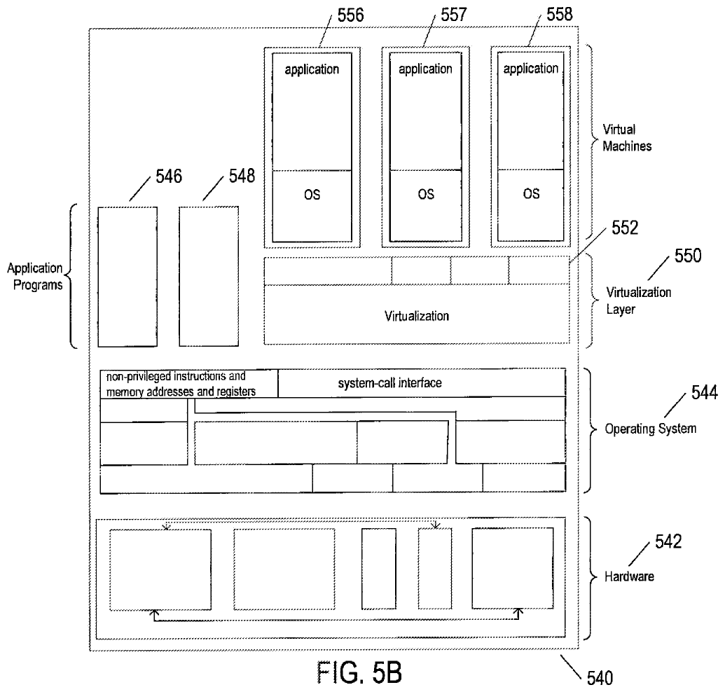

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

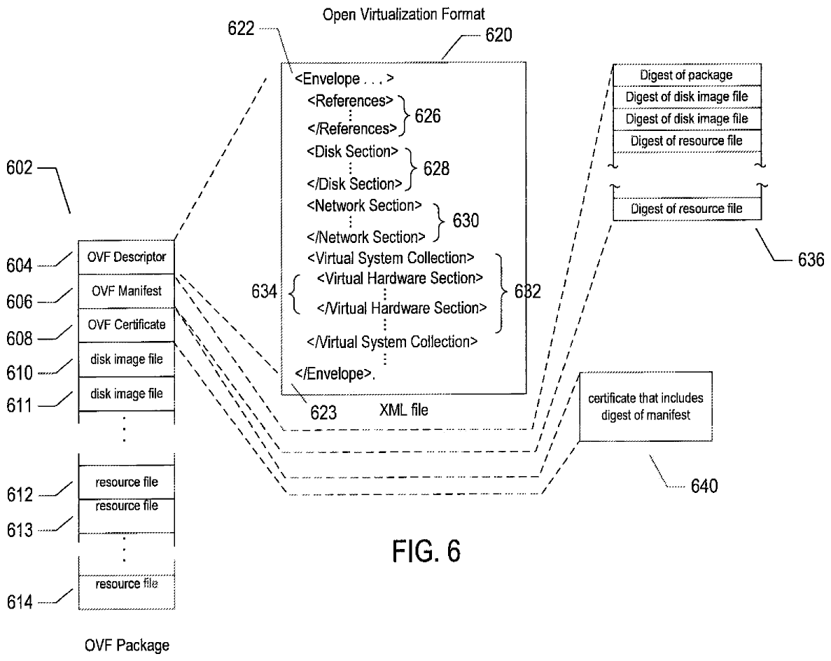

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

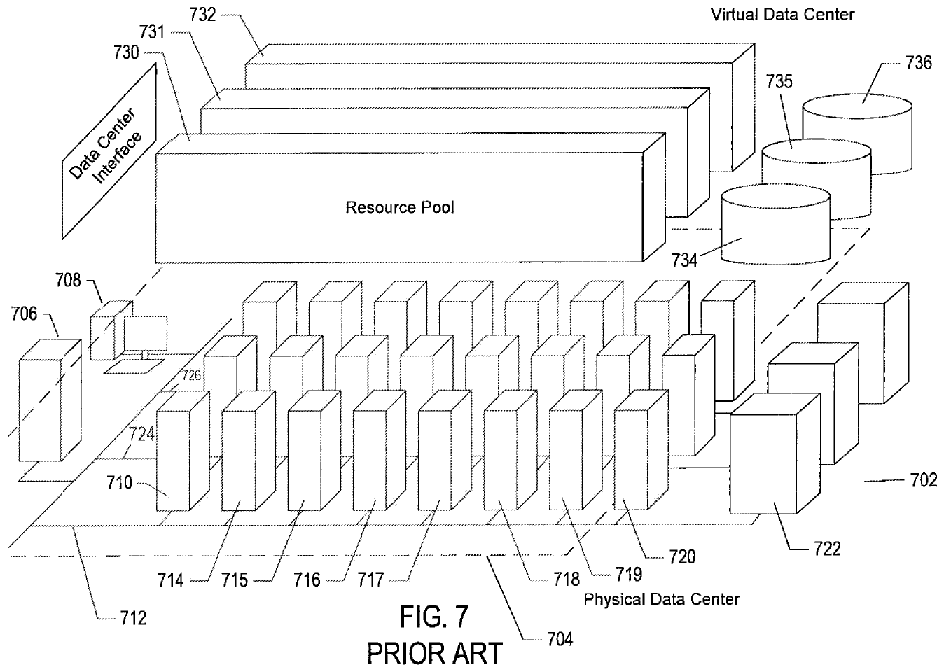

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provides a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

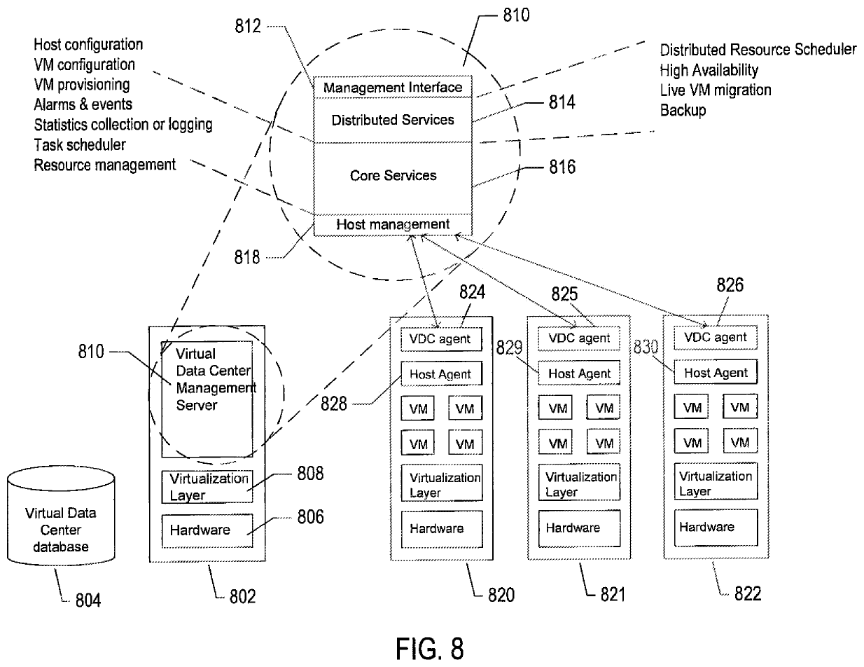

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

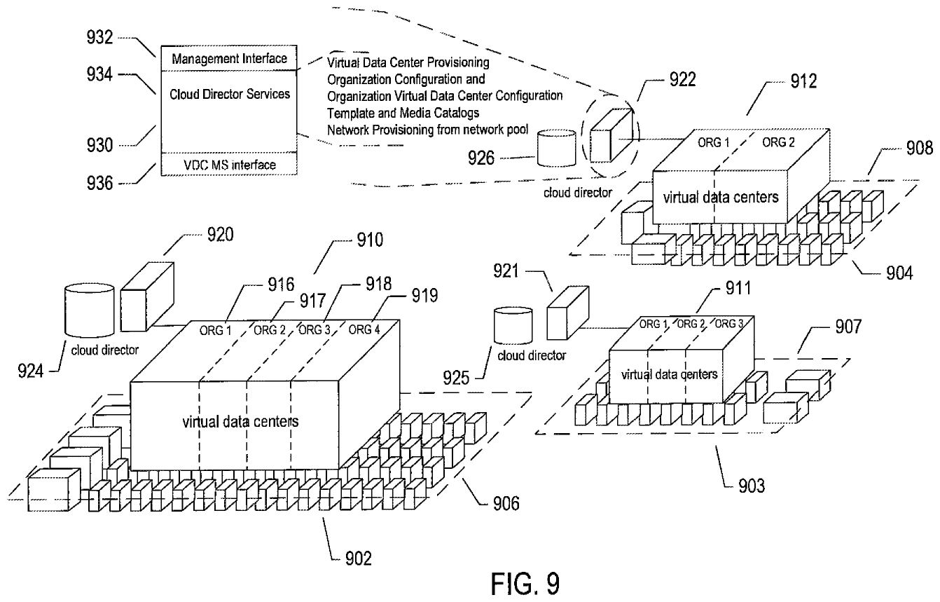

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

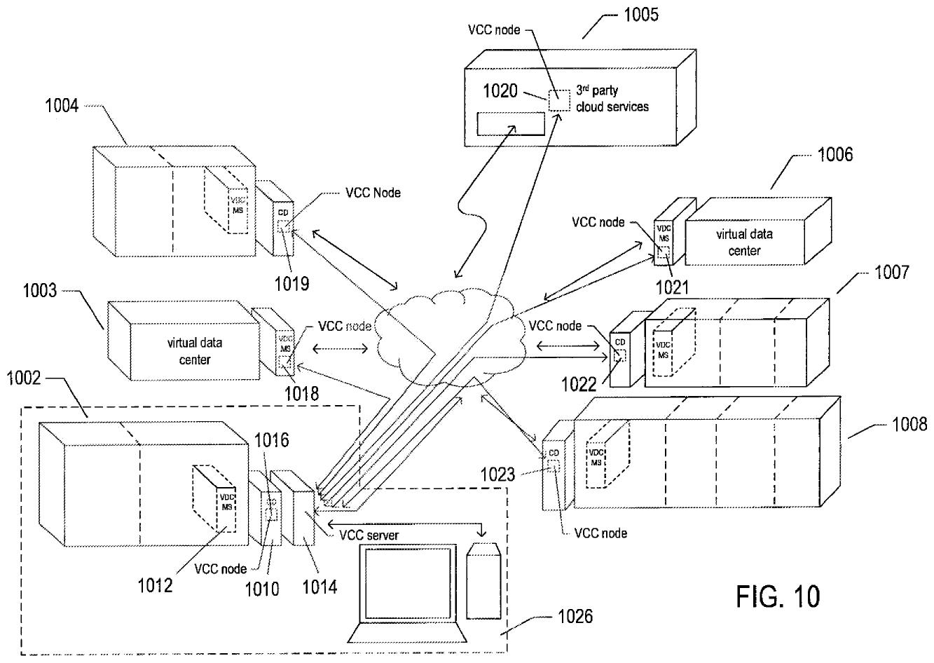

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Event-Message Collection, Processing, and Storage

FIG. 11 illustrates a simple example of event-message logging and analysis. In FIG. 11, a number of computer systems 1102-1106 within a distributed computing system are linked together by an electronic communications medium 1108 and additionally linked through a communications bridge/router 1110 to an administration computer system 1112 that includes an administrative console 1114. As indicated by curved arrows, such as curved arrow 1116, multiple components within each of the discrete computer systems 1102 and 1106 as well as the communications bridge/router 1110 generate event messages which are ultimately transmitted to the administration computer 1112. Event messages may be relatively directly transmitted from a component within a discrete computer system to the administration computer or may be collected at various hierarchical levels within a discrete computer and then forwarded from an event-message-collecting entity within the discrete computer to the administration computer. The administration computer 1112 may filter and analyze the received event messages, as they are received, in order to detect various operational anomalies and impending failure conditions. In addition, the administration computer collects and stores the received event messages in a data-storage device or appliance 1118 as large event-message log files 1120. Either through real-time analysis or through analysis of log files, the administration computer may detect operational anomalies and conditions for which the administration computer displays warnings and informational displays, such as the warning 1122 shown in FIG. 11 displayed on the administration-computer display device 1114.

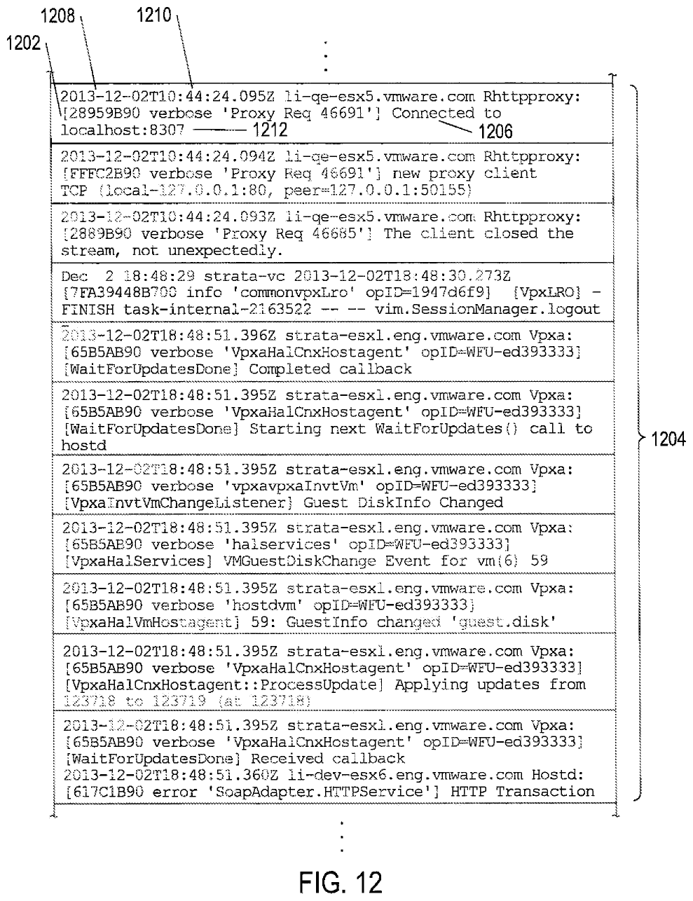

FIG. 12 shows a small, 11-entry portion of a log file from a distributed computer system. In FIG. 12, each rectangular cell, such as rectangular cell 1202, of the portion of the log file 1204 represents a single stored event message. In general, event messages are relatively cryptic, including generally only one or two natural-language sentences or phrases as well as various types of file names, path names, and, perhaps most importantly, various alphanumeric parameters. For example, log entry 1202 includes a short natural-language phrase 1206, date 1208 and time 1210 parameters, and a numeric parameter 1212 which appears to identify a particular host computer.

There are a number of reasons why event messages, particularly when accumulated and stored by the millions in event-log files or when continuously received at very high rates during daily operations of a computer system, are difficult to automatically interpret and use. A first reason is the volume of data present within log files generated within large, distributed computing systems. As mentioned above, a large, distributed computing system may generate and store terabytes of logged event messages during each day of operation. This represents an enormous amount of data to process, even were the individual event messages highly structured and precisely formatted to facilitate automated processing. However, event messages are not so structured and formatted, which is a second reason that continuously received event messages and event logs are difficult to automatically interpret and analyze. They are even more difficult to manually analyze and interpret, by human system administrators and system analysts. Event messages are generated from many different components and subsystems at many different hierarchical levels within a distributed computer system, from operating system and application-program code to control programs within disk drives, communications controllers, and other such distributed-computer-system components. The event messages may be generated according to a variety of different event-message structuring and formatting approaches used by various different vendors and programmers. Even within a given subsystem, such as an operating system, many different types and styles of event messages may be generated due to the many thousands of different programmers who contribute code to the operating system over very long time frames. A third reason that it is difficult to process and analyze event messages is that, in many cases, event messages relevant to a particular operational condition, subsystem failure, or other problem represent only a tiny fraction of the total number of event messages that are received and logged. Searching for these relevant event messages within an enormous volume of event messages continuously streaming into an event-message-processing-and-logging subsystem of a distributed computer system may itself be a significant computational challenge. While text-search methodologies may be employed to search for relevant data within large log files, such methods are generally quite time-consuming and imprecise. A fourth problem associated with event messages in large, distributed computer systems is that storing and archiving event logs may itself represent a significant computational challenge. Given that many terabytes of event messages may be collected during the course of a single day of operation of a large, distributed computer system, collecting and storing the large volume of information represented by event messages may represent a significant processing-bandwidth, communications-subsystems bandwidth, and data-storage-capacity challenge, particularly when it may be necessary to reliably store event logs in ways that allow the event logs to be subsequently accessed for searching and analysis.

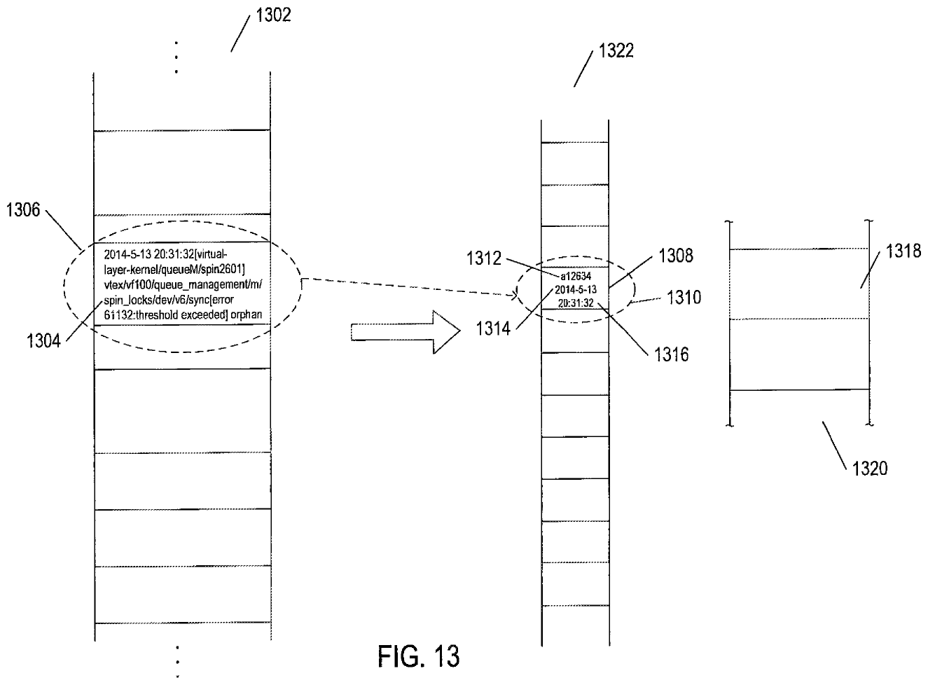

The currently disclosed methods and systems for processing, classifying, and storing event messages have been devised to address the above-mentioned challenges associated with event-message processing and analysis as well as additional deficiencies and problems associated with currently available event-message processing, analysis, and storage. FIG. 13 illustrates one aspect of the event-message-processing approach represented by the currently disclosed methods and systems. In FIG. 13, a traditional event log 1302 is shown as a column of event messages, including the event message 1304 shown within inset 1306. The methods and systems to which the current document is directed automatically process event messages, as they are received, in order to transform the received event messages into event records, such as event record 1308 shown within inset 1310. The event record 1308 includes a numeric event-type identifier 1312 as well as the values of parameters included in the original event message. In the example shown in FIG. 13, a date parameter 1314 and a time parameter 1315 are included in the event record 1308. The remaining portions of the event message, referred to as the “non-parameter portion of the event message,” is separately stored in an entry in a table of non-parameter portions that includes an entry for each type of event message. For example, entry 1318 in table 1320 may contain an encoding of the non-parameter portion common to all event messages of type a12634 (1312 in FIG. 13). Thus, the methods and systems to which the current document is directed have the effect of transforming traditional event logs, such as event log 1302, into stored event records, such as event-record log 1322, and a generally very small table 1320 with encoded non-parameter portions, or templates, for each different type of event message.

The event-record log, such as event-record log 1322, and other types of accumulations of event records have numerous advantages over a traditional event-message log. A first advantage is that each event record is typed. Because the event records are typed, the event-record log can be easily searched, partitioned, and otherwise processed based on event-message types, which produces a significant computational advantage for downstream event-analysis and event-interpretation systems. A second advantage is that, as shown in FIG. 13, event-record logs are significantly compressed with respect to traditional event-message logs. Because only one copy of the non-parameter portion of each type of event message needs to be stored in the associated table, a significant data compression is achieved by the methods and systems to which the current document is directed. The compression ratios achieved depend on the average ratio of non-parameter characters to parameter characters in event messages. In many cases, compression ratios of between 2:1 and 10:1 can be achieved by storing event records rather than event messages. Because terabytes of event messages may be collected on a daily basis within a large, distributed computing system, this potential rate of data compression represents a significant decrease in computational and hardware-usage overheads. A third advantage of event-record logs in comparison to event-message logs is that the event-record logs are fully and uniformly structured, which additionally facilitates downstream automated analysis and interpretation. The downstream analysis and interpretation systems directly acquire relevant parameters and an event type from an event record, without the need for parsing and typing a large variety of different types of event messages.

Returning briefly to FIG. 11, it should be noted that the simple example illustrated in FIG. 11 fails to illustrate the entire problem space addressed by the methods and systems to which the current document is directed. In large, distributed computing systems, for example, it would be impractical to funnel all event messages to a single administration computer. Instead, processing, analysis, and storage of event messages is typically carried out by multiple discrete computer systems and is therefore also distributed. As a result, methods and systems for processing, typing, and efficiently storing event messages need to be both scalable and distributable over multiple computer systems in order to be generally useful over a range of different types of distributed computing systems as well as over significant time frames during which distributed computing systems may increase in size due to continuous addition of new processing components. The distributed virtual-data-center and virtual-cloud management systems discussed in the first subsection of the current document are examples of systems in which event-message processing, typing, and storage may be distributed over multiple computational nodes.

In the current application, the phrase “event-message-clustering system” refers to any of various standalone systems as well as subsystems and components of standalone systems and systems within distributed computing systems that carry out event-message clustering in order to automatically assign event types to event messages, which, in turn, provides for a variety of advantages and efficiencies in event-message collection, processing, and storage. The phrase “event message” refers to any of various types of information entities produced within distributed computer systems that include parameters and non-parametric portions, that provide state information of event-message-emitting distributed-computer-system components and notification of the occurrences of various types of events and conditions within the distributed computer systems, and that are collected, process, and stored to facilitate downstream system monitoring and system analysis which, in turn, facilitates automated distributed-computer-system management.

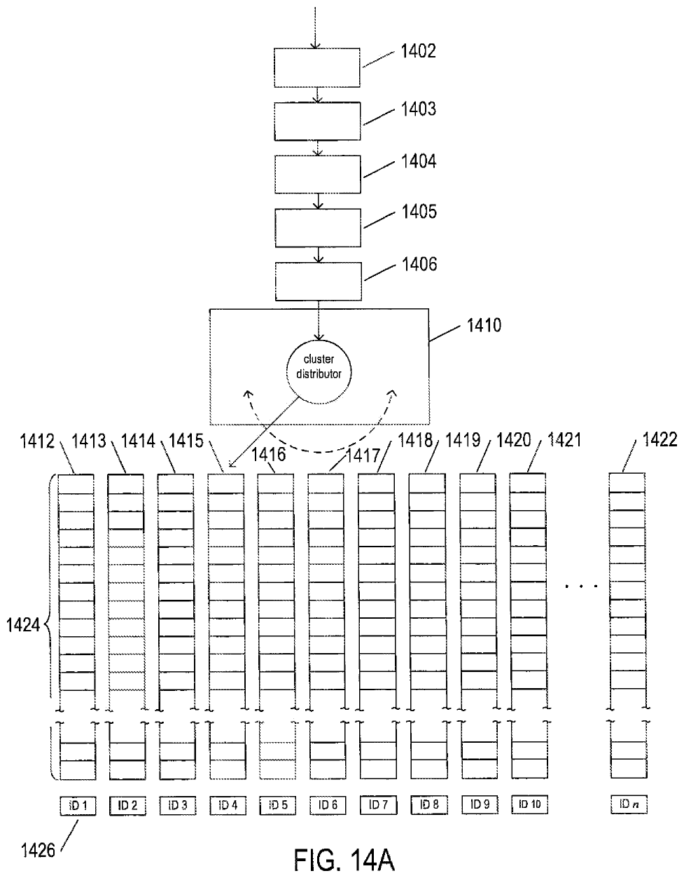

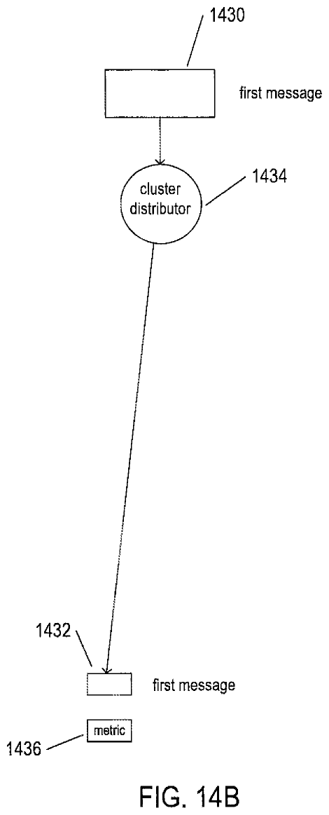

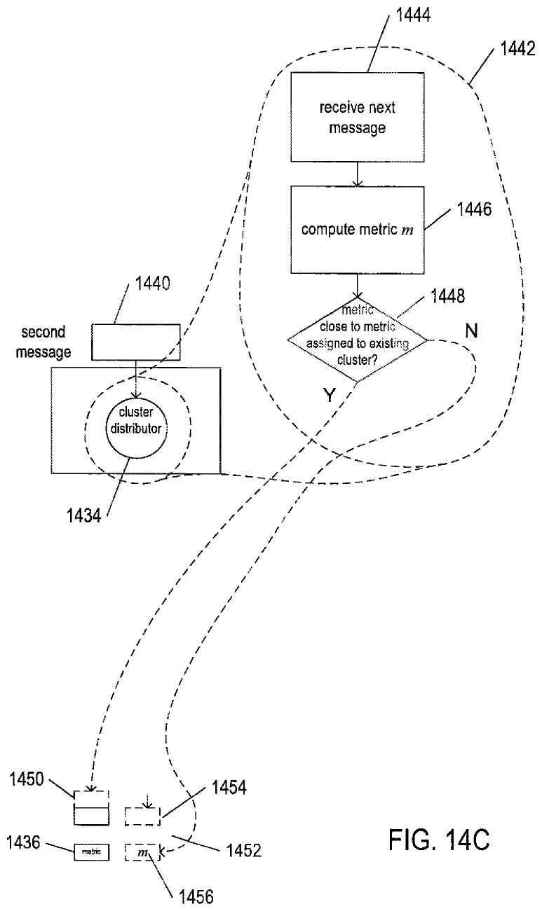

FIG. 14A illustrates one implementation of clustering methods and systems. Rectangles 1402-1406 represent incoming event messages to an event-message-clustering system. The event-message-clustering system includes an event-processing-and-distribution component 1410 and multiple clusters of event records 1412-1422. Each cluster includes stored event records, such as the stored event records 1424 of cluster 1412, and a cluster identifier, such as cluster identifier 1426 of cluster 1412. The event-message-clustering system 1410 processes each received event message to transform the received event message into an event record and determines to which cluster to assign the event record. The clusters represent a typing scheme for event messages. In other words, each cluster represents a message type. The event-message-clustering system 1410 operates in real time to transform event messages into event records and to type the event messages by assigning each event record corresponding to an event message to a particular cluster. The stored event records may be accessed by downstream event-analysis and event-interpretation systems. In certain implementations, the event records may be physically stored by separate systems. Event records may not only be accessed by other entities, but may be periodically flushed to event-record archives, copied to downstream event-record-processing components, and transferred to downstream event-record-processing components. Initially, when a cluster is first initialized and begins storing events, the cluster may store unprocessed event messages rather than event records for an initial period of time. Only when a sufficient number of event messages of a particular type have been accumulated can downstream analysis components, in certain implementations, provide tools to the event-message-clustering system that allow the event-message-clustering system 1410 to transform event messages into event records.

FIG. 14B illustrates processing of a first event message. Initially, there are no clusters. The first received event message 1430 initiates creation of a first cluster 1432 to which the cluster-distributor-component 1434 of the event-message-clustering system 1410 assigns the first event message. A temporary identifier 1436 is assigned to the first cluster.

FIG. 14C illustrates processing of a second message. The second event message 1440 is analyzed by the cluster distributor 1434 as represented by the logic shown in inset 1442. In step 1444, the cluster distributor receives the second message and, in step 1446, computes a numeric metric m for the received event message. In conditional step 1448, the cluster distributor determines whether the computed metric is close to the metric 1436 assigned to the first cluster. If the computed metric m for the second event message is sufficiently close to the metric 1436 assigned to the first cluster, then the second message is added to the first cluster 1450. Otherwise, a new cluster is created 1452 and the second event message is added to the new cluster 1454. The metric computed for the second event message m is assigned as the metric associated with the new, second cluster 1456. Subsequently received event messages are similarly processed. Either a subsequently received event message is assigned to an existing cluster, when a metric computed for the subsequently received event message is sufficiently close to a metric for an existing cluster, or a new cluster is created and the subsequently received event message becomes the first event message assigned to the new cluster. Thus, clusters are created dynamically as event messages are received and processed.

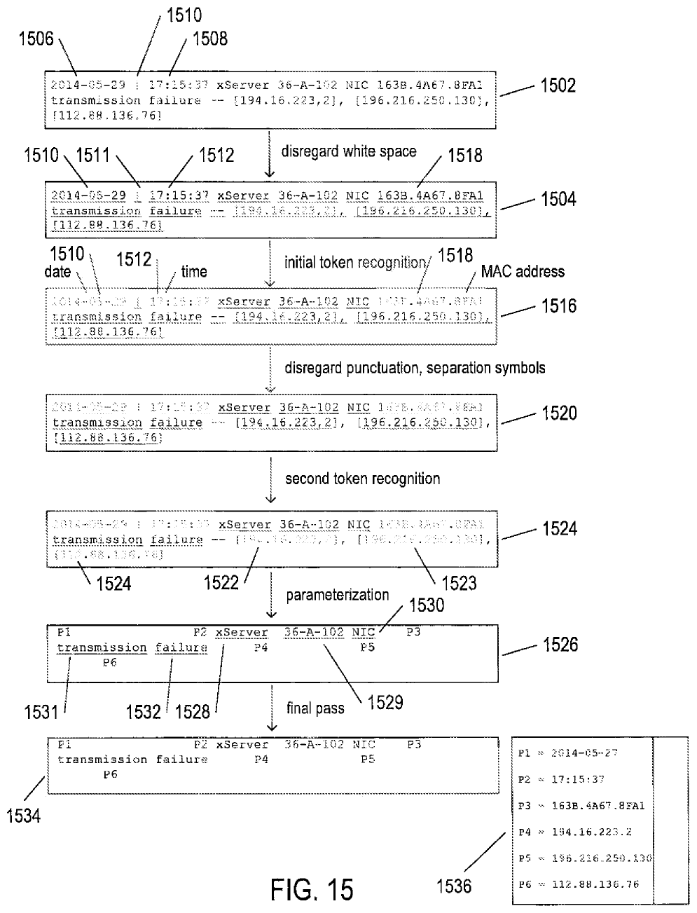

FIGS. 15-20 illustrate one implementation of the logic used by an event-message-clustering system to compute a metric for a received event message that allows the event message to be assigned to a particular existing cluster. FIG. 15 illustrates one implementation of an event-message-normalization procedure that is used to prepare an event message for computation of a metric. The received event message 1502 is first tokenized by considering the event message to consist of tokens separated by non-printing characters, referred to as “white space.” In FIG. 15, this initial tokenization of the event message 1504 is illustrated by underlining of the printed or visible characters. For example, the date 1506, time 1508, and vertical bar 1510 at the beginning of the text contents of the event message 1502, following initial tokenization, become a first token 1510, a second token 1511, and a third token 1512, as indicated by underlining.

Next, an initial token-recognition pass is made to recognize any of the initial tokens as various types of parameter values. Parameter values are tokens or message fields that are likely to be highly variable over a set of messages of a particular type. Date/time stamps, for example, are nearly unique for each event message, with two event messages having an identical date/time stamp only in the case that the two event messages are generated within less than a second of one another, when seconds are the smallest granularity of time encoded in the date/time stamp. Additional examples of parameters include global unique identifiers (“GUIDs”), hypertext transfer protocol status values (“HTTP statuses”), universal resource locators (“URLs”), network addresses, and other types of common information entities that identify variable aspects of a type of event. By contrast, the phrase “transmission failure” in event message 1502 likely occurs within each of a large number of transmission-failure event messages. In FIG. 15, the recognized tokens in the event message following initial token recognition 1516 are indicated by shading. In the example shown in FIG. 15, initial token recognition determines that the first token 1510 is a date, the third token 1512 is a time, and the seventh token 1518 is a media access control address (“MAC address”). Various types of symbolically encoded values, including dates, times, machine addresses, network addresses, and other such parameter values can be recognized using regular expressions or programmatically. For example, there are numerous ways to represent dates. A relatively simple program or a simple set of regular expressions can be written to recognize symbolically encoded dates in any of the common formats. It is possible that the token-recognition process may incorrectly determine that an arbitrary alphanumeric string represents some type of symbolically encoded parameter when, in fact, the alphanumeric string only coincidentally has a form that can be interpreted to be a parameter value. The currently described methods and systems do not depend on absolute precision and reliability of the event-message-normalization process. Occasional misinterpretations generally do not result in mistyping of event messages and, in the rare circumstances in which event messages may be mistyped, the mistyping is most often discovered during subsequent processing. Relatively computationally straightforward processing methods are adopted in the currently described methods and systems for normalization and typing of event messages, because event messages are generally continuously received at high rates, as a result of which the computational overhead associated with processing of each event message represents a significant constraint.

In certain implementations, normalization may terminate following initial token recognition. In the implementation illustrated in FIG. 15, the event message is subject to an additional token-recognition step after re-tokenizing the non-parameter portions of the event message by removing punctuation and separation symbols, such as brackets, commas, and dashes that occur as separate tokens or that occur at the leading and trailing extremities of previously recognized tokens, as shown by underlining in the event message 1520 in FIG. 15. After removal of the punctuation and separation symbols, an additional token-recognition pass in the example of FIG. 15 recognizes additional types of symbolically encoded parameter values, including the three version-4 Internet-protocol (“IPv4”) addresses 1522-1524 in event message 1524.

Those tokens that have been recognized in the two token-recognition passes are considered to be parameters, denoted “P1,” “P2,” . . . “P6” in the parameterized event message 1526 in FIG. 15. The remaining tokens 1528-1532 represent the non-parameter tokens present within the event message. A final pass may involve promoting one or more of the non-parameter tokens to parameters based on certain criteria. For example, token 1529 in the parameterized event message 1526 might be considered to be a parameter value that represents the identifier of a server. In the example shown in FIG. 15, however, no additional tokens are promoted to the status of parameter values following the final pass 1534. The result of normalization is therefore a sequence of non-parameter tokens interspersed with parameter values 1534 and a table 1536 that shows the type and symbol encodings for the parameter values. There are many computational techniques for encoding a list of non-parameter tokens recognized within an event message including, as one example, a list of pointers and associated string lengths.

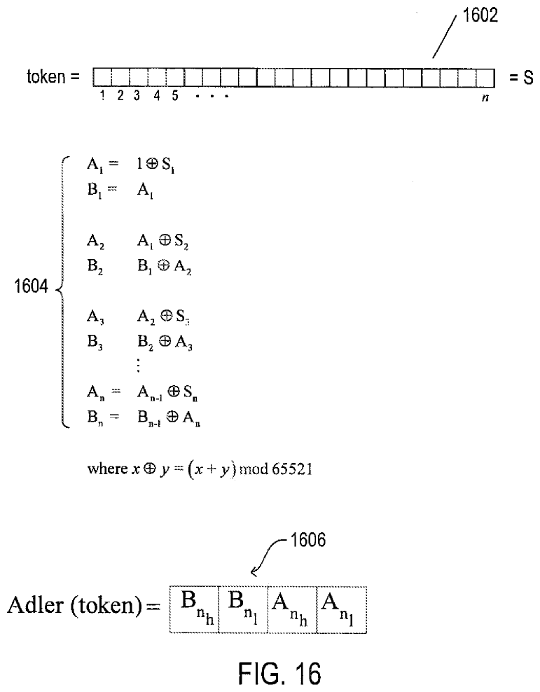

FIG. 16 illustrates the computation of the Adler cyclic redundancy check (“CRC”) value from a token comprising a string of characters. As shown at the top of FIG. 16, the token can be thought of as an array of characters 1602 S. Two 16-bit values Aₙ and Bₙ are computed as indicated by the recursive expressions 1604 in FIG. 16. The high and low bytes of the two 16-bit values Aₙ and Bₙ are arranged 1606 into a 32-bit value that constitutes the Adler CRC for the token. The Adler CRC values are computed, in many cases, to recognize corruptions of a token following network transmission or other such operations. Small one-bit and two-bit transmission errors result in very different Adler CRC values computed for the original token and corrupted token received through an error-introducing communications medium. In one implementation of the currently described methods and systems, the Adler CRC is used for computing a metric m for an event message.

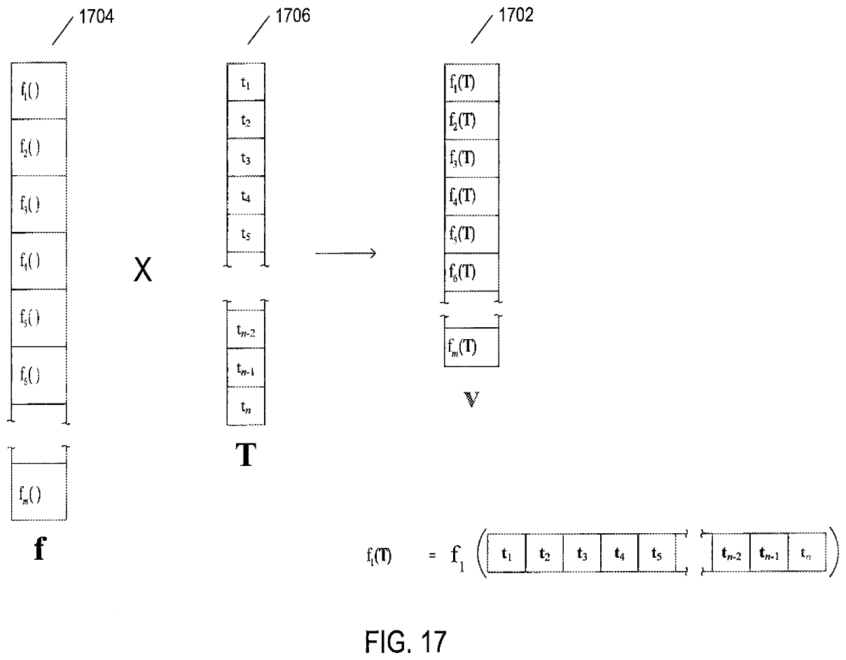

FIG. 17 illustrates computation of a metric m for an event message. In certain implementations of the currently described methods and systems, the metric m is a vector of integer values. This vector, referred to as a “feature vector,” can be thought of as being computed by a matrix-multiplication-like operation. In FIG. 17, the feature vector v 1702 is produced by a matrix-multiplication-like operation in which a matrix-like vector of m functions 1704, each of which takes n arguments is multiplied by a vector of non-parameter tokens identified within an event message 1706 to produce the feature vector v 1702. The number of elements, or number of dimensions, of the feature vector v is equal to the number of functions in the matrix-like function vector f and the number of arguments supplied to each function n is equal to the number of non-parameter tokens n in the ordered set of non-parameter tokens T corresponding to an event message.

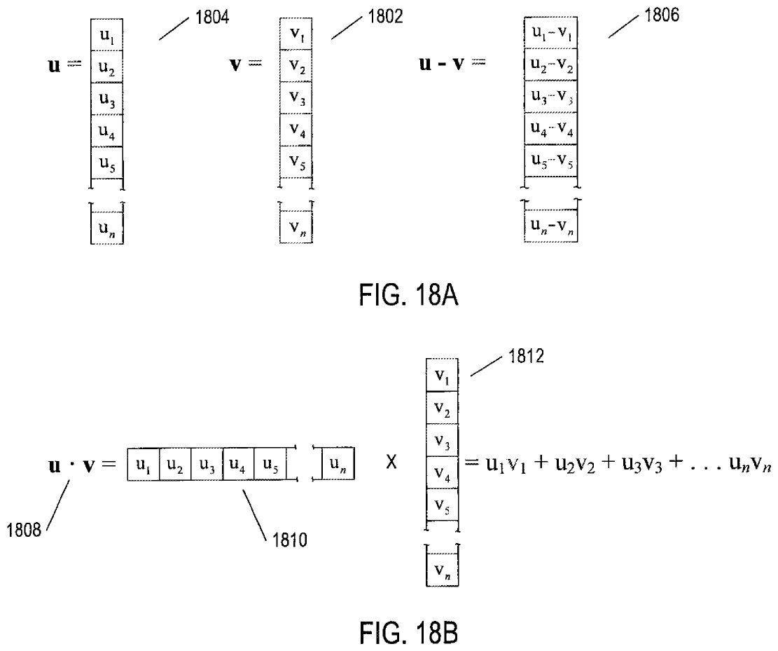

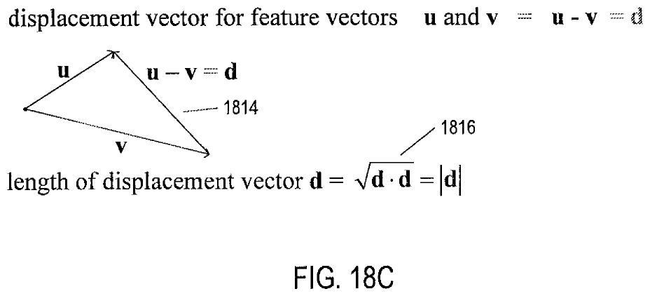

FIGS. 18A-C illustrate computation of the distance between two points represented by vectors. Vectors of dimension n can be thought of as directed distances in an n-dimensional space or as the coordinates for points in an n-dimensional space, where the ray between the origin and the point is equal to the directed distance represented by the vector. FIG. 18A illustrates vector subtraction, in which a vector v 1802 is subtracted from a vector u 1804 to produce the result vector u-v 1806. FIG. 18B shows the computation of the dot product u v of two vectors u and v. The dot product 1808 can be viewed as a matrix multiplication between the transpose of the first vector 1810 and the second vector 1812. FIG. 18C illustrates computation of the distance between two points represented by two vectors u and v. First, a displacement vector d is computed as u-v 1814. Then, the length of the displacement vector is computed as the square root of the dot product of the displacement vector 1816. The distance between two event messages can be similarly calculated as the square root of the dot product of the difference, or displacement vector, computed from the two feature vectors corresponding to the two event messages. Thus, the metric m computed by one implementation of the event-message-clustering system, discussed in FIGS. 14A-C, is a feature vector and an event message is assigned to that cluster for which the distance between the event message and the first event message assigned to the cluster is minimal. In other words, the clusters represent regions in an m-dimensional space that contain similar event messages.

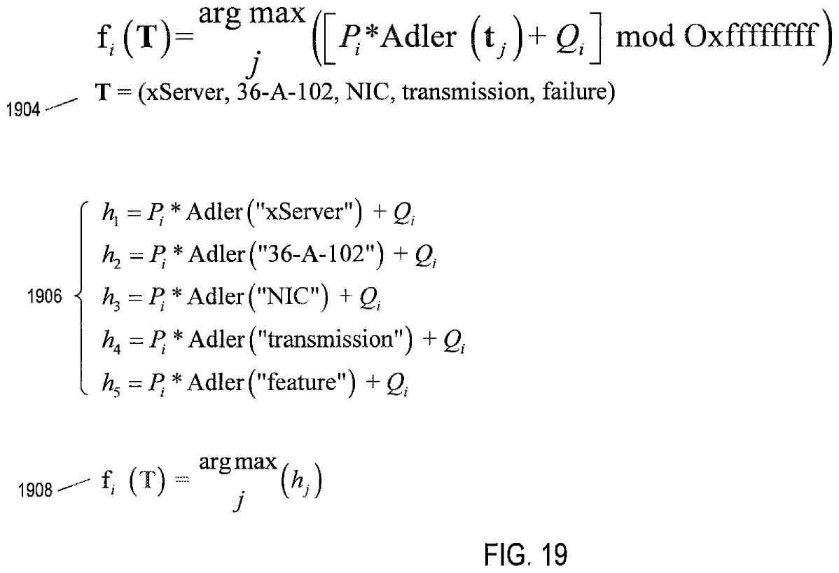

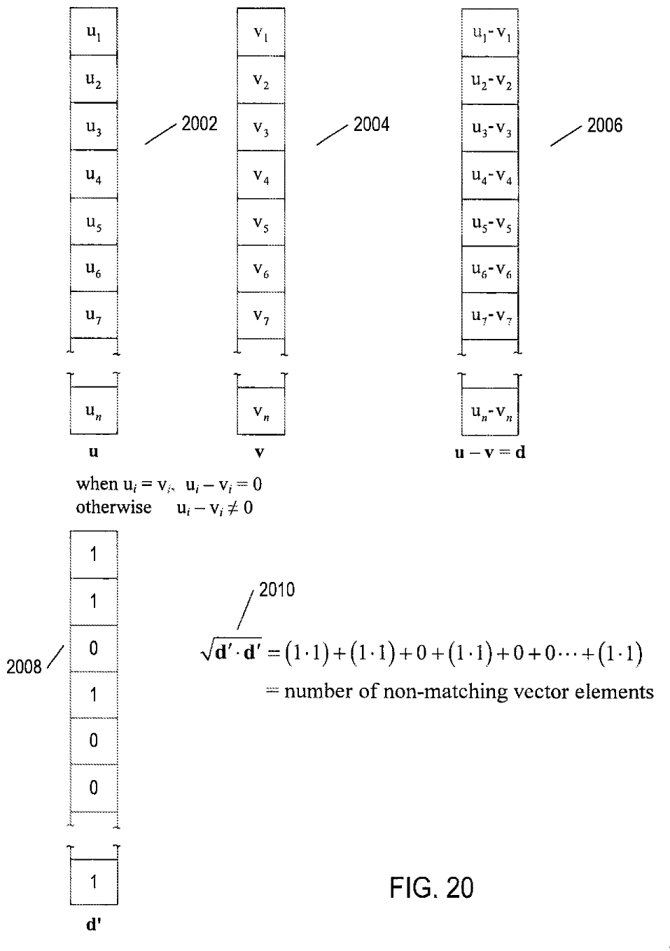

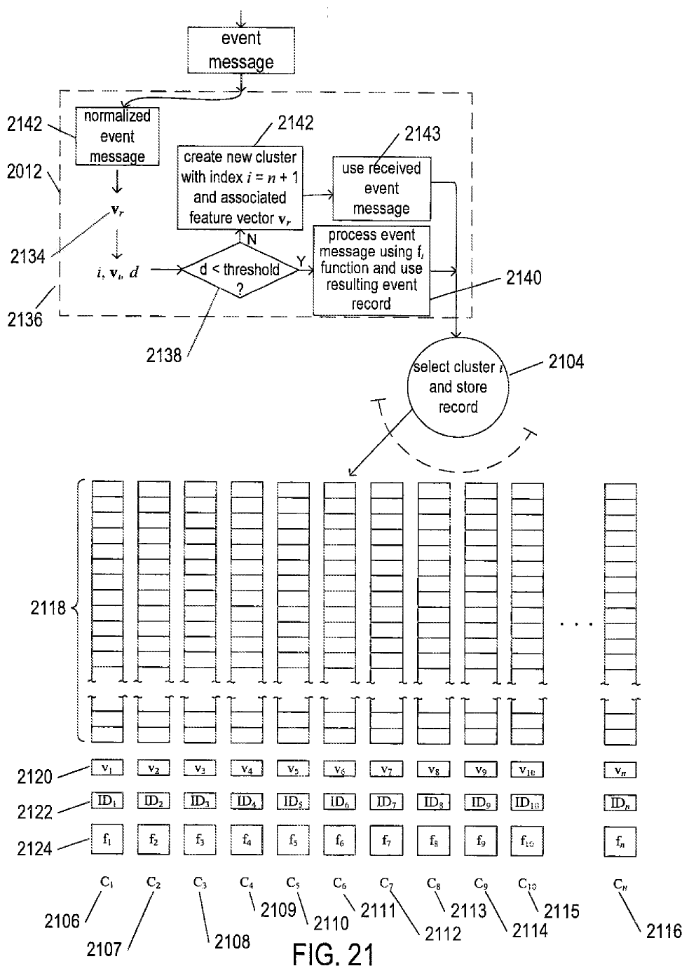

FIGS. 19 and 20 illustrate one particular implementation for computing feature vectors and the distance between event messages represented by feature vectors. As shown in FIG. 19, the function fᵢ( ) for computing the value of element i of a feature vector, in the described implementation, is:

$$\\ {f}_{i} ( T ) = {arg max}_{j} ( [ {P}_{i} * Adler ( {t}_{j} ) + {Q}_{i} ] mod 0 \times ffffffff ) .$$

In essence, the function ƒᵢ( ) computes, for each non-parameter token tⱼ in the event message T, the Adler CRC value, multiplies the Adler CRC value for tⱼ by a first constant, and then adds a second constant to the product of the Adler CRC value for tⱼ and the first constant. The result is truncated to a 32-bit value using a mod operation. The function ƒᵢ( ) returns the maximum of these computed values for each of the non-parameter tokens. FIG. 19 provides an example using the example tokenized event message 1534 of FIG. 15. The non-parameter tokens together comprise an ordered set of tokens T 1904. The function ƒᵢ( ) computes a 32-bit value hⱼ for each non-parameter token tⱼ as shown in the set of five expressions 1906. The function ƒᵢ( ) returns the maximum of these computed values 1908.

FIG. 20 illustrates computing the distance between two event messages represented by two feature vectors computed for the two event messages. FIG. 20 shows a first feature vector u 2002 corresponding to one event message and a second feature vector v 2004 corresponding to another event message. To compute the distance between the two event messages, a displacement feature vector d 2006 is first computed. Because the values of the feature-vector elements are computed based on Adler CRC values, differences between elements do not correspond to distances in particular dimensions, since CRC functions tend to produce very different values for different, but similar tokens. Therefore, when two corresponding elements of two feature vectors are identical, and their differences equal to zero, then the distance-metric for these element values is zero, but when the difference between two corresponding feature-vector element values is non-zero, it can only be concluded that the corresponding feature-vector element values are different and thus are separated by some distance in the corresponding dimension. In the described implementation, all non-zero element values in the displacement vector 2006 are replaced by the value “1” to produce a modified displacement vector d′ 2008. The square root of the dot product of the modified displacement vector 2010 is equal to the number of non-matching feature-vector elements in the two feature vectors u and v or, equivalently, to the number of non-zero elements in the modified displacement vector d′. However, the square root of the dot product of the modified displacement vector is a type of displacement-based metric, just not the familiar Euclidean, or L2, distance metric. Were a similarity-preserving hash function used, rather than the Adler CRC, in computing the feature vector, a stepwise distance metric closer to the L2 distance metric would be computable from the feature vectors representing two event messages.

FIG. 21 illustrates an implementation of the event-message-clustering system to which the current document is directed at a greater level of detail than, but using the same illustration conventions as used in, FIG. 14A. In FIG. 21, the event-message-clustering system includes event-message-processing logic 2102, a distributor component 2104, and a set of n clusters 2106-2116. Each cluster includes a number of assigned event records, such as the assigned event records 2118 for cluster 2106, a feature vector for the cluster, such as feature-vector 2120 for cluster 2106, a cluster identifier, such as cluster identifier 2122 for cluster 2106, and a processing function, such as processing function 2124 for cluster 2106, that can be used by the event-message-clustering system to parse an event message in order to extract parameter values from the event message. As discussed above with reference to FIG. 14A, after a cluster is first created, the cluster temporarily stores event messages, rather than event records, and is associated with a temporary ID and no parsing function. However, once downstream analysis systems have analyzed an initial set of event messages associated with, or assigned to, the cluster, the downstream analysis systems provide a final identifier and parsing function for the cluster to the event-message-clustering system. When a next event message 2130 is received by the event-message-clustering system, the event message is normalized 2142, as discussed above with reference to FIG. 15, and a feature vector vᵣ 2134 is computed for the normalized event message, as discussed above with reference to FIGS. 16-18. The computed feature vector vᵣ is compared with all of the feature vectors for the n clusters to determine a cluster i associated with feature vector vᵢ for which the distance d computed for vᵣ and vᵢ is minimal 2136. When d is less than a threshold value 2138, the event message is processed using function ƒᵢ associated with cluster i to produce a corresponding event record which is output, along with the cluster index i, to the distributor subcomponent 2104. Otherwise, when d is not less than the threshold 2138, a new cluster is created with index i=n+1, the feature vector computed for the received event message vᵣ is associated with this cluster 2142, and the received event message is passed, along with the cluster index, to the distributor subcomponent 2104. The distributor subcomponent 2104 then assigns the event message or event record to the cluster with index i. Again, the event messages and event records associated with clusters may be physically stored by the event-message-clustering system or may be stored by another component, with the event-message-clustering system either returning event messages and event records to requesting downstream components or references to event messages and event records stored in another component. Event records and event messages may be deleted from clusters, copied to other locations, and periodically archived.

The feature-vector-based typing of event messages provides a first estimate of event-message classification. However, downstream analytical components that analyze event messages may determine that two or more clusters represent a single event-message type and may therefore request that the clusters corresponding to these types be merged together. Similarly, downstream analytic components may determine that the event messages in a particular cluster actually have two or more different types and may therefore request the event-message-clustering system to split the cluster into two or more clusters. The merge and split operations thus allow a refinement or fine tuning of the initial feature-vector-based event-message typing carried out by the event-message-clustering system.

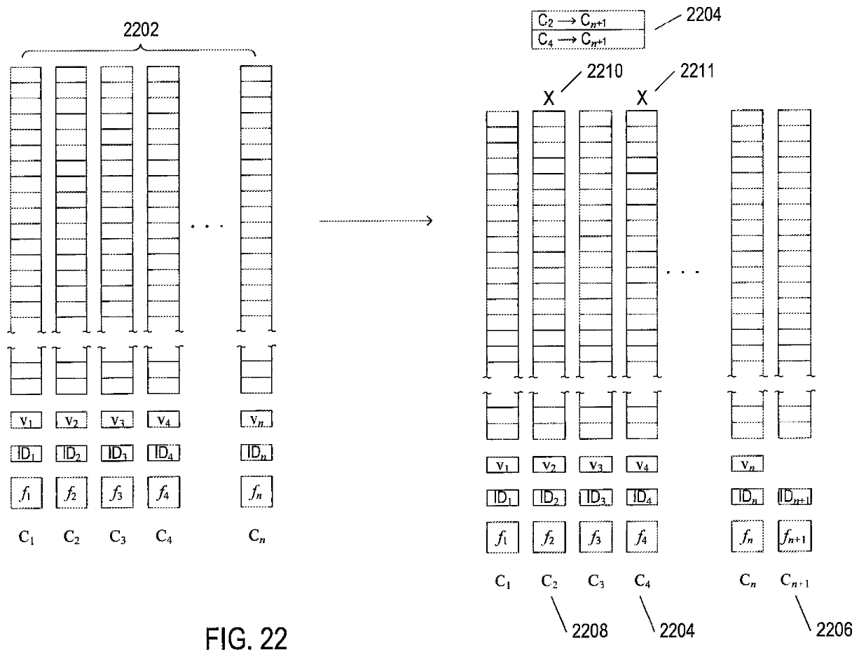

FIG. 22 illustrates a cluster-merge operation. The left portion of FIG. 22 shows n existing clusters 2202 within the event-message-clustering system. A downstream component requests that clusters C₂ and C₄ be merged together. As a result, the event-message-clustering system creates two rules 2204 that indicate that event messages initially typed to belong to C₂ and C₄ now belong to a new cluster Cₙ₊₁. The new cluster 2206 is created to store subsequently received event messages that were previously typed as belonging to clusters C₂ and C₄ and clusters C₂ and C₄ 2208-2209 are marked 2210 and 2211, respectively, to indicate that they will no longer be receiving event records and that, after a period of time, may be removed or returned to a pool for reallocation.

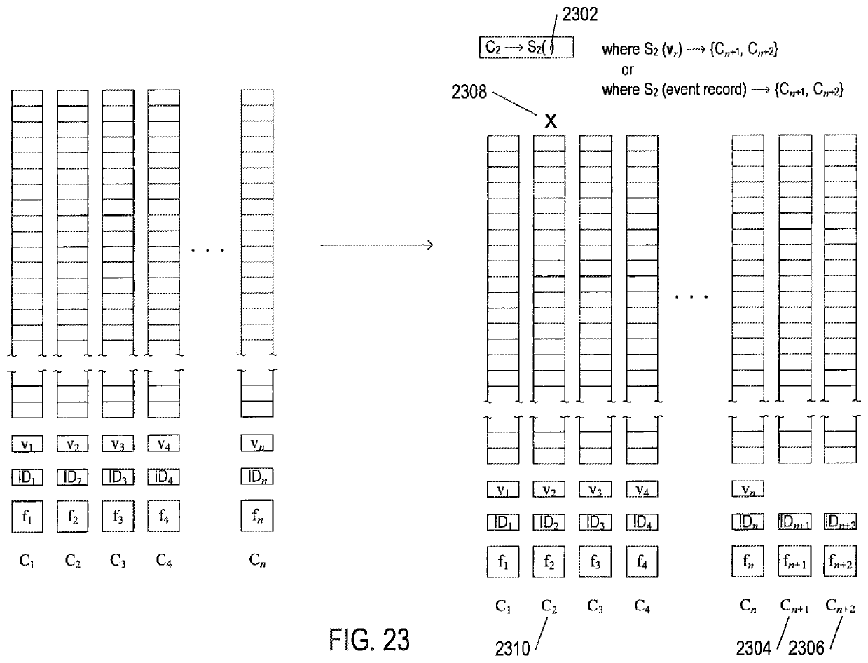

FIG. 23 illustrates a cluster-split operation. In an example shown in FIG. 23, a downstream component requests that a cluster C₂ be split into two new clusters. The downstream component additionally provides a function S₂( ) that takes either a feature vector vᵣ or an event record, as an argument, and returns an indication of which of two or more clusters to assign an event record. In response to the split request, an event-message-processing system adds a split rule 2302 to a set of stored rules that indicates that an event message assigned to cluster C₂ should now be assigned to the cluster returned by a call to the function S₂( ), where the function S₂( ) returns either Cₙ₊₁ or Cₙ₊₂. In addition, the event-message-clustering system creates the two new clusters Cₙ₊₁ and Cₙ₊₂ 2304 and 2306. Finally, the event-message-clustering system marks 2308 cluster C₂ 2310 as no longer receiving event records and as a candidate for removal or reallocation after some period of time. Note that, in the implementation described in FIGS. 22 and 23, new clusters created as a result of merge and split operations are not associated with feature vectors, since event records are directed to these clusters in two steps, the last of which involves applying a redirection rule, such as the redirection rules 2204 and 2302. In alternative implementations, rather than using CRC functions for computing feature vectors, similarity-preserving hash functions may instead be used, as a result of which distances computed as the magnitude of displacement computations on feature vectors may correspond to the degree of dissimilarity between event messages represented by the feature vectors. In this case, the event-message-clustering system may be able to use adjustable thresholding and newly computed feature vectors associated with merge and split clusters in order to direct event messages to appropriate clusters based on the computed feature vectors as in the logic 2102 discussed above with FIG. 21.

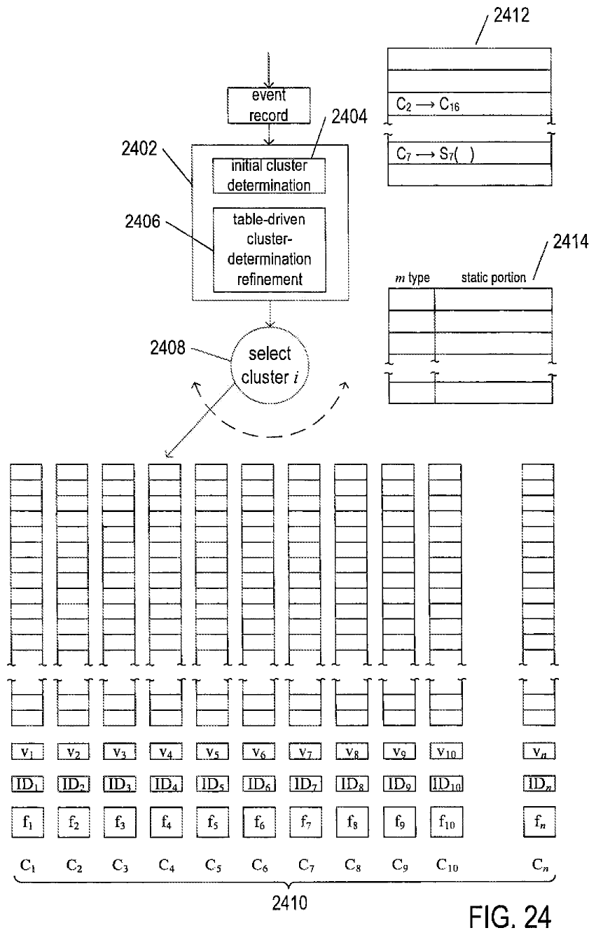

FIG. 24 provides a final illustration of one implementation of the event-message-clustering system to which the current document is directed. FIG. 24 uses similar illustration conventions as used in FIGS. 21 and 14A. The event-message-clustering system includes event-message-processing logic 2402 which includes initial cluster determination logic 2104 and table-driven cluster-determination refinement logic 2406. The initial cluster determination logic 2404 normalizes an input event message, computes a feature vector from the non-parameter tokens within the normalized event message, and uses the feature vector to identify a cluster to which to assign the event message. The table-driven cluster-determination-refinement logic 2406 applies redirection rules in a table of redirection rules in order to carry out any specified redirection of the initial cluster determination that results from previous merge and split operations, as discussed above with reference to FIGS. 22 and 23. The distributor subcomponent 2408 and clusters 2410 are similar to those described with reference to FIG. 21. The event-message-clustering system additionally includes a table of redirection rules 2412 and a table of static portions for each message type 2414 that allow the event-message-clustering system to regenerate original event messages from event records should the original event messages be needed. The table of redirection rules 2412 includes at most one entry for each cluster identifier. A particular cluster may be associated with a single redirection rule or may not be associated with a redirection rule. As discussed above, the redirection rules either indicate to which cluster an event message initially designated as belonging to a first cluster should be forwarded or includes a rule that uses a function to determine to which cluster to forward an event message initially determined to belong to a cluster that was subsequently split. When a redirection rule is applied to a first cluster indication to generate a second cluster identification, the redirection-rule table is again accessed to determine whether there is another redirection rule that may be applied to the second cluster identification. In other words, redirection rules are iteratively applied until a cluster indication is obtained for which there is no redirection rule in the redirection-rule table.

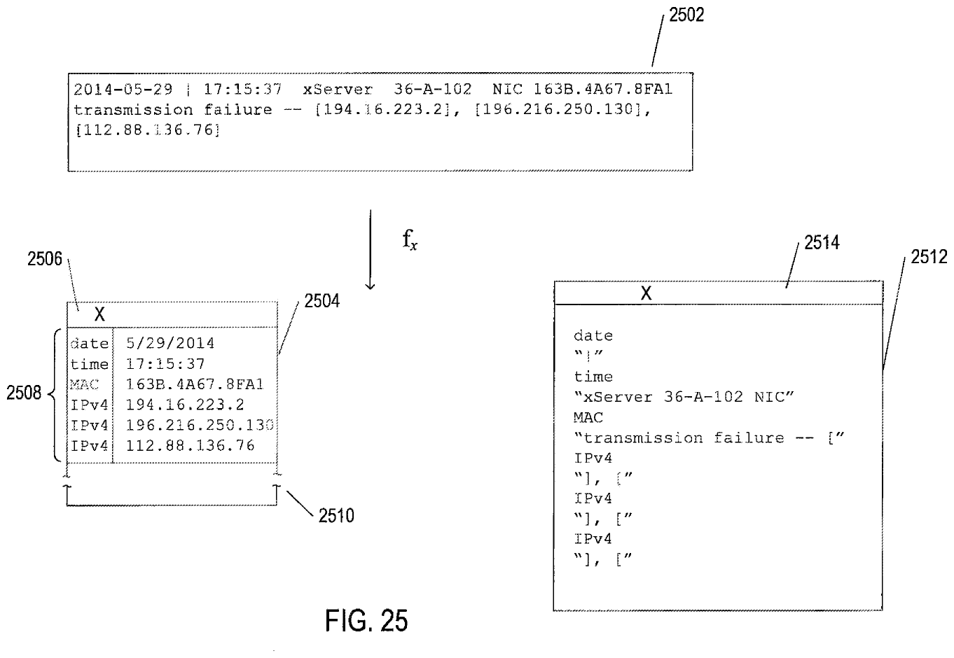

FIG. 25 illustrates a process that extracts parameter values from an event message. As discussed above, each cluster is associated with a parsing function that allows the event-message-clustering system to extract parameter values from the event message. In the example shown in FIG. 25, the function ƒₓ associated with a cluster corresponding to event-message type x, when applied to a received event message of type x 2502, returns an ordered list of parameter values extracted from the message. The sorted list of parameter values can be assembled into an event record 2504 that describes the received event message. The event record may include a header with an indication of the event type 2506, a list of parameter values and associated parameter types 2508, and any additional information 2510 that an event-message-clustering system may choose to associate with event records, including details with regard to from where the event message was received. A representation of the static, non-parameter portion of the message 2512 along with an indication of the message type 2514 may be stored in the static-portion table (2414 in FIG. 24) to allow the original message 2502 to be reconstituted from the event record 2504 generated from the original event message.

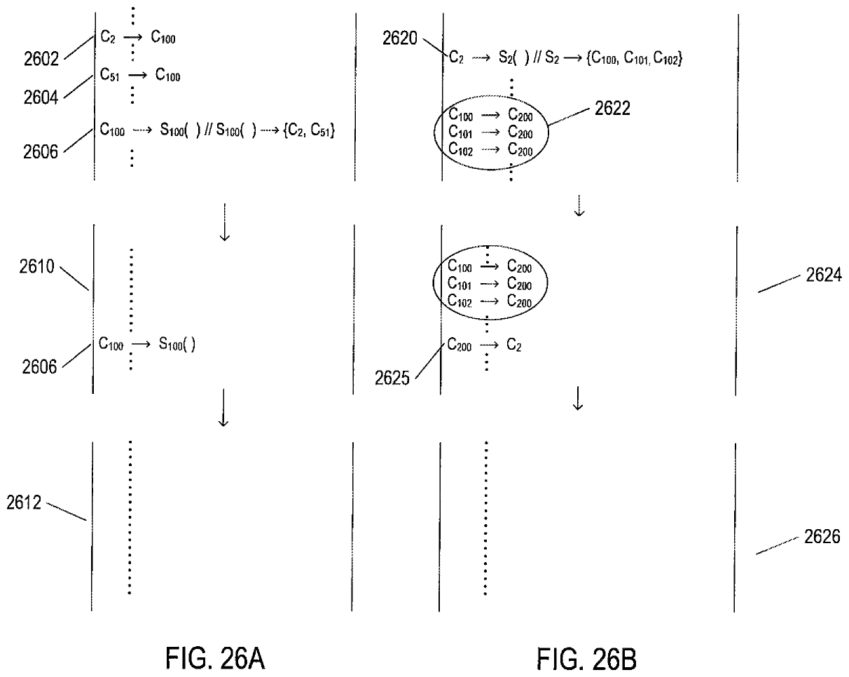

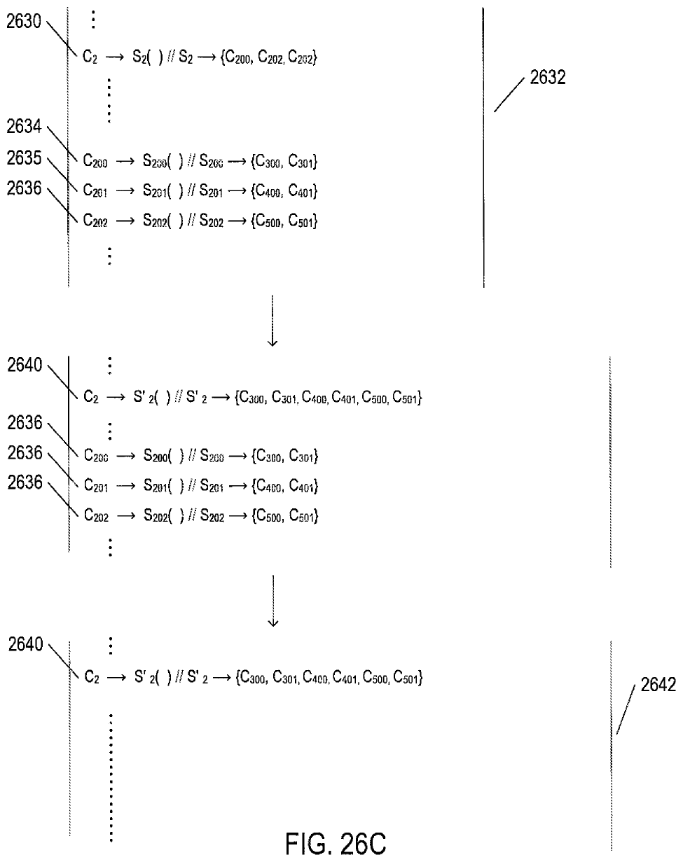

The redirection rules stored by the event-message-clustering system may be periodically analyzed in order to remove and archive unneeded redirection rules. In addition, this analysis may recognize situations in which some number of redirection rules can be replaced, often along with readjustments in the set of clusters managed by the event-message-clustering system. FIGS. 26A-C illustrate examples of editing of the redirection-rule table. In FIG. 26A, the redirection-rule table includes two merge redirection rules 2602 and 2604 and a subsequently added split redirection rule 2606. As it turns out, the split redirection rule 2606 essentially reverses the merge operation represented by the two merge redirection rules 2602 and 2604. In this case, the clusters C₂ and C₅₁ can be re-established and the two merge redirection rules 2602 and 2604 removed, temporarily leaving the split rule 2606 to allow event messages that were typed as belonging to cluster C₁₀₀ to be retyped during subsequent processing, as shown in the intermediate redirection-rule table 2610. Ultimately, once all event records typed as belonging to cluster C₁₀₀ have been flushed or archived, the split rule 2606 can be removed to completely restore the redirection table with respect to clusters C₂ and C₅₁ 2612.

FIG. 26B shows another example of redirection-rule-table editing. In this example, cluster C₂ was split, as a result of which the split rule 2620 was added to the redirection-rule table. Subsequently, merge rules 2622 that reverse the split operation were added to the redirection-rule table. In this case, the split rule 2620 can be removed and the original cluster C₂ re-established, producing an intermediary redirection-rule table 2624. Once all the event records typed as belonging to events C₁₀₀, C₁₀₁, C₁₀₂, and C₂₀₀ have been removed and archived from the event-message-clustering system, the merge rules and redirection rule can be removed to restore the redirection-rule table to its initial condition with respect to cluster C₂ 2626.

FIG. 26C shows yet an additional example of redirection-rule table editing. In this example, the cluster C₂ was split three ways, resulting in the addition of redirection rule 2630 to the redirection-rule table 2632. Subsequently, each of the new clusters created as a result of the split operation were again split, resulting in the addition of split redirection rules 2634-2636. This set of split redirection rules can be modified by creating a comprehensive split rule 2640 to directly split cluster C₂ into the six clusters C₃₀₀, C₃₀₁, C₄₀₀, C₄₀₁, C₅₀₀, and C₅₀₁. The three split redirection rules 2634, 2635, and 2636 are maintained until all event records typed as belonging to clusters C₂₀₀, C₂₀₁, and C₂₀₂ are removed and archived. Then, they can be removed leaving only the comprehensive split redirection rule 2640 in the redirection-rule table 2642. FIGS. 26A-C illustrate a few simple examples of redirection-rule-table editing and associated cluster reorganization. There are many additional, more complex examples in which chains and cycles of redirection rules can be removed from the redirection table. In addition, clusters can be periodically re-indexed in order to compress the range of active cluster indexes.

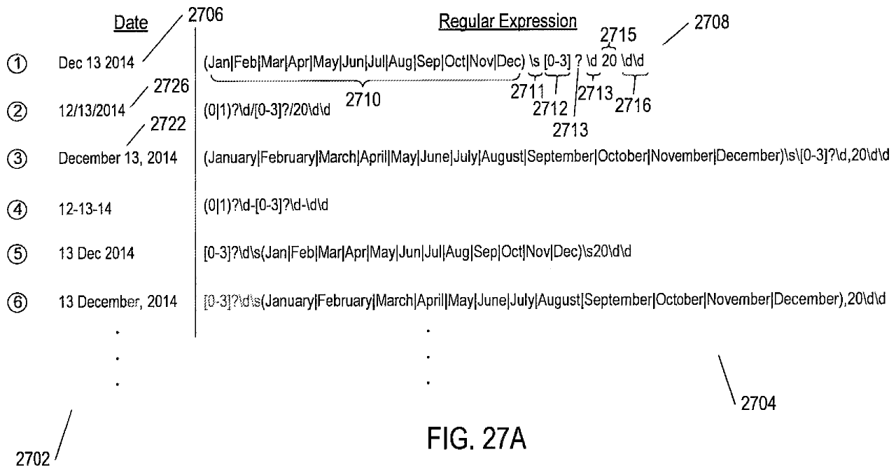

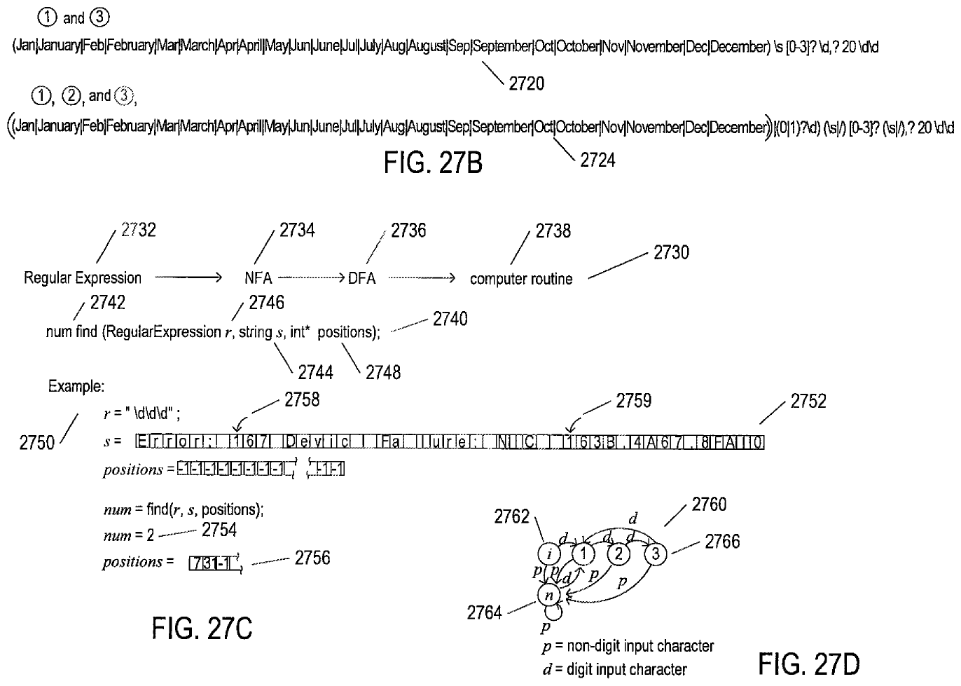

One approach to identifying variables in event messages as well as to generating parsing functions for event-message clusters is to use regular expressions. FIG. 27A illustrates regular expressions corresponding to various types of formats in which dates may be encoded in event messages. In FIG. 27A, examples of numerous date formats are shown in a left column 2702 and corresponding regular expressions that can be used to identify substrings of symbols within a symbol string representing dates in the formats are provided in a right-hand column 2704. Regular expressions are generally symbolic encodings of search patterns that can be applied to text in order to identify substrings. The details regarding various regular-expression syntaxes can be found in numerous references. Regular expressions are widely used in text-processing programs and are included in many modern programming languages, including Perl, Ruby, Python, and C++ 11.

In one type of symbolic encoding of dates, a date 2706 can be expressed as a three-character indication of the month, followed by a space, followed by a one-digit or two-digit representation of the day of the month, followed by another space, and finally followed by a four-digit representation of the year. The regular expression 2708 represents a search pattern that can be used to find symbolic encodings of dates, in the format described with reference to date 2706 in FIG. 27A, in text and symbol strings. The parenthesized list of vertical-bar-delimited three-character month specifications 2710 indicates that any of these three-character month specifications may occur as the first part of the symbolic encoding of a date. The “Is” 2711 indicates a single white-space character, the bracketed digit range 2712 indicates that one of the digits 0, 1, 2, or 3 may next occur, but the question mark 2713 indicates that the digit may or may not be present, the “Id” 2714 indicates that a single digit next occurs, the substring “20” 2715 indicates that the digits 2 and 0 next follow, and the pair of “/d” substrings 2716 indicate that two additional digits next occur.

In general, there is not a unique one-to-one mapping between date formats and regular expressions. Many different regular expressions can be developed to represent a search pattern for any particular data-encoding symbol format. Furthermore, more complex regular expressions can be devised to more exactly specify the substrings that can represent a particular date format. For example, regular expression 2708 would identify “Feb. 31 2014” within a symbol string as a date, but, of course, February 31^{st} is not a valid date. A more complicated regular expression can be devised to exclude such invalid dates.

FIG. 27B illustrates construction of generalized regular expressions that identify two or more types of date formats. For example, regular expression 2720 can be used to identify substrings representing dates encoded in either of the first and third date formats shown in the left-hand column 2702 of FIG. 27A. These two different types of date formats are similar, differing in that the month is fully spelled out in the third format 2722 in FIG. 27A, rather than abbreviated, as in the first format 2706 and the third format includes a comma following the day, while the first format does not. Regular expression 2724 can be used to identify dates encoded in any of the first three formats 2706, 2726, and 2722 illustrated by example in FIG. 27A. A generic regular expression can be developed to recognize dates encoded in any of a very large number of different possible date-encoding formats. However, in general, the more different formats recognized by a regular expression, the larger and more complex the regular expression. In many cases, it is more computationally efficient to develop a number of regular expressions to recognize a corresponding number of classes of date formats and to apply the number of regular expressions iteratively to text in order to identify all the possible dates within the text. The methods described below employ table-driven searching in which regular expressions are successively extracted from a table and applied to an event message in order to identify data encoded in particular formats associated with particular data types.

FIG. 27C illustrates an example of the use of regular expressions in text processing. First, as shown by expression 2730 in FIG. 27C, it is well known that a regular expression 2732 can be transformed into a non-deterministic finite automata 2734. A non-deterministic finite automata can, in turn, be transformed into a deterministic finite automata 2736, and deterministic finite automata 2736 can be implemented as a computer routine 2738. In other words, a computer routine can be developed to recognize sub strings within text specified by any given regular expression. These computer routines can be embedded within text-processing routines, many examples of which can be found in text-processing applications and included in programming languages. One example is a routine “find” that returns the indices of substrings within an input string identified by an input regular expression. FIG. 27C shows a declaration for the function “find” 2740. The function returns the number of sub strings 2742 identified within an input string 2744 that correspond to an input regular expression 2746 and additionally returns, in an array of indices 2748, the indices of the starting positions within the string of each identified substring corresponding to the input regular expression. For example, when the input regular expression indicates a succession of three digits 2750, input of the string 2752 to the function “find” returns the number 2 (2754 in FIG. 27C) and the indices 2756 of two three-digit substrings. The initial symbols, or digits, of the two three-digit substrings are shown by arrows 2758-2759 in FIG. 27C.

FIG. 27D shows a representation of the deterministic finite automata 2760 corresponding to the regular expression 2750 in the example shown in FIG. 27C. The deterministic finite automata is a state-transition diagram that includes an initial state 2762, a non-digit state 2764, and three digit states, the last 2766 of which represents identification of a three-digit substring. Arrows represent transitions between states that occur on input or consideration of a next symbol of a symbol string. The identification of a three-digit substring can be recorded upon reaching the final digit state 2766.

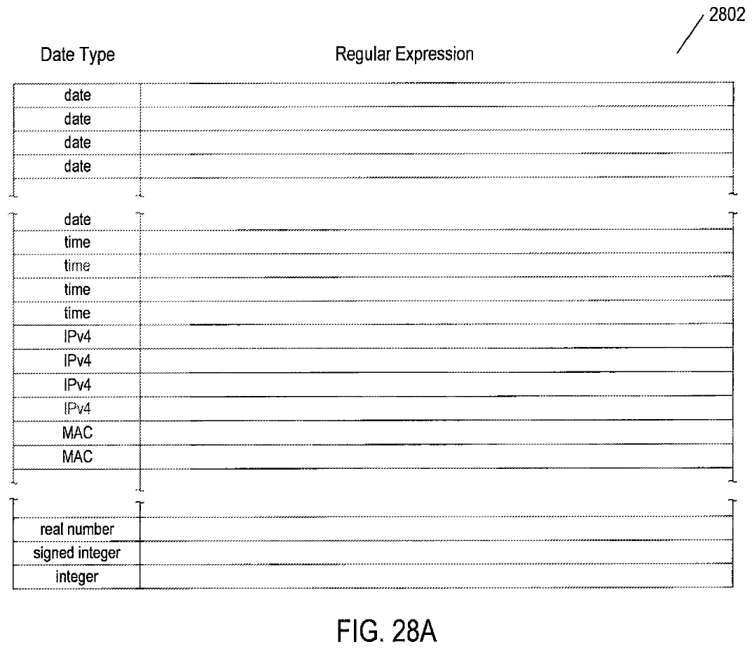

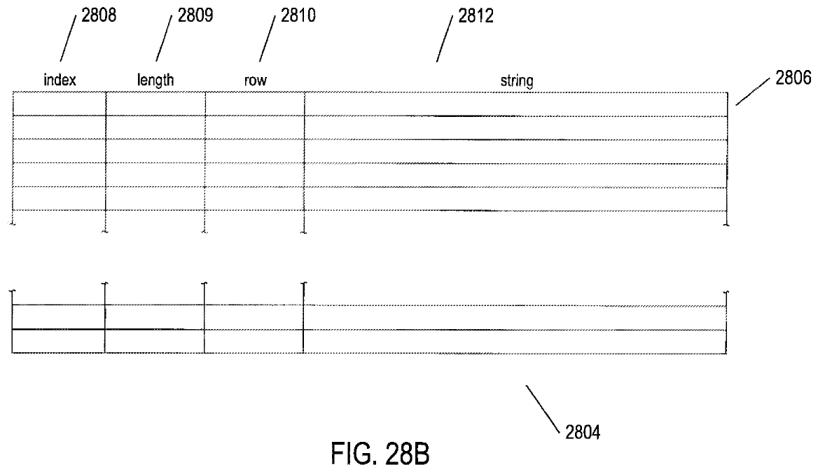

Regular expressions can be used, in one implementation of the currently described event-message-clustering subsystem, to identify variables within an event message. FIGS. 28A-B illustrate implementation of a regular-expression-based variable-finding subsystem. FIG. 28A shows a table of data-type/regular-expression pairs 2802 that provides a basis for variable identification. For each format or class of formats for each different data type of variables in event messages, a regular expression is stored in the table. In general, the table is ordered, with more specific data types occurring before, or higher in the table than, more generic encoded data. For example, date and time formats are generally readily recognized in text and are not ambiguous with respect to formats for other data types, and therefore occur higher in the table than more generic data types, such as integers. FIG. 28B shows a results table in which results of the variable-identifying subsystem are stored for a particular processed event message. Each row in the results table 2804, such as row 2806, represents an identified variable within an event message. The variable is characterized by an index of the starting symbol of the variable 2808, the length of the symbol string corresponding to the variable 2809, the row of the data-type table (2802 in FIG. 28A) corresponding to the data type of the variable 2810, and the substring that encodes the variable within the event message 2812.

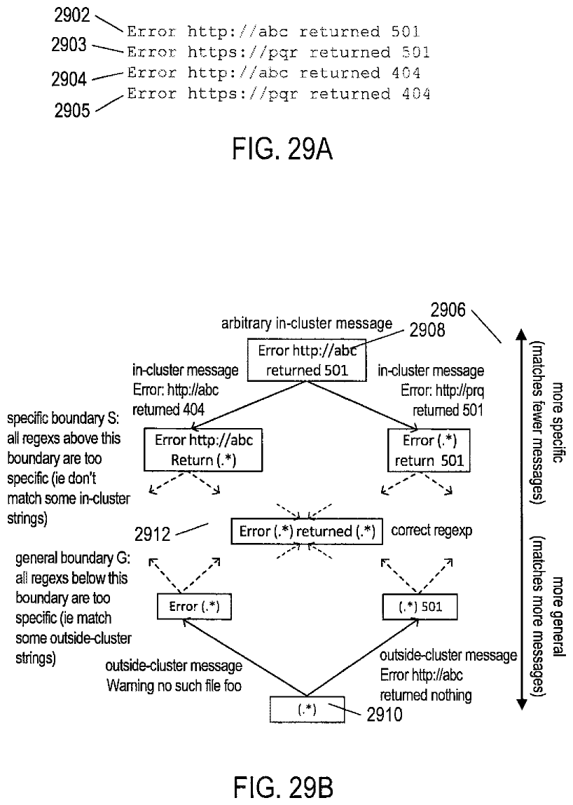

FIGS. 29A-B illustrate a general approach to generating a parsing function for an event-message cluster. FIG. 29A shows four very short event messages of a particular event-message cluster 2902-2905. FIG. 29B illustrates a variety of different regular-expression-based parsing functions for the event-message cluster positioned along a vertical dimension of specificity 2906. The most specific parsing function 2908 is the literal string corresponding to the first event message 2902. This parsing function would be very effective for recognizing the first event message, but would fail to recognize any of the other event messages in the cluster. Thus, parsing function 2908 is far too specific to be used as the parsing function for a cluster containing the four event messages. By contrast, the most generalized parsing function 2920 would return success for all four of the event messages 2902-2905 in the cluster. However, this generic parsing function would return success when applied to any event message. A useful parsing function for the cluster 2912 represents a balance, in specificity, between the most general parsing function 2910 and the most specific parsing function 2908. In the useful parsing function 2912, a regular expression that can be applied to event messages, the common static portions of the event messages within the cluster are represented by literals, including the sub string “Error” and the sub string “returned.” The variable substrings within the event messages are represented, in the regular expression 2912, by the regular sub-expression “(.*),” which matches any substring, including an empty substring. Finding an appropriate regular-expression-based parsing function for a cluster of event messages thus involves generating a regular expression that represents a specificity balance and that can be used to extract the variable portions of the event messages of a cluster.

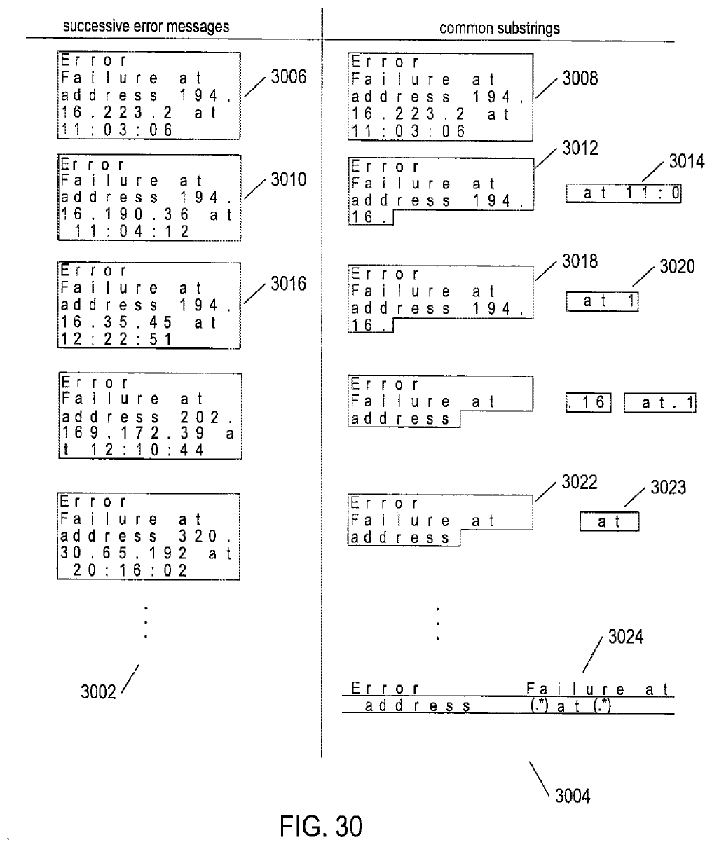

Next, one approach to generating useful parsing functions for event-message clusters is described. FIG. 30 provides an illustrated example of the common-substring-recognizing method. In a left column 3002 of FIG. 30, successive event messages within an event-message cluster are shown. A right-hand column 3004 of FIG. 30 shows a currently recognized common substring for the cluster as the method considers, in turn, each successive event message within the cluster. Following consideration of the first event message 3006, the common substring is the entire first event message 3008. This common substring 3008 is next considered with respect to the second event message 3010. Comparison of the common substring 3008 to the second event message 3010 reveals that, following consideration of the first two event messages in the cluster, there are two common substrings 3012 and 3014. These two common substrings 3012 and 3014 represent the common portions of previous common substring 3008 and the second event message 3010. Next, the common sub strings 3012 and 3014 are compared to the third event message 3016. As a result of this comparison, two new common substrings 3018 and 3020 are produced. This process continues with consideration of subsequent event messages to produce common substrings 3022 and 3023 which, should the remaining event messages in the cluster follow the same pattern followed by the initial five event messages in the cluster, represent the common or static portions of all of the event messages within the cluster. These two common substrings 3022-3023 can then be used to create an initial regular expression 3024 as the basis for a parsing function for the event messages of the cluster. This initial regular expression includes the literal strings for the two common substrings and regular-expression sub-expressions “(.*)” for the variable portions of the event messages.

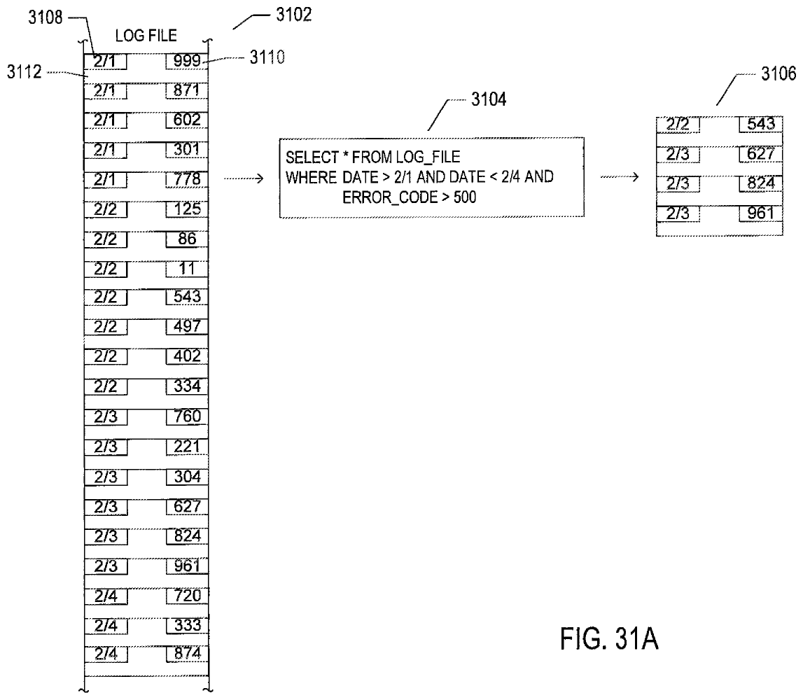

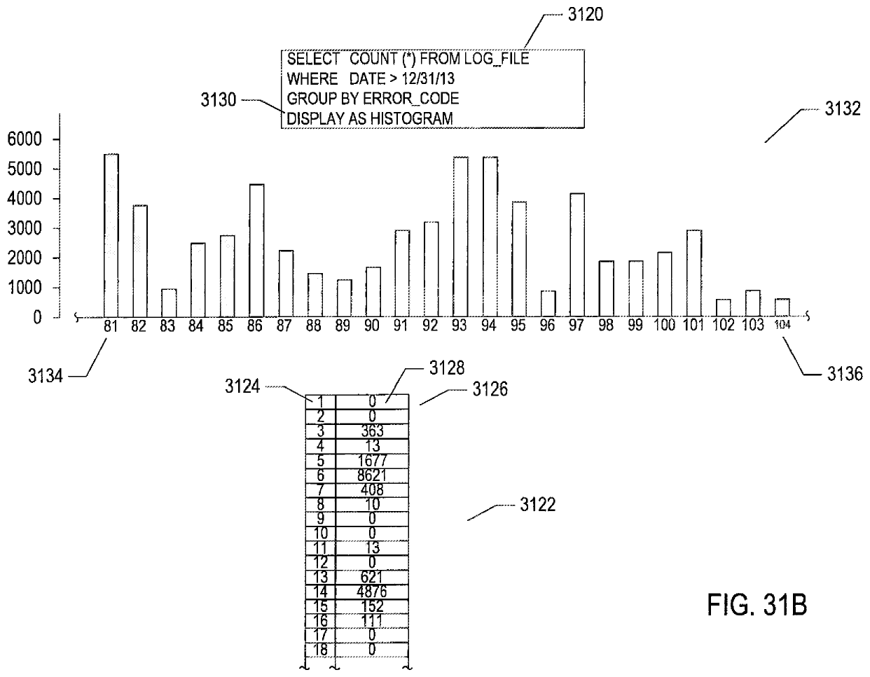

FIGS. 31A-B illustrate generation of event distributions from log-file entries. As shown in FIG. 31A, a log file 3102, such as an individual log file or a virtual log file that represents the contents of many individual log files within a distributed computing system, may be treated as a database of log-file entries. Queries, such as query 3104, may be executed against the contents of a log file or virtual log file to produce a subset 3106 of log-file entries that correspond to the constraints specified in the query. Another way of looking at the query-execution process is that the query 3104 operates as a filter to select, or accept, only a subset 3106 of the total number of entries within a log file or virtual log file 3102. In the example shown in FIG. 31A, the query 3104 is shown in a structured-query-language (“SQL”) form, as commonly used in relational-database queries. In the simple example shown in FIG. 31A, the date and error_code fields of simplified log entries are shown with example values, such as the date field containing the date “2/1” 3108 and the error_code field containing the error code “999” 3110 in log-file entry 3112. Query 3104 selects, from the log file, those entries for which the date field is greater than 2/1 and less than 2/4 and for which the error_code field has a value greater than 500. Of the log-file entries displayed in the portion of the log-file shown in FIG. 31A, only the four entries in the subset of log-file entry 3106 meet the constraints of the query 3104.

As shown in FIG. 31B, a query 3120 can be used to select the number of log-file entries for each different possible error code. The result of the query can be viewed as a table 3122, each row of which contains the indication of an error code, such as the error code “1” 3124 in the first row 3126 of the table, and a field containing the count of the number of log-file entries with that error code, such as the count “0” 3128 in the first row 3126 of the table 3122. Query 3120 also includes a directive 3130 “DISPLAY AS HISTOGRAM.” This results, in one implementation, in the display of a histogram-like plot 3132 of the number of log-file entries for each of the possible error codes. Only a portion of the plot is shown in FIG. 31B that includes vertical-bar representations of the counts of the error codes from “81” 3134 to “104” 3136.

A histogram, such as histogram 3132, or a table of counts for the different error codes, such as table 3122, are readily converted into probability distributions. The count for any particular error code divided by the total counts for all of the error codes is the probability that a log-file entry with that error code would be selected at random from the entries within the log file from which the histogram or table is generated. The sum of all of the probabilities for the different error codes is 1.0, consistent with the definition of a discrete probability distribution. Thus, a SELECT query with a “GROUP BY ERROR CODE” clause provides the raw data for generation of a distribution of error_code types within all or a defined subset of the entries of a log file or virtual log file.

In the current document, the histogram plots of error-code counts and the counts of the different types of error codes divided by the total counts are referred to as “probability distributions.” They are probability distributions in the sense that, were one to define a discrete random variable E representing the error code in a sampled log entry, then P(E=e), where e is a particular error code, is computed for a set of N log entries as the number of entries with error code e divided by N. However, these are discrete, rather than continuous probability distributions, and the process by which they are generated is not random sampling. Furthermore, these are simply the distribution of error codes in a set of log entries selected from one or more log files. The distribution generated from a set of log entries does not necessarily have any predictive relationship to other log entries. Thus, it might be more accurate to refer to these computed distributions as “quasi-probability distributions.” It is important to note that the order in which the counts of error-code types is displayed has no significance. The order of the histogram bars in histogram 3132 in FIG. 31B or the orders of the rows in table 3122 in FIG. 31B can be arbitrarily reordered without affecting the analyses of these quasi-probability distributions, discussed below, or the use of these quasi-probability distributions for monitoring state changes within a distributed computer system. In general, the order of error codes does not reflect relative properties of error codes. For example, the fact that the error codes for two errors are adjacent in a numerical ordering of the error codes generally does not imply that the errors are related or more related than error with error codes displaced by a large distance in the numerical ordering. The error codes thus do not generally have a meaningful ordering. Peak-like features in histogram 3132 in FIG. 31B, for example, have no significance with respect to the use of the data in monitoring state changes within a distributed computer system. However, when the histogram bars are consistently numerically ordered by error code, visual comparison of two histograms can reveal differences in the distribution of error codes within two different sets of log entries. The significant features are disparities in the heights of histogram bars associated with a particular error code.

Queries, such as query 3120 in FIG. 31B, can be used to select counts for the different types of events or error codes within log-file entries that represent various subsets of log-file entries available for analysis. In many cases, the subsets of log-file entries are obtained by query logic that selects a subset of queries created or received during a particular time interval. However, in other cases, the subsets may be alternatively specified. As one example, a subset may include log-file entries generated by a particular computer system or a particular subsystem within a particular computer system. Furthermore, the queries may be further restricted to select counts for only a subset of all of the possible event types or error codes. In certain cases, discussed below, the probability distributions generated from such queries provide a type of fingerprint or snapshot of the state of a log file or log files for particular intervals in time. By comparing these distributions, changes in the state of the log files, which reflect changes in the state of a distributed system, can be detected between different periods of time. In other cases, the distributions may serve as fingerprints for particular computer systems, for particular types of operational characteristics or behaviors, and for essentially any arbitrary conditions, time intervals, localities, or other phenomenon on the basis of which the subsets of log-file entries from which the probability distributions were specified. In other words, comparing the probability distributions generated from the results of two queries carried out on a large set of available log-file-entries provides insight as to the similarity or dissimilarity between characteristics of the subsets of log-file-entries specified in the queries.

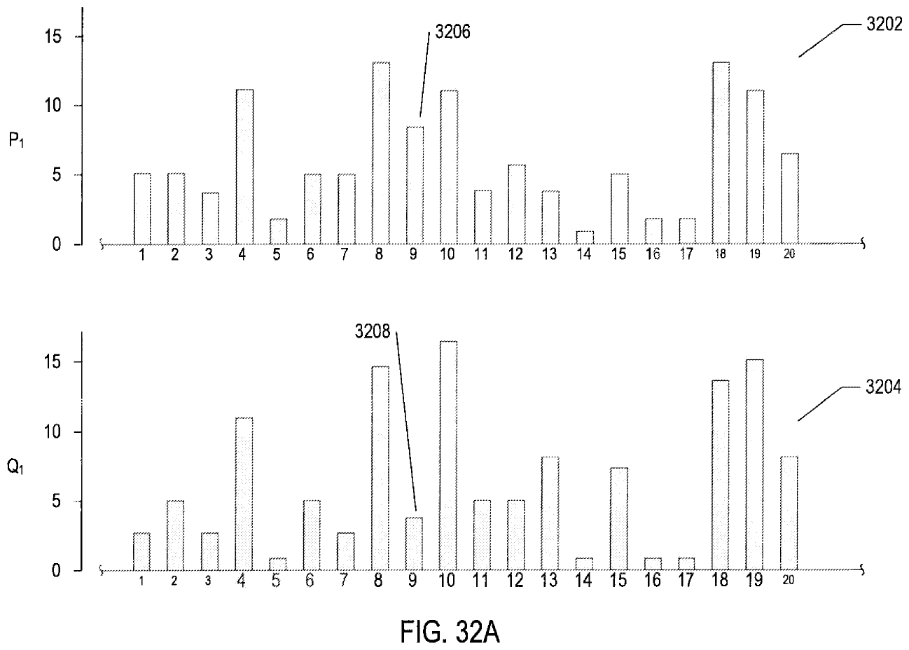

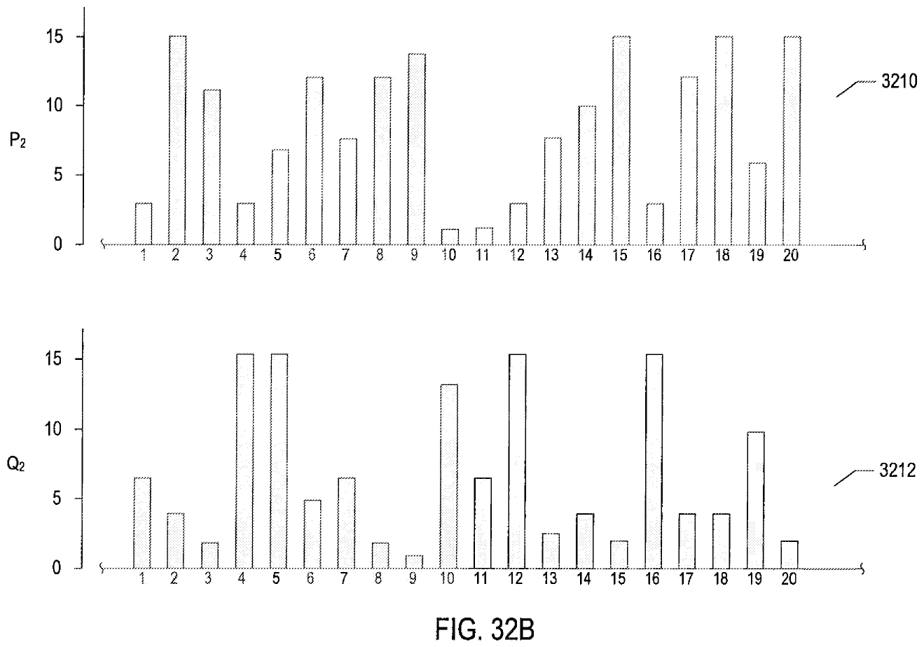

FIGS. 32A-B show event-type histograms collected from different time intervals using queries, such as query 3120 in FIG. 31B, executed against one or more log files or virtual files. In FIG. 32A, a first histogram 3202, corresponding to a probability distribution P₁ of event types, or error-code values, is generated from log-file entries collected during a first interval of time and second histogram 3204, corresponding to a second probability distribution Q₁, is generated from log-file entries selected from a log file or virtual log file with respect to a second time interval. In this example, and in subsequent examples, only a small number, 20, of error_code types or event types are considered. A visual comparison of the two histograms reveals that, for the most part, they reflect similar probability distributions. There are differences. For example, the count of log-file entries with event type “9” 3206 in the histogram 3202 corresponding to the probability distribution P₁ is significantly greater than the count 3208 for log-file entries with error_code value “9” and the second histogram 3204 corresponding to probability distribution Q₁. Nonetheless, the overall shapes of the two histograms are visually similar. Thus, one might conclude, from visual inspection, that the states of the distributed computing system reflected in the log-file entries for the two periods of time are similar. By contrast, FIG. 32B shows two different histograms 3210 and 3212 based on queries against log-file entries of two different time intervals and corresponding to the two different probability distributions P₂ and Q₂. In this second case, the two histograms differ significantly, and one would likely conclude, based on visual inspection, that the states of the distributed computing system in these two different time intervals, as reflected in probability distributions P₂ and Q₂, are quite different.

A log-file analytics application may allow an administrator or other user to generate probability distributions and display them as histograms from log-file entries selected for different time intervals, much as the pairs of histograms are displayed in FIG. 32A-B. This would provide a useful graphical visualization of the states of the distributed computer system from which the log-file entries are gathered over different periods of time. Visual comparison often provides a powerful analytical tool to human users. Of course, as discussed above, only comparison of the heights of histogram bars for a particular error code has significance. The ordering of the histogram bars and apparent peaks and other features in the displayed histogram have no significance. Nonetheless, when the histogram bars are identically ordered, for example, in ascending error-code numerical order, visual comparison can provide a quick type of analysis to look for significant differences between error-code-distribution fingerprints computed for different time intervals. However, the examples shown in FIGS. 32A-B are very simple examples featuring a very small number of different event types or error codes. In an actual system, as pointed out above, there may be thousands, tens of thousands, or more different event types or error codes. Furthermore, the data may appear quite noisy and many of the differences may be relatively subtle and difficult to discern when visually displayed as histograms. In many cases, log-file analyses need to be fully automated and incorporated into subsystems of a distributed computing system. For automated systems, visual comparison of histograms is clearly an inefficient approach to discerning differences in the states of a distributed computing system over different periods of time. Furthermore, visual display of the distributions may inadvertently lead system administrators to make unwarranted assumptions and conclusions from insignificant, but visually apparent, features in the histogram, as discussed above. For these reasons, a numeric method is desirable for determining the extent that two different event-type or error-code probability distributions generated from log-file entries differ.

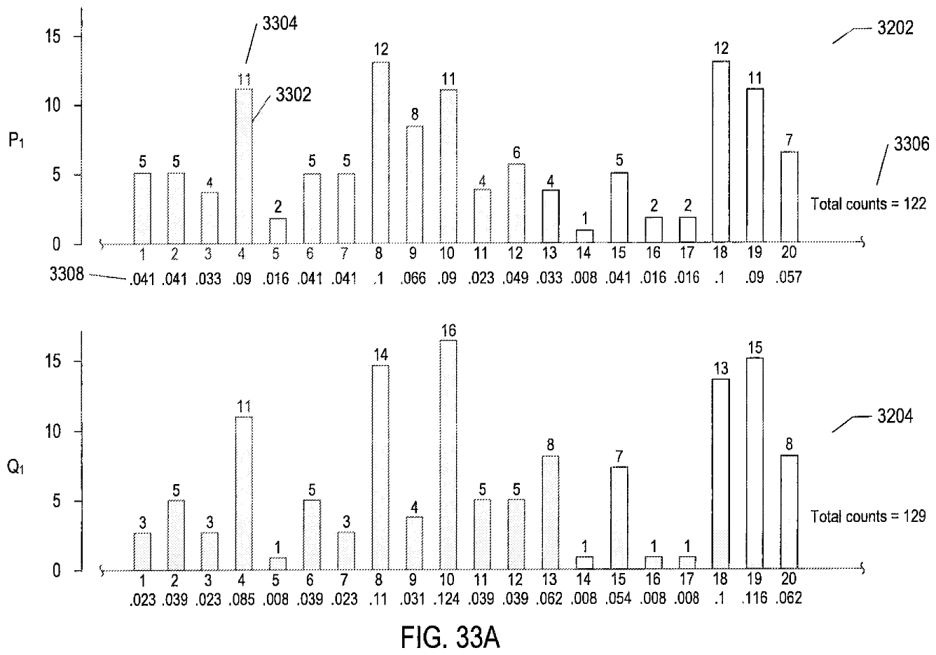

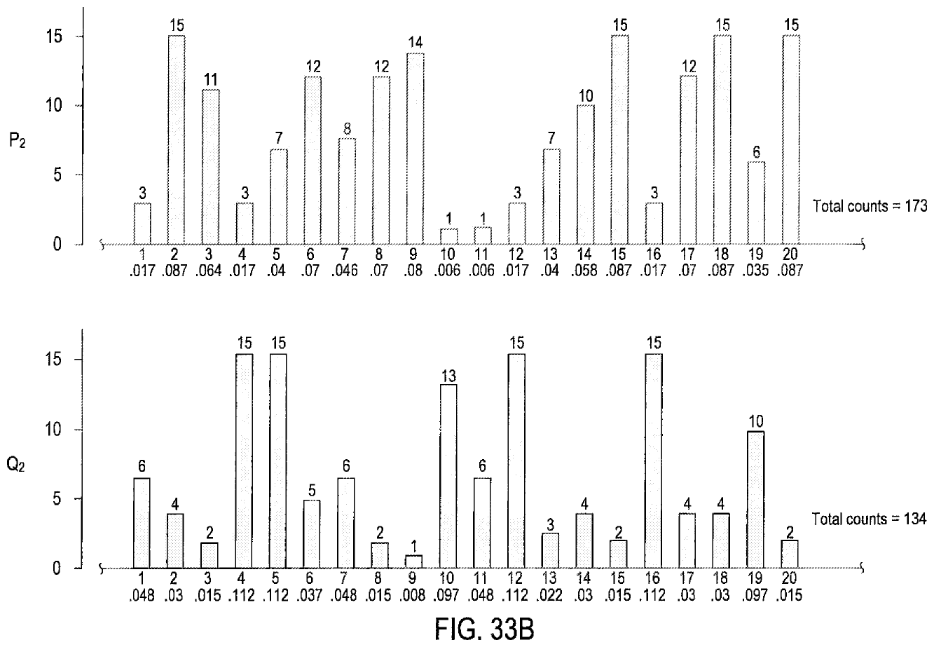

FIGS. 33A-B illustrate conversion of the histograms shown in FIG. 32A-B into numeric probability distributions. FIG. 33A shows histograms 3202 and 3204 from FIG. 32A. Above each vertical histogram bar, such as vertical histogram bar 3302, the count or number of log-file entries with the particular event type or containing the particular error code is provided as an integer, such as the integer “11” 3304 indicating that vertical histogram bar 3302 represents the fact that 11 log-file entries containing the error code value 4 were observed in the time interval from which the log-file entries were selected. All of the counts represented by all of the vertical histogram bars are added together to produce a total-count or total-number value 3306. Then, the count corresponding to each vertical bar is divided by the total counts to produce the probability value for each different error code value. These probabilities are shown as a horizontal line of values 3308 below the histogram, each probability value corresponding to a particular error code value. The sum of the probability values is 1.0.

One measure of the similarity or difference of two probability distributions, such as those generated in FIGS. 33-B, is referred to as the Kullback-Leibler divergence. Expressions for the Kullback-Leibler divergence are provided below:

$$\\ \begin{matrix}{D}_{KL} ( P ‖ Q ) = \sum P ( i ) log \frac{P ( i )}{Q ( i )} , & ( 1 )\end{matrix}$$

$$\\ \begin{matrix}{D}_{KL} ( Q ‖ P ) = \sum Q ( i ) log \frac{Q ( i )}{P ( i )} . & ( 2 )\end{matrix}$$

The Kullback-Leibler divergence has several significant characteristics. First, D_{KL}(P∥Q)≠D_{KL}(Q∥P). This is one reason that the computed Kullback-Leibler metrics are not distances between different probability distributions in a probability-distribution space. The metric from P to Q is not the same as the metric from Q to P. Another characteristic, and in fact, the motivation for using, the Kullback-Leibler divergence is that the magnitude of the computed Kullback-Leibler divergence is proportional to the dissimilarity between the two probability distributions. As discussed above with reference to FIG. 32A, the two histograms 3202 and 3204 visually appear similar, and their Kullback-Leibler metric values of 0.035 and 0.024 are relatively small. By contrast, the two distributions shown as histograms in FIG. 32B, 3210 and 3212, appear to be quite dissimilar, and their Kullback-Leibler divergence values of 0.368 and 0.407 are much larger than the Kullback-Leibler divergence values for distributions 3202 and 3204. Thus, the Kullback-Leibler divergence values for pairs of probability distributions of log-file entries provides a numeric indication of the dissimilarity between two probability distributions.

Unfortunately, the Kullback-Leibler metric has several characteristics that render it unsuitable for automatic analysis of log-file-entry probability distributions. One drawback is the fact that the Kullback-Leibler divergence is not symmetric, as discussed above. A more serious drawback is that the Kullback-Leibler metric cannot tolerate 0-probability values in the probability distributions that are being compared. Note that a 0 value in the denominator of the argument of the log function in the Kullback-Leibler expressions would result in an improper value. In many cases, if not almost all cases, in which a reasonably large set of different event types or error codes are considered in generating a probability-distribution fingerprint from selected log-file entries, many of the probabilities are generally 0. In other words, when plotted as histograms, the vertical bars would be relatively sparsely arrayed across the horizontal axis.

A second type of metric that can be used to compute a numeric value related to the similarity/difference of two probability distributions is called the “Jensen-Shannon divergence.” One expression for the Jensen-Shannon divergence is provided below:

$$\\ \begin{matrix}JSD ( P ‖ Q ) = \frac{1}{2} {D}_{KL} ( P ‖ M ) + \frac{1}{2} {D}_{KL} ( Q ‖ M ) where & ( 3 )\end{matrix}$$

$$\\ M = \frac{1}{2} ( P \vert + Q ) .$$

The Jensen-Shannon divergence is symmetrical:

J_{SD}(P∥Q)=J_{SD}(Q∥P). (4)

The Jensen-Shannon divergence values fall within the real-number range [0,1]:

J_{SD}(P∥Q)∈[0,1] (5)

A second expression for the Jensen-Shannon divergence is based on the Shannon entropy. The Shannon entropy for a discrete probability distribution P is:

$$\\ \begin{matrix}H ( P ) = - {\sum }_{i} P ( i ) log P ( i ) , & ( 6 )\end{matrix}$$

where the notation P(i) refers to the probability of the occurrence of event i. The Shannon entropy frequently arises in information theory and is related to the uncertainty with respect to random selection of an event given the probability distribution. For example, the Shannon entropy for a coin with two heads computed from the probability distribution of a head or tail resulting from a coin flip is 0 while the Shannon entropy for a fair, balanced coin with both a head and a tail is 1. The Shannon entropy value of 0 reflects the fact that, for a double-headed coin, there is no uncertainty in the outcome. Also, as noted above:

$$\\ \begin{matrix}{\sum }_{i} P ( i ) = 1. & ( 7 )\end{matrix}$$

The second expression for the Jensen-Shannon divergence is:

$$\\ \begin{matrix}JSD = H ( \frac{1}{2} P + \frac{1}{2} Q ) - \frac{1}{2} H ( P ) - \frac{1}{2} H ( Q ) , & ( 8 )\end{matrix}$$

$$\\ = {\sum }_{i} \frac{1}{2} ( P ( i ) + Q ( i ) ) log ( \frac{1}{2} ( P ( i ) + Q ( i ) ) ) + \frac{1}{2} {\sum }_{i} P ( i ) log P ( i ) + \frac{1}{2} {\sum }_{i} Q ( i ) log Q ( i ) ,$$

$$\\ = \frac{1}{2} {\sum }_{i} ( P ( i ) + Q ( i ) ) log \frac{1}{2} - \frac{1}{2} {\sum }_{i} ( P ( i ) + Q ( i ) ) log ( P ( i ) + Q ( i ) ) + \frac{1}{2} {\sum }_{i} P ( i ) log P ( i ) + \frac{1}{2} {\sum }_{i} Q ( i ) log Q ( i ) ,$$

$$\\ \begin{matrix}= 1 + \frac{1}{2} [ {\sum }_{i} P ( i ) log P ( i ) + {\sum }_{i} Q ( i ) log Q ( i ) - {\sum }_{i} P ( i ) log ( P ( i ) + Q ( i ) ) - {\sum }_{i} Q ( i ) log ( P ( i ) + Q ( i ) ) ] . & ( 9 )\end{matrix}$$

One interesting characteristic of the Jensen-Shannon divergence computation is that, when either P(i) is 0 or Q(i) is 0, the sum of all the terms for probability i in the four summations within brackets in the expression (9) above, is 0:

$$\\ \begin{matrix}When P ( i ) = 0 , - P ( i ) log ( P ( i ) + Q ( i ) ) = 0 , & ( 8 )\end{matrix}$$

$$\\ - Q ( i ) log ( P ( i ) + Q ( i ) ) = - Q ( i ) log Q ( i ) , P ( i ) log ( P ( i ) ) = 0 , and$$

$$\\ Qi log ( Q ( i ) ) = Q ( i ) log Q ( i ) ,$$

as a result of which the sum of the 4 terms=0.

As discussed above, when probability distributions are generated for counts of types of log-file entries, there are often many 0-probability values in the distribution, since many types of events or error codes may not be observed within considered time intervals. For all of these cases, as well as cases in which one of the two probability distributions being compared has a 0 probability for event type i and the other probability distribution has a non-0 entry for event type i, no computation is involved for entries i in the two probability distributions. Thus, for example, when a first event-type probability distribution has non-0 values for odd event types and a second event-type probability distribution has non-0 entries for even event types, the Jensen-Shannon divergence can be seen, from expression (9), as having the value of 1.

The Jensen-Shannon divergence provides a basis for many different types of stored-event-record analysis and monitoring of distributed computer systems. Monitoring systems can periodically generate the Jensen-Shannon divergence for the event records generated from event messages collected from a particular event-message source, and the generated Jensen-Shannon divergence can be compared to a base-level Jensen-Shannon divergence to detect changes in the status of the event-message source. The base-level Jensen-Shannon divergence may be computed during a time period during which the event-message source is known to be operating in an expected fashion or may be computed as an average divergence for a number of event-message sources identical or similar to the event-message source. This is one example of how stored event records may be analyzed in order to facilitate management of a distributed computer system and, in particular, to facilitate various types of semi-automated and automated distributed-computer-system management. Stored event records can be queried, in many systems, by system administrators, managers, and other such personnel to facilitate manual analysis and management and can be queried by automated management systems to facilitate automated analysis and management operations. The event-message collection, processing, and storage thus provides the foundation for a wide variety of different monitoring and management tasks.

### Decentralization and Centralization of Event-Message Collection, Processing, Storage, and Filtering

FIG. 34 illustrates the components of one implementation of an event-message collection, processing, and storage system within a distributed computer system. In FIG. 34, the main components are illustrated as labeled rectangles, such as labeled rectangle 3402 representing a collector component, and circular input queues, such as circular queue 3404, represent buffered input to components of the event-message collection, processing, and storage system (“EM system”). Because the component types form a logical pipeline, the component types can be independently scaled, by increasing or decreasing the number of instances of component types, and independently located within a distributed computer system, which, in turn, facilitates fine-granularity scaling of the event-message collection, processing, and storage system, fine-grain load balancing, and decentralization and centralization of the event-message collection, processing, and storage system. Of course, two or more successive components in the pipeline may be combined into a single, aggregate component, with a single input buffer or queue, and when a number of successive components starting with the collector are aggregated, the aggregated component may be referred to as an “agent.”

The first component, collector 3402, receives event messages from event-message sources within a distributed computer system. The collector instance employs a load-balancing method to distribute the received event messages among one or more normalization components 3406. The three circular queues 3408-3410 represent input queues two three different normalization-component instances, with circular queue 3409 serving as the input queue for the illustrated normalization component 3406. While the remaining component types in FIG. 34 are not shown as directing outputs to multiple instances of the next downstream component, they may also do so, in certain implementations, to facilitate fine-granularity scaling and load balancing. The normalization-component instances associated with circular queues 3408 and 3410 are not shown in FIG. 34. As indicated by inset 3412, the normalization components receive raw event messages, in the described implementation. In various different implementations, inputs to a component may be packages or containers containing multiple input objects. For example, in certain implementations, a normalization component may receive input containers that contain multiple raw event messages. The collector component 3402 serves as the entry point to the EM system. As further discussed below, an EM system may include multiple collector-component instances and may also include multiple instances of the other components discussed below.

The normalization component 3406 carries out the normalization task discussed above with reference to FIG. 15. As shown at the bottom of FIG. 15, the normalization component produces an encoding of the static portion of an event message (1534 in FIG. 15) and an encoding of the values of the variables or parameters in the event message (1536 in FIG. 15). The static-portion/variable-values pair produced from an input event message are output to the input queue 3414 of a feature-vector-generation component 3416, in the described implementation. The normalization component, in many implementations, uses a set of regular expressions, indicated by item 3407, to detect parameters or variables within each input event message.

The feature-vector-generation component produces a feature vector corresponding to each input static-portion/variable-values pair, as discussed above with reference to FIGS. 16-19, and outputs the static-portion/variable-values pair together with the corresponding feature vector to the input queue 3418 of an event-type-assignment-and-event-type-generation component 3420. In essence, feature vectors serve as a type of fingerprint or multi-dimensional identifier for event messages and comprise a metric space. The metric for the particular type of feature vectors discussed with reference to FIGS. 16-19 is computed as the length of a difference vector computed from two feature vectors, but this is only one example of a more general class of fingerprints that can be computed from event messages and that are associated with a distance metric.

The event-type-assignment-and-event-type-generation component 3420 uses, in the described implementation, a clustering method to assign event types or event identifiers to each event message. The clustering method employs the distance metric associated with feature vectors, as discussed above with reference to FIGS. 14A-C and 18A-24. In the described implementation, the clustering method employs cluster information 3422 that includes clusters that are each associated with an event type or event identifier, a representative feature vector, and a parsing function. The event-type-assignment-and-event-type-generation component additionally stores the static portions of each type of event message 3424 and generates and uses event-type-specific parsing functions 3425. The event-type-assignment-and-event-type-generation component produces an event record for each received static-portion/variable-values/feature vector triple and outputs the event record to the input queue 3426 of a message-processing-and-storage component 3428.

The message-processing-and-storage component 3428 stores each received event record into an event-message database 3430. In certain implementations, event records are packaged into containers by the event-type-assignment-and-event-type-generation component and the message-processing-and-storage component first unpackages the event records within a received container before processing each of the event messages. The event-message database is subsequently used by downstream systems and components of a distributed computer system, such as a monitor 3432 which retrieves and analyzes event records to generate warnings and alerts to automated and semi-automated distributed-computer-system management-and-administration systems as well as to management-and-administration personnel.

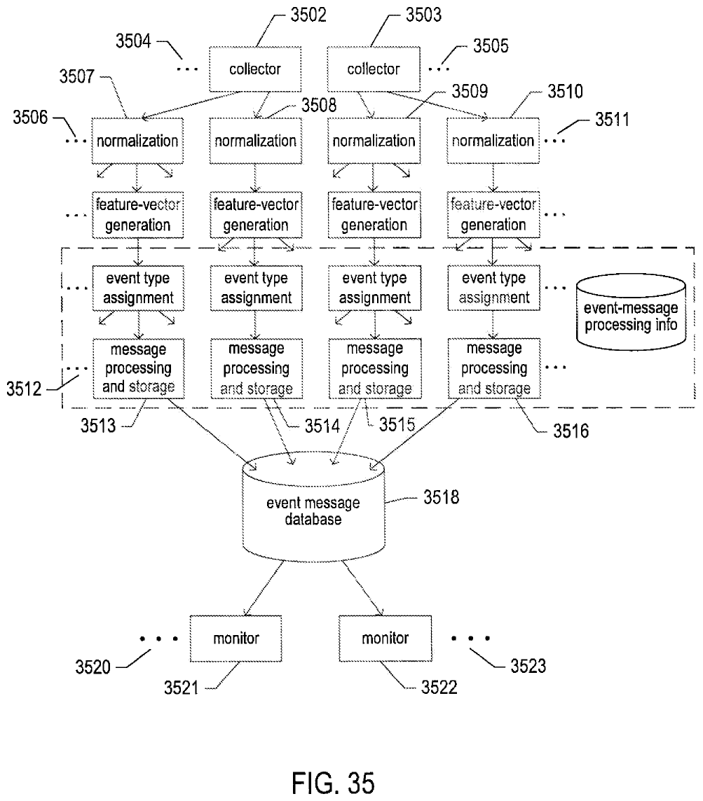

FIG. 35 illustrates distribution of components of an EM system within a distributed computer system. While FIG. 34 shows a linear sequence of components that cooperate to collect, process, and store event messages, FIG. 35 illustrates the fact that a given distributed computer system may include multiple instances of each of the different types of components. For example, an EM system may include multiple collector-component instances 3502-3503, with ellipses 3504 and 3505 indicating a potential for additional collector-component instances, that each distribute event messages to one or more normalization components. In FIG. 35, collector-component instance 3502 distributes event messages to normalization-component instances 3507-3508 and potentially additional normalization-component instances indicated by ellipsis 3506 and collector-component instance 3503 distributes event messages to normalization-component instances 3509-3510 and potentially additional normalization-component instances indicated by ellipsis 3511. Of course, a collector component may distribute event messages to more than two downstream normalization-component instances or may forward event messages to only a single normalization component. Data flows downward, through hierarchies of components, to one or more message-processing-and-storage component instances 3512-3516 which store event records in a distributed event-message database 3518 that can be accessed by one or more downstream analysis and monitoring systems and components 3520-3523. The component instances and organization of the EM system can vary dynamically, over time, to allow the EM system to respond to changes in the components and configurations of, and event-message-generation fluxes within, the distributed computer system in which the EM system runs. Moreover, as further discussed below, the configuration of the EM system can vary with respect to a selected level of centralization/decentralization by adjusting the locations and numbers of different component instances within the distributed computer system. The EM system may be static with respect to centralization/decentralization or may automatically and dynamically adjust the centralization/decentralization level to optimize operation of the EM system. This allows the EM system to take advantage of many different advantages and deficiencies associated with different levels of centralization/decentralization as well as to scale and perform load balancing according to the magnitudes and rates of event-message generation within the attribute computer system.

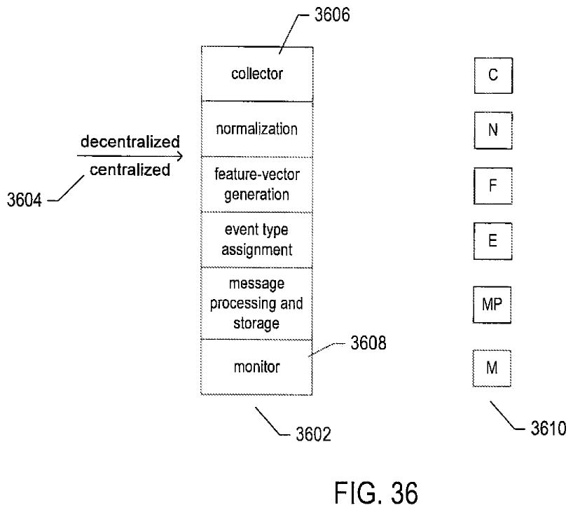

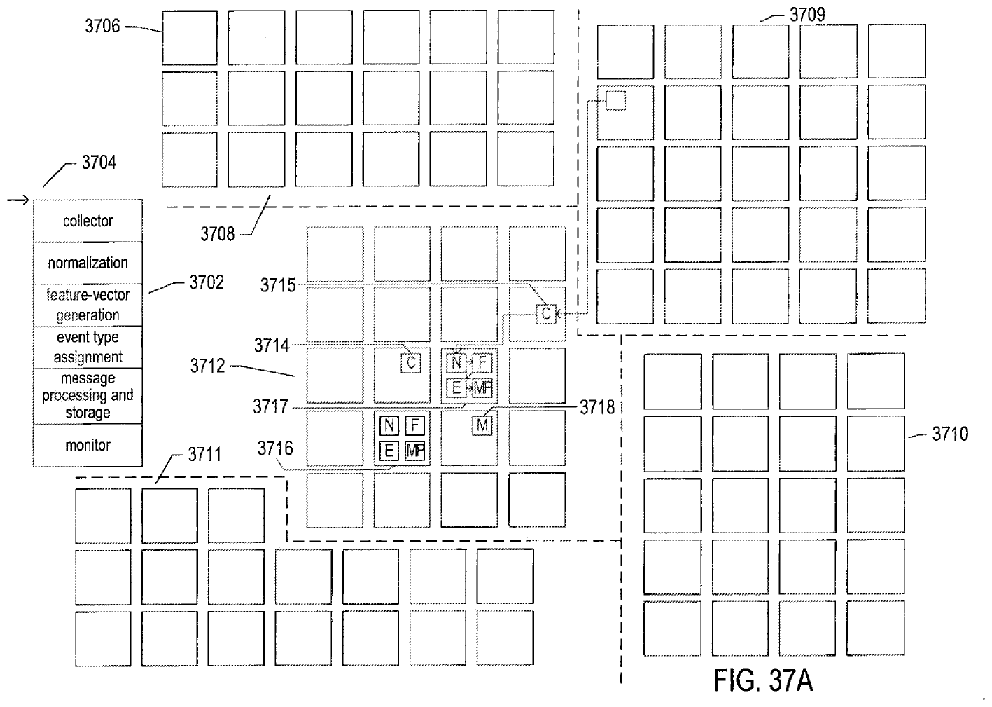

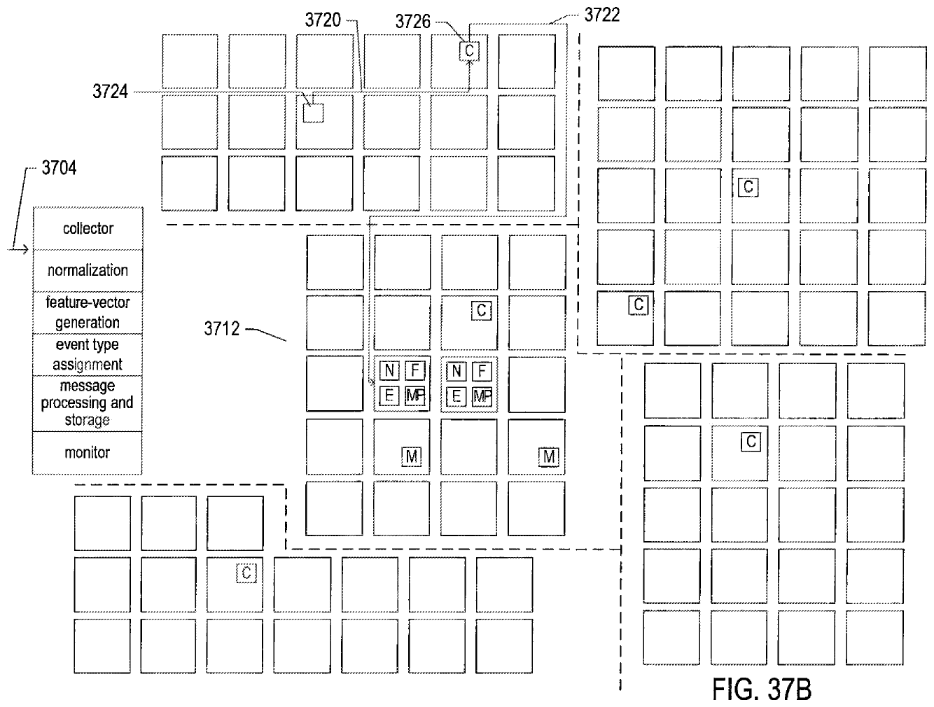

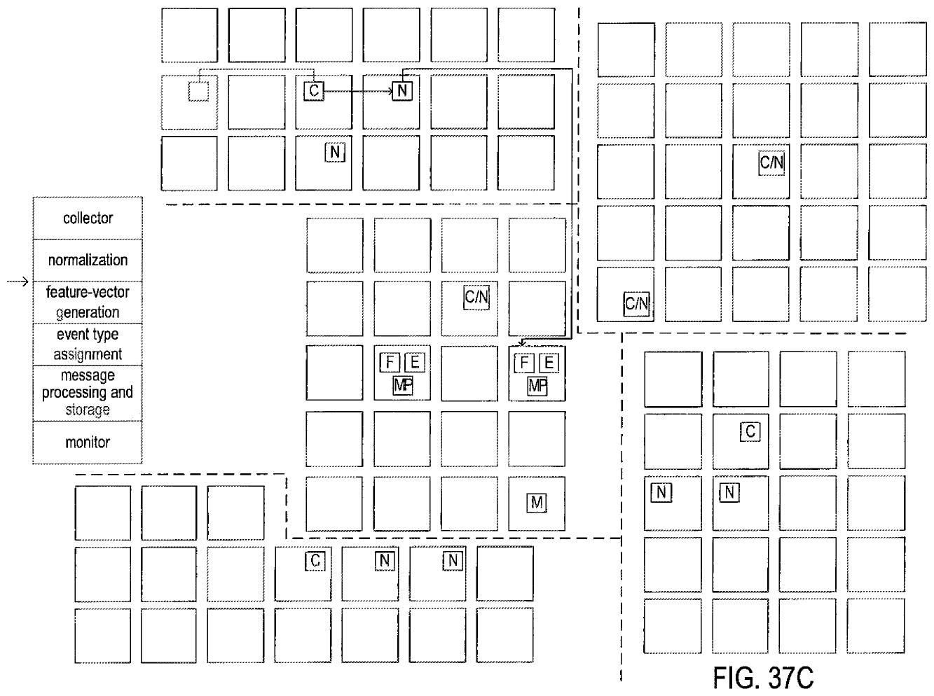

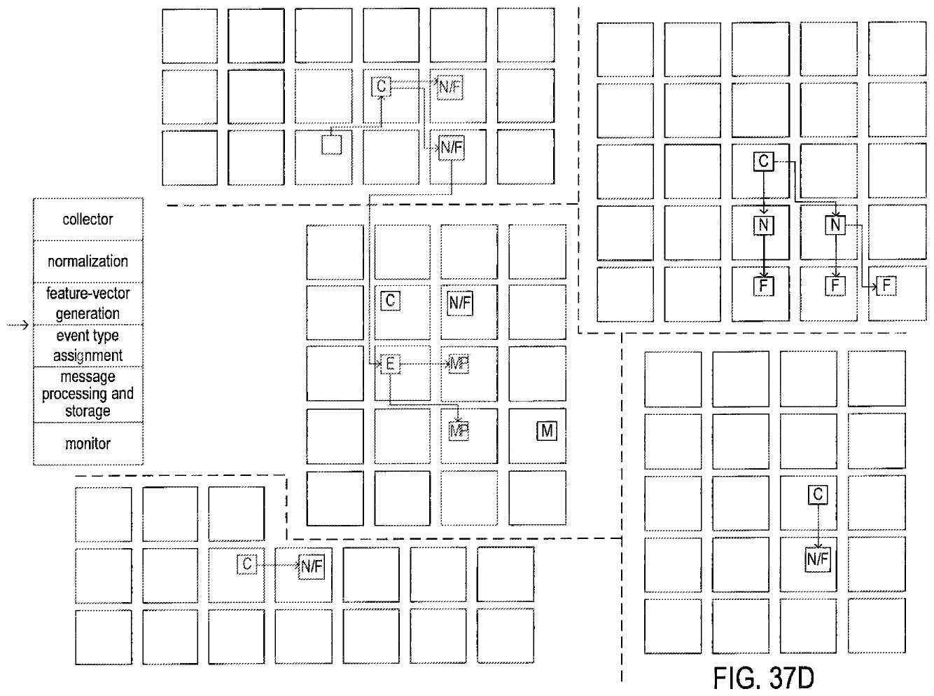

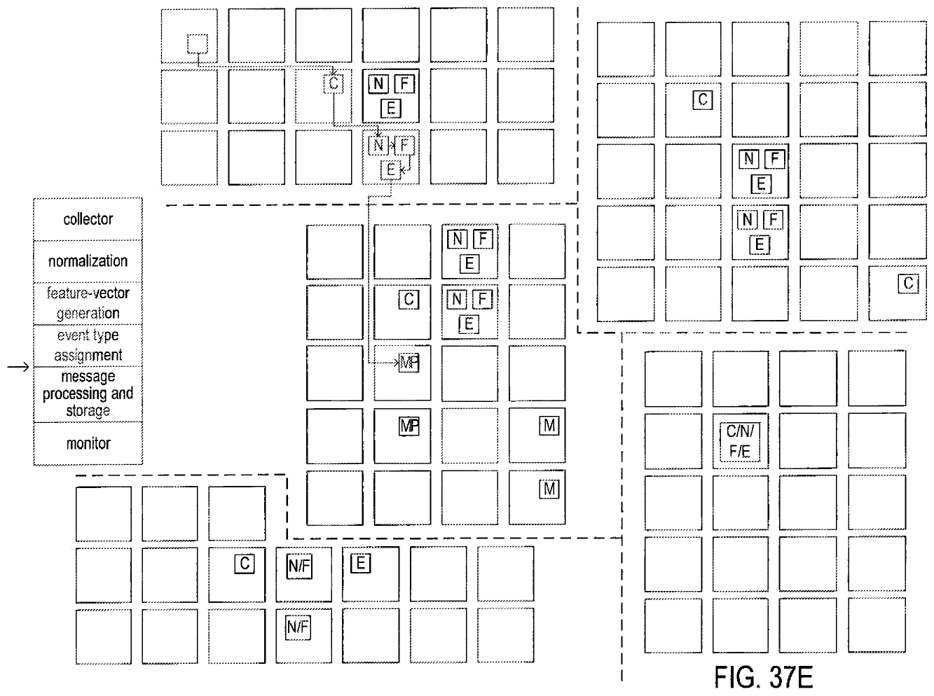

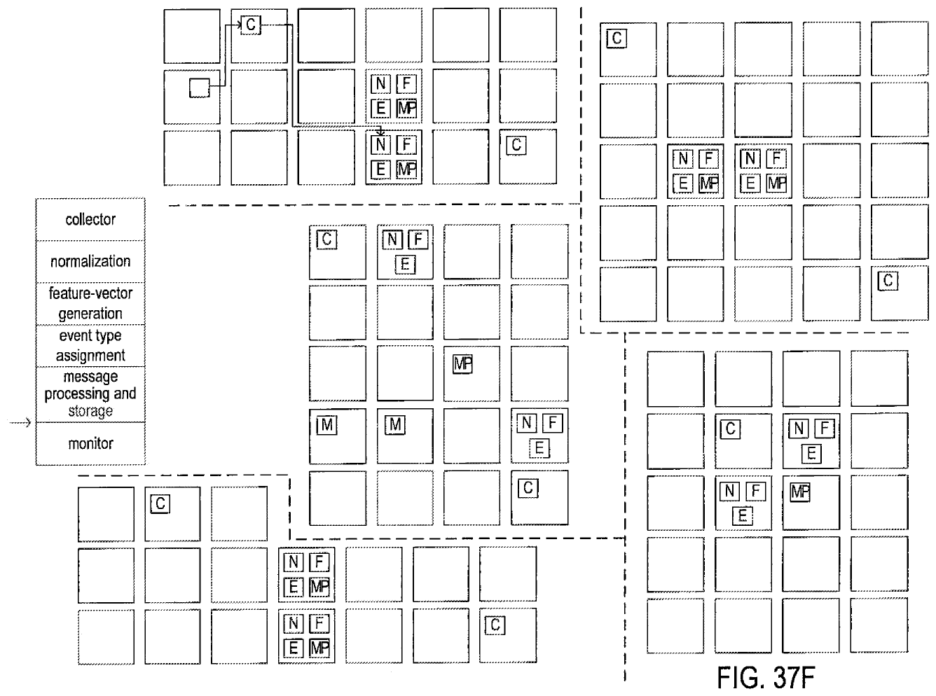

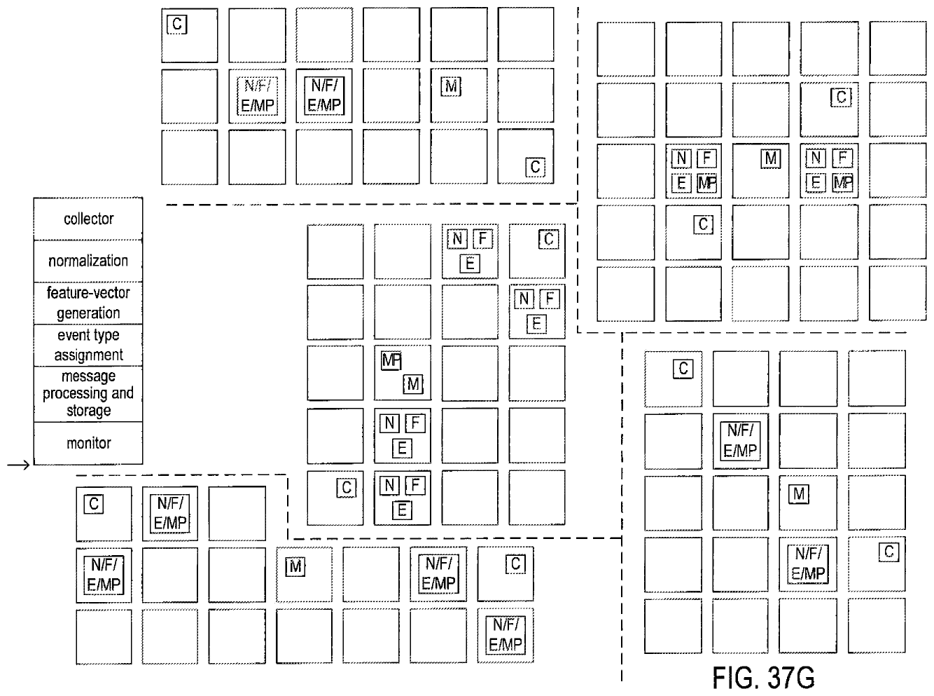

FIG. 36 illustrates the decentralization/centralization level of an EM system within a distributed computer system. In column 3602, the hierarchical order of component types within the EM system is shown. The collector component 3606 is shown at the top of the column and is the first component through which event messages enter the EM system. The final component 3608, at the bottom of the column, is a monitor component that may, alternatively, be viewed as a separate downstream system or component that uses the event records that are generated and stored by the EM system. An arrow 3604 represents the current boundary between decentralized components of the EM system, residing above the arrow in the column, and the centralized components of the EM system, residing below the arrow in the column. The different types of components can be alternatively represented as shown in column 3610 using single-character and two-character labels or representations. The arrow representing the decentralization/centralization boundary can be thought of as a slider that can be moved upwards and downwards to select different decentralization/centralization boundaries for different configurations of the EM system. The column of component types and the decentralization/centralization-boundary slider are used in FIGS. 37A-G, discussed below, which illustrate a range of EM-system configurations representing different levels of centralization/decentralization.

FIGS. 37A-G illustrate configurations of a hypothetical EM system representing different levels of centralization/decentralization. FIGS. 37A-G all use the same illustration conventions, next described with reference to FIG. 37A. The column of component types 3702 and the decentralization/centralization-boundary slider 3704 were discussed above with reference to FIG. 36. The large number of computer systems, each represented by a square, such as square 3706, are shown to be partitioned, by dashed lines, into five distinct regions 3708-3712. These may be different server clusters within a data center, different data centers owned and managed by an organization, a portion of a cloud-computing facility and four private data centers, or any of a variety of other partitions of any of a variety of different types of distributed computer systems. In the example used in FIGS. 37A-G, partition or region 3712 represents a central region and partitions or regions 3708-3711 represent peripheral regions or partitions. As indicated by the position of decentralization/centralization-boundary slider 3704 with respect to column 3702, FIG. 37A illustrates a fully centralized EM system, with all components residing within the central partition 3712. These include two collectors 3714-3715, two different sets 3716-3717 of normalization, feature-vector-generation, event-type assignment, and message-processing-and-storage components residing in two different computer systems, and a monitor component 3718. As mentioned above, each set of normalization, feature-vector-generation, event-type assignment, and message-processing-and-storage components may comprise separate components or an aggregation of components into a single multi-functional component. Multiple instances of component types may be deployed to provide sufficient processing bandwidth to handle the event-message load generated by all of the different computer systems and the distributed computer system. In the example system shown in FIG. 37A, all of these components are located within the central partition or region 3712, and thus the EM system is fully centralized. A fully centralized EM system may have significant advantages during initial periods of EM-system operation. As discussed above with reference to FIGS. 14A-C, event-message clustering is an ongoing process, and there is likely an initial, computationally intensive period of detecting and identifying a reasonably complete set of event-message types. Were the EM system decentralized during this initial period, there might be significant inefficiencies related to access, from different regions or partitions, to a centralized database storing cluster information, static portions characteristic of event-message types, and event-type-specific partitioning functions. Alternatively, relatively complex mechanisms for aggregating multiple sets of clusters and associated event types might be needed in order to produce a common set of clusters and event types for the entire distributed computer system. In the case that computational resources are rapidly added to the distributed computing system during an initial growth period, there might not, initially, be a sufficient volume of event messages to justify launching multiple instances of the various different components of the EM system, so that a gradual decentralization of the EM system may provide greater overall efficiency. However, a fully centralized EM system has the disadvantage that all of the event messages need to be transmitted from the various peripheral partitions or regions to EM-system components within the central partition or region, and may have significant fault-tolerance and robustness issues.

FIG. 37B shows an EM-system in which the collector-component instances are decentralized and distributed throughout the central and peripheral regions. Thus, the decentralization/centralization-boundary slider 3704 is now pointing to the boundary between the collector components and the normalization components. The normalization, feature-vector-generation, event-type-assignment, message-processing-and-storage, and monitor components remain centralized within the central region 3712. As indicated by arrows 3720-3722, an event-message source 3724 within a peripheral region transmits the message to a local collector component 3726 within the region, and the local collector component then transmits the message, in some implementations within a container containing other collected messages, to centralized normalization and other downstream components within the central region 3712. Decentralization of the collector components can provide data-transmission efficiencies by packaging event messages into larger messages so that fewer messages need be transmitted from peripheral regions to the central processing components of the EM-system in the central region. As further discussed below, in certain implementations, collector-component instances can also carry out various types of filtering to even further decrease data-transmission overheads.

FIGS. 37C-G show increasing levels of decentralization within the example EM system. In FIG. 37C, the normalization components are decentralized, which provides efficiencies of local peripheral regions shouldering a greater portion of the computational overhead of event-message processing. In FIG. 37D, both normalization and feature-vector generation are decentralized. Of course, these components can be aggregated into single multi-functional components or agents, in certain cases. As more components are decentralized, the opportunities for fine-granularity scaling and load-balancing increase. In FIG. 37E, collector, normalization, feature-vector generation, and event-type assignment components are decentralized. At this level of decentralization, there are many opportunities for increased efficiencies, including the efficiencies of transmitting only event records from peripheral regions to the remaining centralized components, rather than full event messages, and large efficiencies obtained by intelligently filtering the numbers and types of event records for transmission to the centralized components. In FIG. 37F, all but the monitor components are decentralized and, in FIG. 37G, the EM system has been decentralized to the point that each region includes instances of all the different components, with the overall EM system more like a collection of very loosely coupled independent regional EM systems.

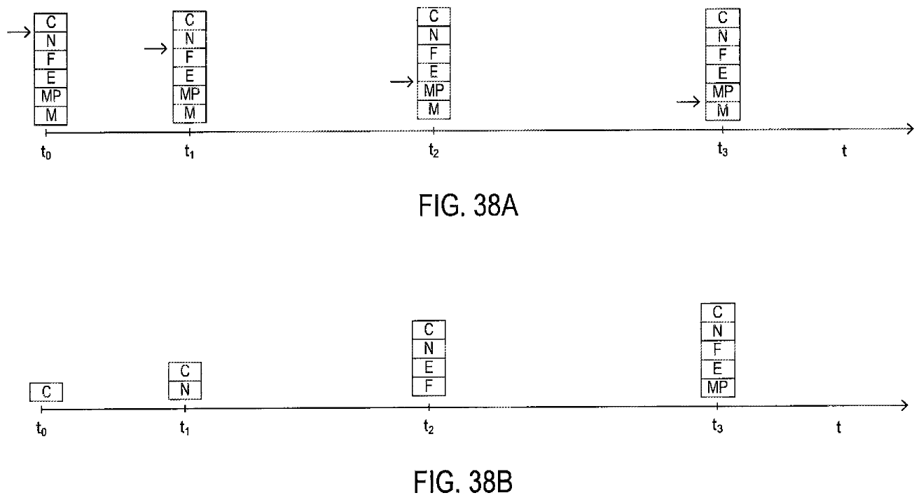

FIGS. 38A-B illustrate evolution, over time, of an EM system that provides for dynamic adjustment of the centralization/decentralization level. FIG. 38A shows the change in decentralization/centralization level of an EM system with respect to a timeline and FIG. 38B shows the corresponding sets of EM-system components that are decentralized. In the illustrated case, the EM system starts out relatively centralized and, over time, is continuously reconfigured towards greater decentralization. In this fashion, local, higher-granularity scaling and load-balancing increase as the distributed computer system evolves to include more and more component computer systems and as the EM system stabilizes with respect to detected event types and corresponding clusters. This is but one example of the flexibility that can be provided by flexible instantiation and distribution of EM-system components within a distributed computer system. The components are designed so that the different types of components can be scaled independently of other component types and distributed independently from the other component types, allowing for many different configurations and centralization/decentralization levels.

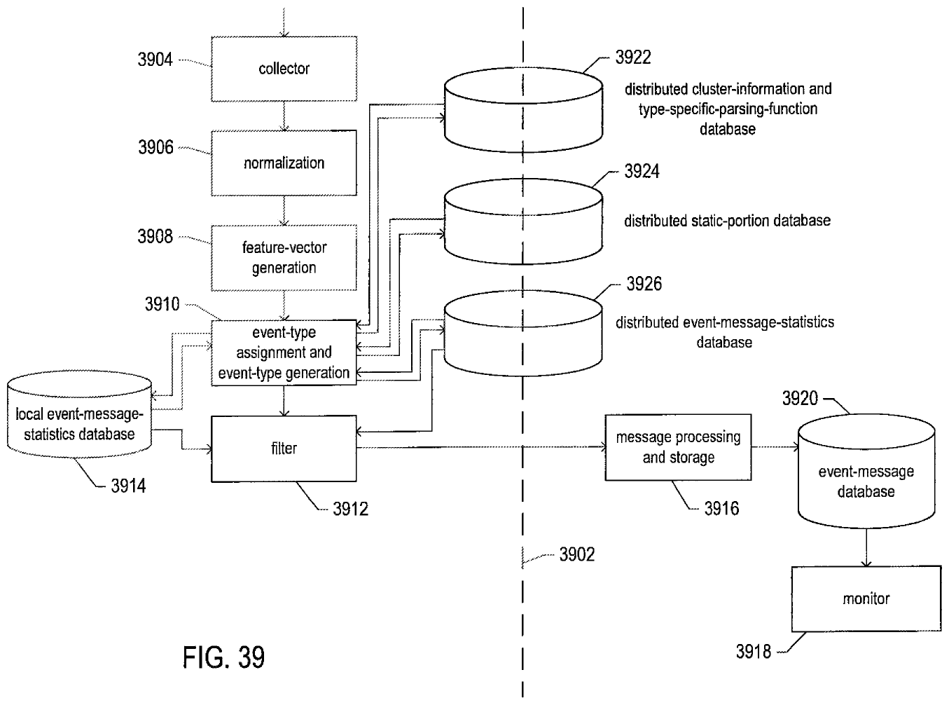

FIG. 39 illustrates one EM-system implementation that features a relatively high level of decentralization and that also includes centralized components. In FIG. 39, a vertical dashed line 3902 represents the boundary between decentralized portions of the EM system, to the left of the dashed line, and centralized portions of the EM system, to the right of the dashed line. The decentralized portions include the collector 3904, normalization 3906, feature-vector-generation 3908, event-type-assignment 3910, and filter 3912 components as well as a local event-message-statistics database 3914 that maintains local statistics for a region within the distributed computer system. Each region of the distributed computer system includes instances of the components to the left of vertical dashed line 3902. The centralized portion or region of the EM system includes centralized message-processing-and-storage 3916 and monitor 3918 components as well as a centralized event-message database 3920. Distributed cluster-information 3922, static-portion 3924, and global event-message-statistics 3926 databases span the boundary between decentralized and centralized components. Of course, various different components shown in FIG. 39 may be aggregated together into higher-level components. For example, a single distributed database can be used for cluster information, static portions of event messages, and global event-message statistics. As another example, the collector, normalization, feature-vector-generation, and event-type-assignment components can be aggregated into single agents that may additionally include the filter-component functionality. One major advantage provided by the EM system illustrated in FIG. 39 is that the decentralized agents, or EM components, can locally carry out event-message typing and generation of event records along with filtering of the event records in order to greatly decrease the amount of data that needs to be transmitted from peripheral regions to the centralized EM-system components and to greatly decrease the amount of data that is eventually stored in the centralized event-message database. In addition, the centralized monitor is able to execute queries against the centralized event-message database to efficiently and quickly implement a variety of different types of monitoring activities, without the complexities and overheads of attempting to execute queries against multiple local event-message databases or manage a complex distributed event-message database distributed across regions of the distributed computer system.

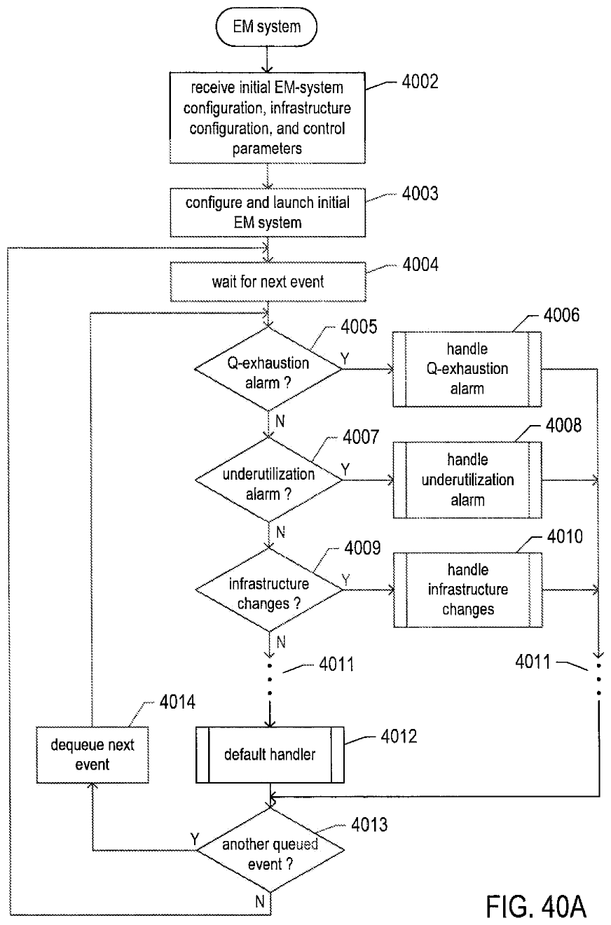

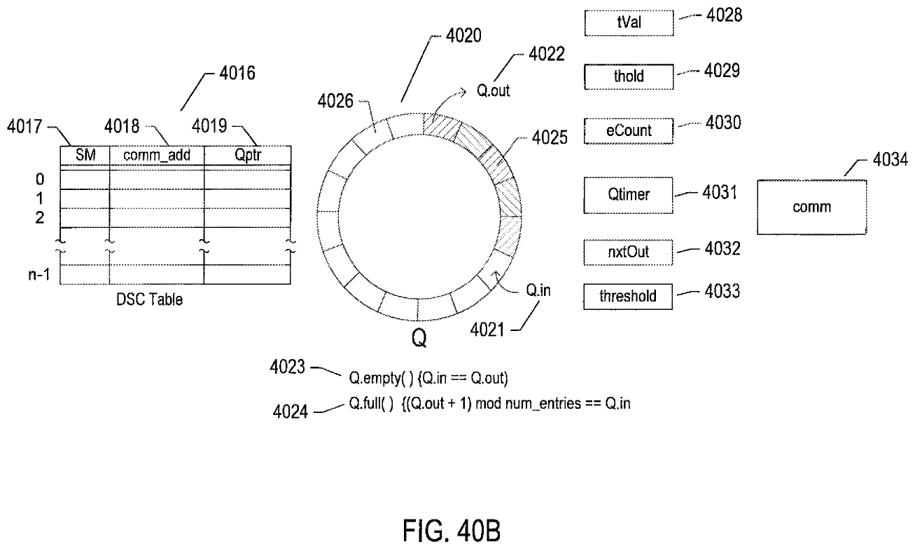

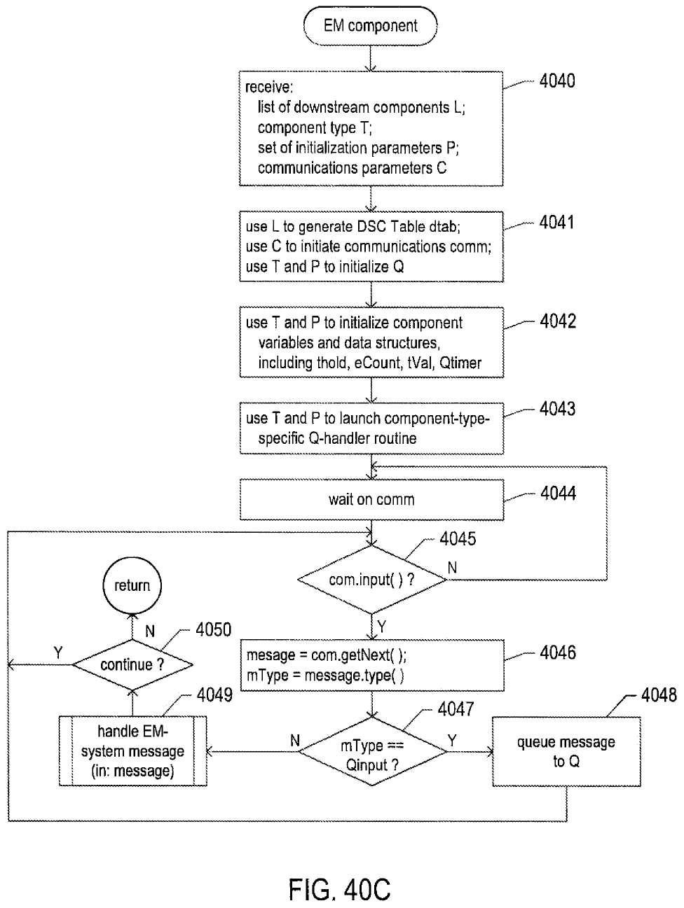

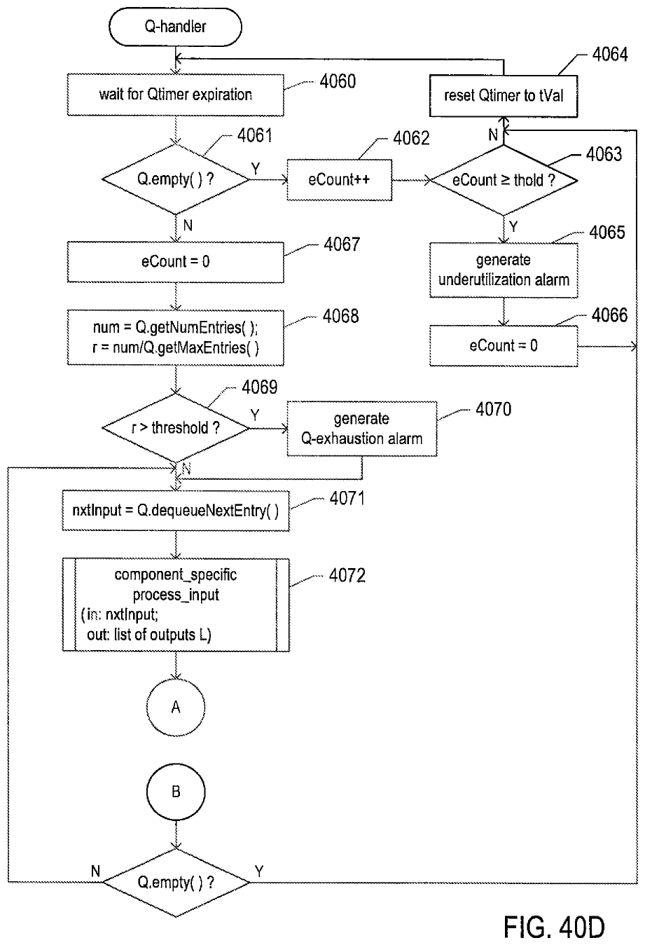

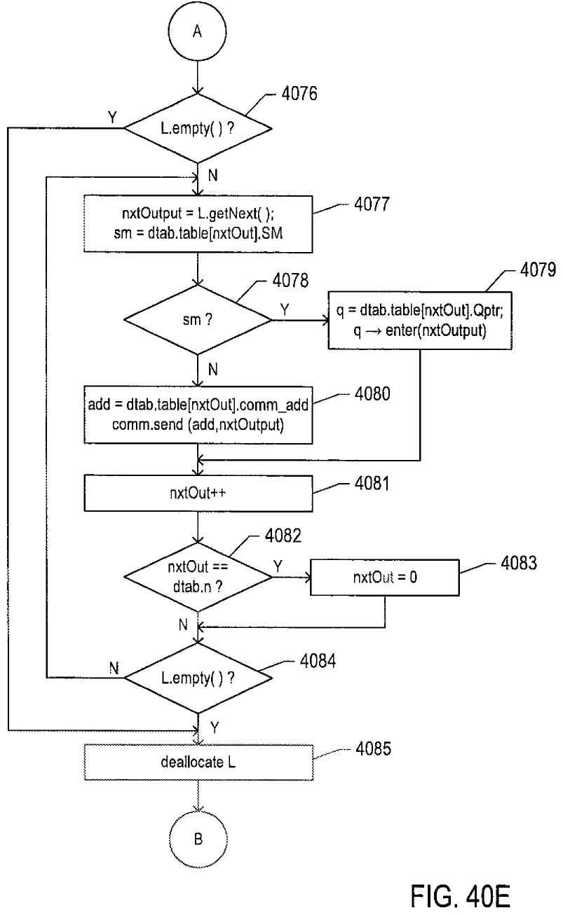

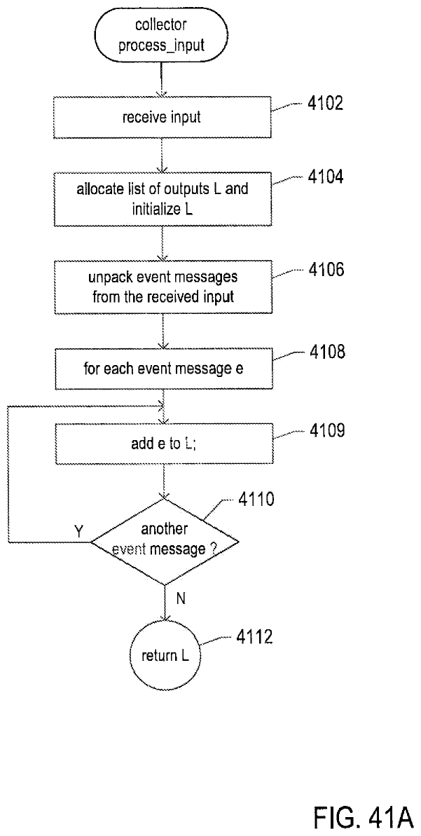

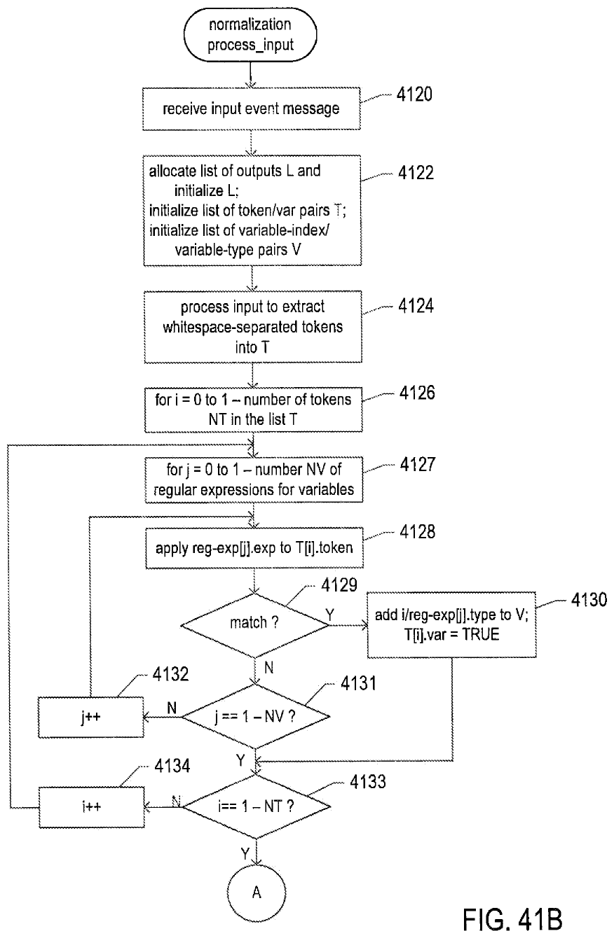

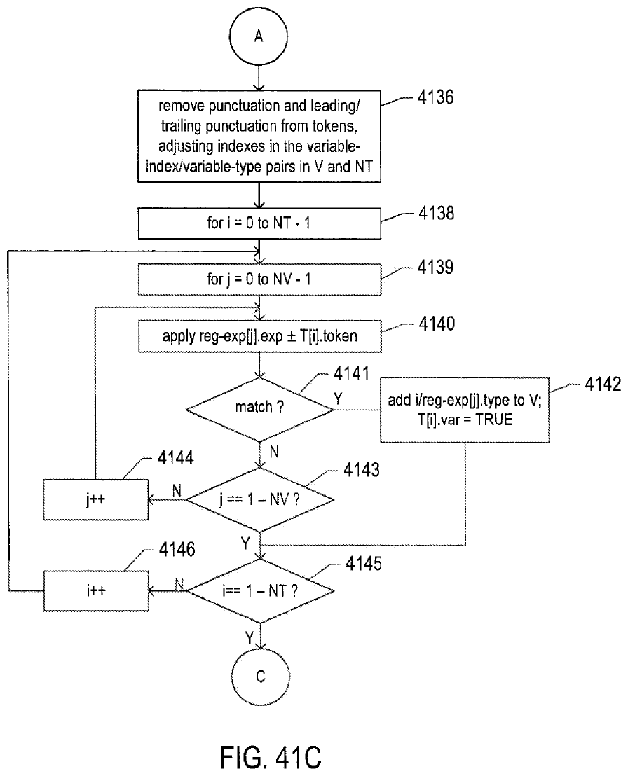

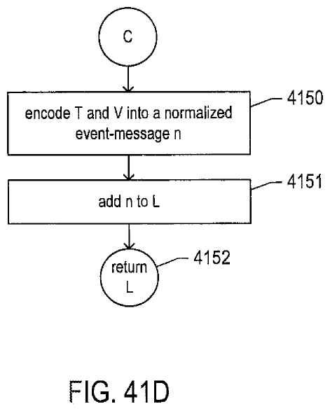

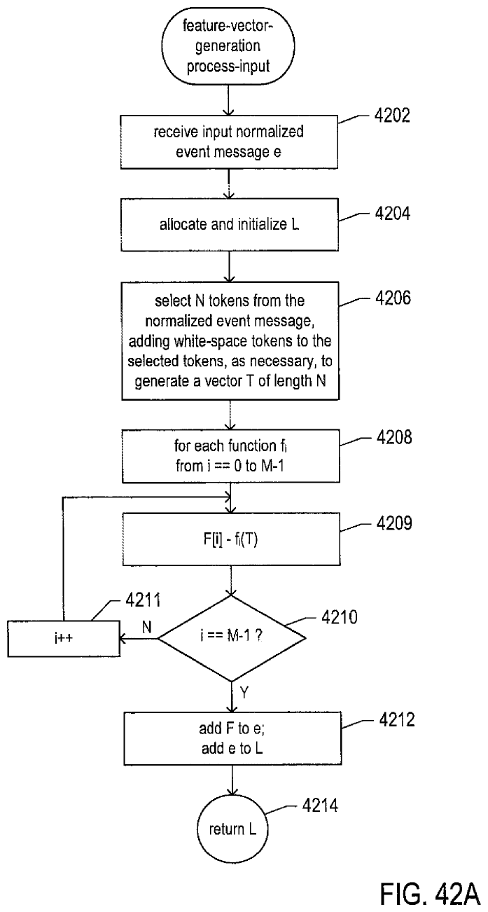

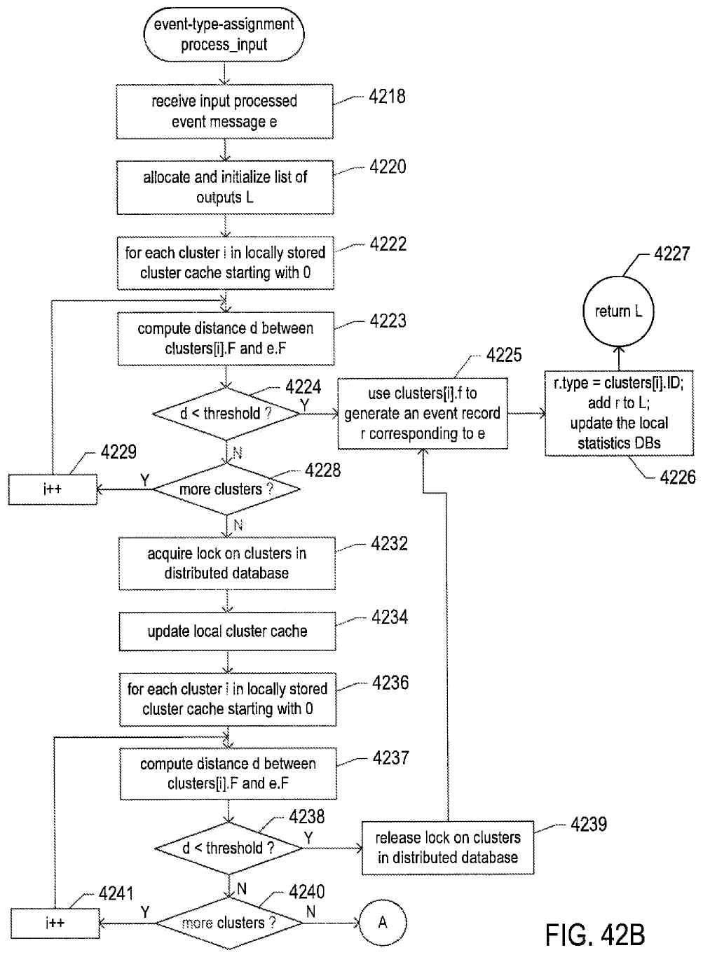

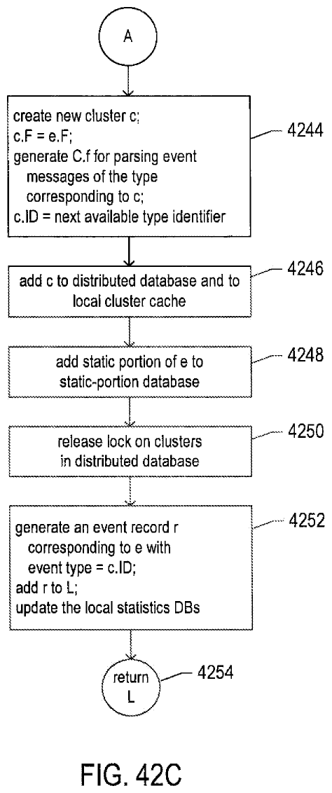

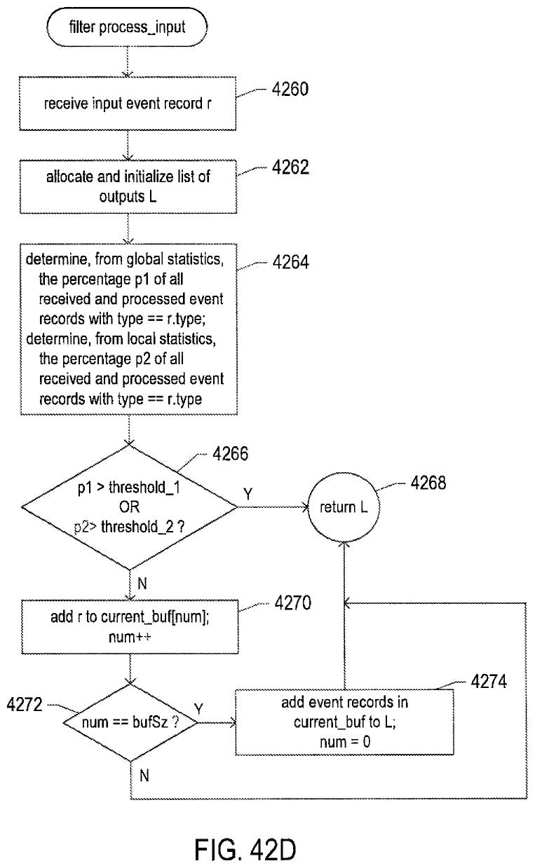

FIGS. 40A-E provide control-flow diagrams that illustrate one implementation of the EM system discussed with reference to FIG. 39. Additional details are provided in FIGS. 41A-42D. FIG. 40A shows a high-level control-flow diagram for an EM-system controller. In step 4002, the EM-system controller receives an indication of an initial configuration, an indication of the configuration of the infrastructure in which the EM system will run, and a set of control parameters. In step 4003, the EM system is configured and launched within the infrastructure using the configuration indications and control parameters. Then, the EM-system controller operates essentially as an event loop illustrated by steps 4004-4014. In step 4004, the EM-system controller waits for a next event to occur. When the next occurring event is a Q-exhaustion alarm, as determined in step 4005 and further explained below with reference to subsequent figures, the handler “handle Q-exhaustion alarm” is called in step 4006. A Q-exhaustion alarm indicates that the input queue of an EM-system component has more than a threshold number of filled entries, indicating that the EM-system component may be overloaded or experiencing some type of operational anomaly. When the next occurring event is an underutilization alarm, as determined in step 4007 and further explained below with reference to subsequent figures, the handler “handle underutilization alarm” is called in step 4008. An underutilization alarm indicates that one of the EM-system components has been idle for more than a threshold amount of time, indicating that the EM-system component may no longer be needed or that there are operational anomalies in EM-system components upstream from the EM-system component. When the next occurring event is notification of infrastructure changes, as determined in step 4009, the handler “handle infrastructure changes” is called in step 4010. Infrastructure configuration changes, like Q-exhaustion and underutilization alarms, may require the EM-system controller to rescale or otherwise reconfigure the EM system by adding components, removing components, changing the centralization/decentralization level of the EM system, or by other actions. The EM-system controller can, for example, direct an EM-system component instance to change the set of component instances to which the EM-system component outputs data entities in order to alter the load-balancing characteristics of the EM system in order to address load-balancing problems detected from alarms and other notifications or from monitoring operational characteristics of the EM system and EM-system components. Ellipses 4011 indicate that many additional types of events may be detected and handled in the event loop of steps 4004-4014. A default handler 4012 handles any rare or unexpected events. Following handling of a next-occurring event, the EM-system controller determines whether another event has been queued for handling, in step 4013. If so, the next event is dequeued, in step 4014, and control returns to step 4005. Otherwise, control returns to step 4004, where the EM-system controller waits for the occurrence of a next event.

FIG. 40B illustrates numerous data structures and variables employed in a general implementation of EM-system components, provided in FIGS. 40C-E. The DSC table 4016 stores information for the downstream components of a particular EM-system component to which the particular EM-system component inputs data entities output by the particular EM-system component. Each entry, or row, in the DSC table includes three fields represented by columns in the table: (1) SM 4017, which contains a Boolean value indicating whether or not the particular EM-system component communicates with the downstream component via shared memory; (2) comm_add 4018, which contains a communications address for the downstream component in the case that the SM field contains the Boolean value FALSE; and (3) Qptr 4019, which contains the address of an input queue for the downstream component in the case that the SM field contains the Boolean value TRUE. Each EM-system component is associated with an input queue Q 4020 implemented as a logical circular queue with in 4021 and out 4022 pointers and a number of member functions including the member function empty( ) 4023 which returns a Boolean indication of whether or not the queue is empty, and the member function full( ) 4024, which indicates whether or not the input queue is full. In the representation of the input queue in FIG. 40 B, crosshatched entries, such as entry 4025 represent input data residing within the queue and the other entries, such as entry 4026, represent empty or unfilled queue entries. The in pointer 4021 points to the next empty queue entry into which input data can be entered and the out pointer 4022 indicates the next, least recently entered input data that can be removed from the input queue. A circular queue is logically circular and implemented using modulo arithmetic for in and out pointer arithmetic. The parameter tVal 4028 is the time period between accesses to the input queue by an EM-system component. The parameter thold 4029 is the maximum number of times that an EM-system component can successively check its input queue and find it empty before generating an underutilization alarm. The variable eCount 4030 stores a count of the number of times that an EM-system component has successively checked its input queue and found it to be empty. The timer Qtimer 4031 controls periodic access, by an EM-system component, to its input queue. The variable nxtOut 4032 is an index of an entry in the DCT table dtab for a next downstream component to which to forward data. The parameter threshold is the maximum ratio of filled input-queue entries to total input-queue entries past which a Q-exhaustion alarm is generated by an EM-system component. An EM-system component receives messages from, and sends messages to, the EM-system controller through the communications channel or connection comm 4034. The communications channel or connection may be a network-communications channel or connection or may be implemented, in certain cases, through a shared-memory mechanism or other alternative mechanisms for communications between computational entities within a computer system. The EM-system component may also receive data input through the communications channel or connection, in the case that the EM-system component's input queue is not directly accessible to upstream components.

FIG. 40C provides a control-flow diagram for a generalized EM-system component. In step 4040, the EM-system component receives a list L of downstream components, an indication T of the component type, a set of initialization parameters P, and a set of communications parameters C. In step 4041, the EM-system component uses the received list L to generate a DSC table dtab, uses the parameters C to initialize the communications channel or connection comm, and uses the parameters P and component type T to initialize the input queue Q for the EM-system component. In step 4042, the EM-system component uses the parameters P and component type T to initialize variables and data structures of the EM-system component, including the variables discussed above with reference to FIG. 40B. In step 4043, the EM-system component uses the parameters P and component type T to launch a component-type specific Q-handler routine, discussed below, that continuously accesses the input queue to carry out the types of data processing associated with the component type. Then, in the continuous communications-event loop of steps 4044-4050, the EM-system component receives and responds to incoming communications messages. In step 4044, the EM-system component waits for a next communications event. When no message is available, control returns to step 4044. When a message is available, as determined in step 4045, the EM-system component retrieves the message and determines its type, in step 4046. When the message contains input data for the EM-system component, as determined in step 4047, the EM-system component queues the data to the input queue Q in step 4048. Otherwise, in step 4049, the EM-system component calls a handler to handle the message. In general, the message handler handles messages from the EM-system controller. These messages can direct the EM-system component to terminate, to change the contents of its DCT table, to increase its input-queue size, and carry out other changes. Following handling of the message, the EM-system controller determines whether or not to continue operating. If not, as in the case that the handled communications message was a termination request from the EM-system controller, the EM-system component terminates. Otherwise, control returns to step 4045 where the EM-system component attempts to access another communications message. In certain implementations, an interrupt mechanism is used to control access to comm, by the EM-system component, rather than the polling method illustrated in FIG. 40C.

FIGS. 40D-E provide a control-flow diagram for the Q-handler routine that represents operation of a generalized EM-system component and that is launched in step 4043 of FIG. 40C. In step 4060, the routine “Q-handler” waits for expiration of the Qtimer (4031 in FIG. 40B). In step 4061, the routine “Q-handler” checks to see whether or not the input queue is empty. If the input queue is empty, the routine “Q-handler” increments the value stored in variable eCount, in step 4062, and then checks to see whether or not the value stored in variable eCount is greater than or equal to the parameter value thold, in step 4063. If not, the routine “Q-handler” resets the Qtimer to tVal, in step 4064, and control returns to step 4060. Otherwise, in step 4065, the routine “Q-handler” generates an underutilization alarm and, in step 4066, sets the variable eCount to 0, after which control flows to step 4064. When the input queue is not empty, as determined in step 4061, variable eCount is set to 0, in step 4067 and, in step 4068, local variable num is set to the number of entries in the input queue and local variable r is set to the ratio of the number of entries in the input queue to the maximum number of entries that can be contained in the input queue. When r contains a value greater than a threshold value, as determined in step 4069, the routine “Q-handler” generates a Q-exhaustion alarm, in step 4070. In step 4071, the routine “Q-handler” sets the local variable nxtInput to contain data in a next entry dequeued from the input queue and then calls, in step 4072, a component-type-specific process_input routine to process the data stored in local variable nxtInput and return a list of output-data entities L. The routine “Q-handler” then processes the output entities, as shown in FIG. 40E. Following processing of the output entities, the routine “Q-handler” determines whether the input queue Q is empty. If so, control flows to step 4064. Otherwise, control flows to step 4071.

FIG. 40E shows a portion of the control-flow diagram of FIGS. 40D-E in which output entities returned by the component-type-specific process_input routine are processed. When the list of output entities L returned by the component-type-specific process_input routine is empty, as determined in step 4076, control flows to step 4085, where list L is deallocated. Otherwise, in step 4077, the variable nxtOutput is sent to the next output entity in the list L, which is removed from the list L by the call to the list member function getNext, and local variable sm is set to the contents of the SM field of the row or entry in the DCT table dtab, indexed by the contents of variable nxtOut, to which the next output entity is to be forwarded. When sm contains the value TRUE, as determined in step 4078, the output entity is queued to the input queue of the downstream component, in step 4079, and, otherwise, is sent to the downstream component through the communications channel or connection comm, in step 4080. In step 4081, the routine “Q-handler” increments variable nxtOut. When nxtOut contains a value equal to the number of entries in the DCT table dtab, as determined in step 4082, the variable nxtOut is set to 0, in step 4083. Thus, the EM component carries out round-robin load balancing. When the output-entities list L is empty, as determined in step 4084, control flows to step 4085. Otherwise, control returns to step 4077 to process the next output-data entity in list L. An interrupt mechanism can be used rather than a timer in alternative implementations to control EM-component access to the input queue. Load-balancing schemes other than round-robin load balancing can be used in alternative implementations.

FIGS. 40B-E illustrate the general implementation of an EM-system component. EM-system components are designed to be both scalable and locatable independently from other EM-system components, which allows the EM system to independently change the number of instances of particular types of components for load-balancing purposes and to relocate components in order to change the centralization/decentralization level of the EM system. Thus, the EM system can adopt a wide variety of different configurations in order to adapt to changes in the infrastructure and event-message flux within the distributed computer system in which the EM system runs as well as to changes in the operational state of the EM system and its components.

FIGS. 41A-D provide control-flow diagrams that illustrate the process_input functions for the collector and normalization components of one implementation of an EM system. FIG. 41A provides a control-flow diagram for the collector process_input routine. In step 4102, the routine process_input receives an input-data entity and, in step 4104, allocates and initializes a list L of output-data entities. In step 4106, the routine process_input unpacks one or more event messages from the received input-data entity and, in the for-loop of steps 4108-4110, adds the unpacked event messages to the list L. The list L is then returned, and step 4112.

FIGS. 41B-D provide control-flow diagrams for the normalization process_input routine. In step 4120, the routine process_input receives an event message and, in step 4122, allocates and initializes a list L of output-data entities, initializes a list of tokens/variable pairs T, and initializes a list of variable-index/variable-type pairs V. In step 4124, the routine process_input processes the received event message to extract whitespace-separated tokens from the event message into list T. Then, in the nested for-loops of steps 4126, the routine process_input attempts to match each token in the list T to a type of variable. The outer for-loop of steps 4126-4134 processes each token in the list T and the inner for-loop of steps 4127-4132 applies each regular expression in the set of regular expressions used to identify variables to the currently considered token. When application of a regular expression to a token indicates a match, as determined in step 4129, the index of the token in the list T and the variable type associated with the regular expression is added to the list V as an index/type pair, and a field in the representation of the token in list T is set to TRUE, in step 4130, to indicate that the token is a variable value, after which control flows to step 4133, generally short-circuiting the inner for-loop of steps 4127-4132. In step 4136, at the top of FIG. 41C, the routine process_input removes tokens consisting entirely of punctuation as well as leading and trailing punctuation from the remaining tokens and adjusts indexes in the index/type pairs in the list V as well as an indication of the number of tokens NT in the list T The nested for-loops of steps 4138-4146 repeat the logic of the nested for-loops of steps 4126-4134 in order to identify any additional variables after punctuation has been removed from the tokens. In step 4150, at the top of FIG. 41D, the lists T and V are encoded in a normalized event-message which is then added to the output-data-entities list L in step 4150, after which the list L is returned in step 4152.

FIGS. 42A-D provide control-flow diagrams that illustrate the feature-vector-generation, event-type-assignment, and filter process_input routines. FIG. 42A provides a control-flow diagram for the feature-vector-generation process_input routine. In step 4202, the routine process_input receives a normalized event message e and, in step 4204, allocates and initializes a list L of output-data entities. In step 4206, tokens are selected from the normalized event message and input to a list T for use in generating a corresponding feature vector. In the for-loop of steps 4208-4211, each function of a set of functions used to generate the future vector is called to generate a next element of the feature vector. In step 4212, the feature vector is added to the normalized event message e and the feature-vector-supplemented normalized event message is added to list L, which is returned in step 4214.

FIGS. 42B-C provide a control-flow diagram for the event-type-assignment process_input routine. In step 4202, the routine process_input receives a feature-vector-supplemented normalized event message e and, in step 4204, allocates and initializes a list L of output-data entities. The routine process_input considers each cluster i in a locally stored cluster cache. In step 4223, the routine process_input computes a distance d between the representative feature vector associated with the currently considered cluster and the feature vector contained in the received feature-vector-supplemented normalized event message e. When d is less than a threshold distance value, as determined in step 4224, the routine process_input uses the parsing function associated with currently considered cluster i to generate an event record r corresponding to e and, in step 4226, sets the type of the event record to the type associated with the currently considered cluster i, adds the event record to the list L, and updates local and global statistics databases to reflect the reception and processing of the event record, after which list L is returned, in step 4227. When d is greater than or equal to the threshold, as determined in step 4224, and when there are more clusters to consider, as determined in step 4228, for-loop variable i is incremented, in step 4229, and control returns to step 4223 for another iteration of the for-loop of steps 4222-4229. When there are no more clusters to consider, as determined in step 4228, then, in step 4232, the routine process_input acquires a lock on the clusters in the distributed clusters database and extracts information from the database to update the local cluster cache in step 4234. Then, in the for-loop of steps 4236-4241, the routine process_input again attempts to find a cluster for which the distance between the representative feature vector of the cluster and of the feature vector in e is less than a threshold value. When such a cluster is found, control flows to step 4225 after the routine process_input releases the lock on the clusters database, in step 4239. When no cluster is found, then control flows to step 4244 at the top of FIG. 42C. In step 4244, the routine process_input creates a new cluster c, associates the feature vector in e with the new cluster, generates a parsing function for the new cluster, and uses a next available type identifier as the type for the new cluster. In step 4246, the routine process_input adds the new cluster to the distributed clusters database as well as to the local cluster cache. In step 4248, the routine process_input adds the static portion of e to the static-portion database. In step 4250, the routine process_input releases the lock on the clusters distributed database and, in step 4252, generates an event record and updates the local and global statistics databases as in steps 4225-4226 of FIG. 42B. Finally, in step 4254, the routine process_input returns list L. In certain implementations, the static portion associated with the new cluster is only updated later, after a threshold number of event messages belonging to the new cluster have been collected and analyzed.

FIG. 42D provides a control-flow diagram for the filter process_input routine. In step 4260, the routine process_input receives an event record r and, in step 4262, allocates and initializes a list L of output-data entities. In step 4264, the routine process_input determines, from global statistics, the percentage p1 of all received and processed event messages having the type as the received event record and, from local statistics, the percentage p2 of all event messages locally received and processed, within the region in which the filter component runs, having the type as the received event record. When p1 is greater than a first threshold or p2 is greater than a second threshold, as determined in step 4266, the routine process_input returns, in step 4268, without storing the received event record in a buffer for forwarding to the centralized components of the EM system. In this manner, commonly occurring events which generally provide little useful information are not forwarded to the centralized components of the EM system in order to avoid the communications and processing overheads associated with transmission of low-information event records to the centralized components. Otherwise, the received event record is added to a buffer, in step 4270, and an indication of the number of event records in the buffer is incremented. When that number is equal to the parameter bulk, as determined in step 4272, the event records in the buffer are added to list L and the indication of the number of event records in the buffer is set to 0, in step 4274. Thus, groups or batches of event records are forwarded by the routine process_input to the centralized components of the EM system.

Although the present invention has been described in terms of particular embodiments, it is not intended that the invention be limited to these embodiments. Modification within the spirit of the invention will be apparent to those skilled in the art. For example, any of a variety of different implementations of the event-message collection, processing, storage, and filtering system, along with decentralization and centralization features, can be obtained by varying any of many different design and implementation parameters, including modular organization, programming language, underlying operating system, control structures, data structures, and other such design and implementation parameters. Many different filtering criteria, in addition to those discussed above, can be alternatively included in additional implementations. Various additional approaches to designing components that provide for centralization and decentralization are possible.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An event-message collection, processing, and storage system (“EM system”) within a distributed computer system, the EM system comprising:
one or more processors;
one or more memories;
computer instructions, stored in one or more of the one or more memories that, when executed by one or more of the one or more processors, control components of the EM system to
receive, collect, normalize, assign types to, and generate event records from, event messages generated by event-message sources within the distributed computer system, and
store the event records in an event-message database; and
an EM-system controller that dynamically launches, terminates, reconfigures, and relocates instances of the EM components in order to scale, load-balance, and change the centralization/decentralization level of the EM system.

2. The EM system of claim 1 wherein the components of the EM system include:
a collector component that receives event messages from event-message sources;
a normalization component that generates, from an event message, a normalized event message that includes a static portion and a list of variable values;
a feature-vector-generation component that generates, from a normalized event message, a feature vector for the normalized event message;
an event-type-assignment component that
determines, from a normalized event message and a feature vector corresponding to the normalized event message, an event type, and
generates, from the normalized event message, an event record corresponding to the event message that includes the event type; and
a message-processing-and-storage component that stores event records in the event-message database.

3. The EM system of claim 1
wherein the EM system includes aggregate components that each includes functionalities of two or more of the collector component, normalization component, feature-vector-generation component, event-type-assignment component, and message-processing-and-storage component; and
wherein the aggregate components include agents that each includes functionalities of the collector component.

4. The EM system of claim 3 wherein the EM system includes one or more instances of the components included in the EM system.

5. The EM system of claim 4 wherein each component instance includes:
an input queue to which input data is queued; and
data-processing logic that
dequeues input data from the input queue,
processes the dequeued input data to generate one or more output-data entities, and
outputs the one or more output-data entities to one or more downstream component instances, selecting the downstream component instances from a set of downstream component instances in order to balance a downstream processing workload among the downstream component instances of the set of downstream component instances.

6. The EM system of claim 4 wherein the EM-system controller launches additional component instances to scale up the EM system to handle an increase in a rate of event-message generation within the distributed computer system.

7. The EM system of claim 4 wherein the EM-system controller terminates idle or lightly loaded component instances to scale down the EM system.

8. The EM system of claim 4 wherein the EM-system controller directs a component instance to change the set of downstream component instances to which the component instance outputs output-data entities in order to change the load-balancing characteristics of the EM system.

9. The EM system of claim 4 wherein the EM system launches and installs component instances in peripheral regions or portions of the distributed computer system to increase a decentralization level of the EM system.

10. The EM system of claim 4 wherein the EM system terminates component instances in peripheral regions or portions of the distributed computer system to decrease a decentralization level of the EM system.

11. An event-message collection, processing, and storage system (“EM system”) within a distributed computer system, the EM system comprising:
one or more processors;
one or more memories;
computer instructions, stored in one or more of the one or more memories that, when executed by one or more of the one or more processors, control components of the EM system to
receive, collect, normalize, assign types to, and generate event records from, event messages generated by event-message sources within the distributed computer system,
filter the event records, and
store the event records in an event-message database; and
an EM-system controller that dynamically launches, terminates, and reconfigures instances of the EM components in order to scale and load-balance the EM system.

12. The EM system of claim 1 wherein the components of the EM system include:
a collector component that receives event messages from event-message sources;
a normalization component that generates, from an event message, a normalized event message that includes a static portion and a list of variable values;
a feature-vector-generation component that generates, from a normalized event message, a feature vector for the normalized event message;
an event-type-assignment component that
determines, from a normalized event message and a feature vector corresponding to the normalized event message, an event type, and
generates, from the normalized event message, an event record corresponding to the event message that includes the event type;
a filter component that filters event records for transmission to a message-processing-and-storage component; and
the message-processing-and-storage component that stores event records in the event-message database.

13. The EM system of claim 1
wherein the EM system includes aggregate components that each includes functionalities of two or more of the collector component, normalization component, feature-vector-generation component, event-type-assignment component, and message-processing-and-storage component; and
wherein the aggregate components include agents that each includes functionalities of the collector component.

14. The EM system of claim 3 wherein the EM system includes one or more instances of the components included in the EM system.

15. The EM system of claim 4 wherein each component instance includes:
an input queue to which input data is queued; and
data-processing logic that
dequeues input data from the input queue,
processes the dequeued input data to generate one or more output-data entities, and
outputs the one or more output-data entities to one or more downstream component instances, selecting the downstream component instances from a set of downstream component instances in order to balance a downstream processing workload among the downstream component instances of the set of downstream component instances.

16. The EM system of claim 4
wherein the distributed computer system includes peripheral portions or regions and a central portion or region;
wherein one or more EM system components that together include functionalities of the collector component, normalization component, feature-vector-generation component, event-type-assignment component, and filter component are located in one or more of the peripheral portions of the distributed computer system; and
wherein one or more instances of the message-processing-and-storage component and the event-message database are located in the central portion or region of the distributed computer system.

17. The EM system of claim 16 wherein a filter-component instance or an agent or other aggregate-component instance that includes filter-component functionality forwards only those received event records to an instance of the message-processing-and-storage component that meet one or more relevance, importance, or information-content requirements.

18. The EM system of claim 16
wherein a filter-component instance or an agent or other aggregate-component instance that includes filter-component functionality determines, for each received event record, a percentage p1 of all event messages received and processed by the EM-system having the event type of the received event record and a percentage p2 of all event messages locally received and processed within the region in which the filter-component instance runs;
wherein, when p1 is greater than a first threshold or p2 is greater than a second threshold, the filter-component instance or the agent or other aggregate-component instance that includes filter-component functionality does not output the event record to an instance of the message-processing-and-storage component; and
wherein, when p1 is less than or equal to the first threshold or p2 is less than or equal to the second threshold, the filter-component instance or the agent or other aggregate-component instance that includes filter-component functionality outputs the event record to an instance of the message-processing-and-storage component.

19. A method carried out by an event-message collection, processing, and storage system (“EM system”), within a distributed computer system that includes one or more processors, one or more memories, computer instructions, stored in one or more of the one or more memories that, when executed by one or more of the one or more processors, control components of the EM system to receive, collect, normalize, assign types to, and generate event records from, event messages generated by event-message sources within the distributed computer system, filter the event records, and store the event records in an event-message database; and an EM-system controller that dynamically launches, terminates, and reconfigures instances of the EM components in order to scale and load-balance the EM system, the method comprising:
placing one or more EM system components that together include functionalities of the collector component, normalization component, feature-vector-generation component, event-type-assignment component, and filter component in one or more peripheral portions or regions of the distributed computer system;
placing one or more instances of the message-processing-and-storage component and the event-message database in a central portion or region of the distributed computer system; and
forwarding, by a filter-component instance or an agent or other aggregate-component instance that includes filter-component functionality, only those received event records to an instance of the message-processing-and-storage component that meet one or more relevance, importance, or information-content requirements

20. The method of claim 19
wherein a filter-component instance or an agent or other aggregate-component instance that includes filter-component functionality determines, for each received event record, a percentage p1 of all event messages received and processed by the EM-system having the event type of the received event record and a percentage p2 of all event messages locally received and processed within the region in which the filter-component instance runs;
wherein, when p1 is greater than a first threshold or p2 is greater than a second threshold, the filter-component instance or the agent or other aggregate-component instance that includes filter-component functionality does not output the event record to an instance of the message-processing-and-storage component; and
wherein, when p1 is less than or equal to the first threshold or p2 is less than or equal to the second threshold, the filter-component instance or the agent or other aggregate-component instance that includes filter-component functionality outputs the event record to an instance of the message-processing-and-storage component.
